(19) United States
(12) Patent Application Publication
(10) Pub. No.: US 2015/0301698 A1
(43) Pub. Date: Oct. 22, 2015

(54) SYSTEMS, METHODS AND COMPUTER-READABLE MEDIA FOR ENABLING INFORMATION TECHNOLOGY TRANSFORMATIONS

(71) Applicant: CAPGEMINI TS FRANCE, Suresnes (FR)

(72) Inventor: Philippe ROQUES, Suresnes (FR)

(21) Appl. No.: 14/449,978

(22) Filed: Aug. 1, 2014

Related U.S. Application Data
(60) Provisional application No. 61/980,835, filed on Apr. 17, 2014.

(51) Int. Cl. G06F 3/0482; H04L 12/24; G06F 17/30; G06Q 10/06; G06F 3/0484

(52) U.S. Cl. CPC G06F 3/0482; G06Q 10/06; G06F 3/04842; G06F 17/30601; H04L 41/22

(57) ABSTRACT

In one aspect, a method comprising using at least one computer processor to perform operations of: retrieving from the memory data relating to assets of an organization's IT estate, including values ascribed to parameters common among the assets, the parameters relating to respective features of the assets; interacting with a user to convey thereto a set of selectable classification parameters among said parameters; interacting with the user to receive therefrom an identification of a plurality of classification parameters selected from the conveyed set of selectable classification parameters; using a display screen to render perceptible to the user a plurality of graphical elements each corresponding to at least one of the assets, each graphical element characterized by multiple independent and simultaneously perceptible features, each of the features conveying the value ascribed to a corresponding one of the selected classification parameters for the corresponding at least one asset.

### CROSS-REFERENCE TO RELATED APPLICATION

The present application claims the benefit of U.S. provisional application Ser. No. 61/980,835 to Philippe Rogues, filed Apr. 17, 2014, hereby incorporated by reference herein in its entirety for any and all non-limiting purposes.

### FIELD

The present invention relates generally to improving the efficiency with which information technology assets and/or resources are analyzed and/or deployed in an organization.

### BACKGROUND

An organization's installed base of information technology assets may include a disparate number of software assets (e.g., desktop software applications, mobile apps, source code, etc.) programmed in various languages, presenting different levels of obsolescence, exposed to varying degrees of security risk and generally differing in many ways. This may lead to an unwieldy and precarious mix of installed software assets that is difficult to manage. In such an environment, it is particularly challenging for management to obtain a sense of how well the information technology infrastructure serves the needs of the organization, so as to permit the taking of timely and cost-efficient decisions regarding resource (including human resource) allocation, decommissioning and the like.

### SUMMARY

According to an aspect of the present invention, there may be provided a method performed by at least one computer processor executing computer program instructions tangibly stored on at least one non-transitory computer-readable medium, the method comprising using the at least one computer processor to perform operations of:
retrieving from a computer-readable memory data relating to assets of an organization's IT estate, the data relating to each asset including values ascribed to parameters common among the assets, the parameters relating to respective features of the assets;
interacting with a user to convey to the user a set of selectable classification parameters among said parameters;
interacting with the user to receive from the user an identification of a plurality of classification parameters selected from the conveyed set of selectable classification parameters;
using a display screen to render perceptible to the user a plurality of graphical elements each corresponding to at least one of the assets, each graphical element characterized by multiple independent and simultaneously perceptible features, each of the features conveying the value ascribed to a corresponding one of the selected classification parameters for the corresponding at least one asset.

According to another aspect of the present invention, there may be provided a computer system that includes a processor, a memory and an interface, the memory storing instructions, the processor configured to read and interpret the instructions from the memory, wherein the processor interpreting the instructions read from the memory causes the computer system to perform operations of:
retrieving from the memory data relating to assets of an organization's IT estate, the data relating to each asset including values ascribed to parameters common among the assets, the parameters relating to respective features of the assets;
via the interface, interacting with a user to convey to the user a set of selectable classification parameters among said parameters;
via the interface, interacting with the user to receive from the user an identification of a plurality of classification parameters selected from the conveyed set of selectable classification parameters;
via the interface, rendering perceptible to the user a plurality of graphical elements each corresponding to at least one of the assets, each graphical element characterized by multiple independent and simultaneously perceptible features, each of the features conveying the value ascribed to a corresponding one of the selected classification parameters for the corresponding at least one asset.

According to another aspect of the present invention, there may be provided a non-transitory computer-readable medium storing instructions which, when read and interpreted by a processor of a computer system that also comprises an interface, cause the computer system to perform operations of:
retrieving from the memory data relating to assets of an organization's IT estate, the data relating to each asset including values ascribed to parameters common among the assets, the parameters relating to respective features of the assets;
via the interface, interacting with a user to convey to the user a set of selectable classification parameters among said parameters;
via the interface, interacting with the user to receive from the user an identification of a plurality of classification parameters selected from the conveyed set of selectable classification parameters;
via the interface, rendering perceptible to the user a plurality of graphical elements each corresponding to at least one of the assets, each graphical element characterized by multiple independent and simultaneously perceptible features, each of the features conveying the value ascribed to a corresponding one of the selected classification parameters for the corresponding at least one asset.

According to another aspect of the present invention, there may be provided a dynamic portfolio analysis engine implemented by at least one computer processor executing computer program instructions tangibly stored on at least one non-transitory computer-readable medium and configured for:
retrieving from the computer-readable medium data relating to assets of an organization's IT estate, the data relating to each asset including values ascribed to parameters common among the assets;
generating a portfolio analysis output based on the retrieved data, the portfolio analysis output encoding a graphical representation of a mutual comparison of the assets of the IT estate with respect to at least one of the parameters;
monitoring the memory to detect changes in the data relating to the at least one of the parameters, for at least one of the assets;
updating the portfolio analysis output in substantially real-time as said changes in the data relating to the at least one of the parameters are detected.

According to another aspect of the present invention, there may be provided a method performed by at least one computer processor executing computer program instructions tangibly stored on at least one non-transitory computer-readable medium, the method comprising using the at least one computer processor to implement a dynamic portfolio analysis engine configured for:
retrieving from a computer-readable medium data relating to assets of an organization's IT estate, the data relating to each asset including values ascribed to parameters common among the assets;
generating a portfolio analysis output based on the retrieved data, the portfolio analysis output encoding a graphical representation of a mutual comparison of the assets of the IT estate with respect to at least one of the parameters;
monitoring the memory to detect changes in the data relating to the at least one of the parameters, for at least one of the assets;
updating the portfolio analysis output in substantially real-time as said changes in the data relating to the at least one of the parameters are detected.

According to another aspect of the present invention, there may be provided a computer system that includes a processor, a memory and an interface, the memory storing instructions, the processor configured to read and interpret the instructions from the memory, wherein the processor interpreting the instructions read from the memory causes the computer system to perform operations of:
retrieving from the memory data relating to assets of an organization's IT estate, the data relating to each asset including values ascribed to parameters common among the assets;
generating a portfolio analysis output based on the retrieved data, the portfolio analysis output encoding a graphical representation of a mutual comparison of the assets of the IT estate with respect to at least one of the parameters;
monitoring the memory to detect changes in the data relating to the at least one of the parameters, for at least one of the assets;
updating the portfolio analysis output in substantially real-time as said changes in the data relating to the at least one of the parameters are detected.

According to another aspect of the present invention, there may be provided a non-transitory computer-readable medium storing instructions which, when read and interpreted by a processor of a computer system that also comprises an interface, cause the computer system to perform operations of:
retrieving from the computer-readable medium data relating to assets of an organization's IT estate, the data relating to each asset including values ascribed to parameters common among the assets;
generating a portfolio analysis output based on the retrieved data, the portfolio analysis output encoding a graphical representation of a mutual comparison of the assets of the IT estate with respect to at least one of the parameters;
monitoring the memory to detect changes in the data relating to the at least one of the parameters, for at least one of the assets;
updating the portfolio analysis output in substantially real-time as said changes in the data relating to the at least one of the parameters are detected.

According to another aspect of the present invention, there may be provided a method performed by at least one computer processor executing computer program instructions tangibly stored on at least one non-transitory computer-readable medium, the method comprising using the at least one computer processor to implement an IT transformation tool configured for:
interacting with a user to provide to the user a plurality of IT transformation options including at least a first option and a second option;
responsive to selection of the first option, causing further interaction with the user to allow the user to submit data relating to assets of an organization's IT estate, the data relating to each asset including values ascribed to parameters common among the assets, the parameters relating to respective features of the assets;
responsive to selection of the second option, processing the data relating to the assets to dynamically generate a portfolio analysis output and using a display screen to render perceptible to the user the portfolio analysis output.

According to another aspect of the present invention, there may be provided a computer system that includes a processor, a memory and an interface, the memory storing instructions, the processor configured to read and interpret the instructions from the memory, wherein the processor interpreting the instructions read from the memory causes the computer system to perform operations of:
via the interface, interacting with a user to provide to the user a plurality of IT transformation options including at least a first option and a second option;
responsive to selection of the first option, causing further interaction with the user to allow the user to submit data relating to assets of an organization's IT estate, the data relating to each asset including values ascribed to parameters common among the assets, the parameters relating to respective features of the assets;
responsive to selection of the second option, processing the data relating to the assets to dynamically generate a portfolio analysis output and using a display screen to render perceptible to the user the portfolio analysis output.

According to another aspect of the present invention, there may be provided a non-transitory computer-readable medium storing instructions which, when read and interpreted by a processor of a computer system that also comprises an interface, cause the computer system to perform operations of:
interacting with a user to provide to the user a plurality of IT transformation options including at least a first option and a second option;
responsive to selection of the first option, causing further interaction with the user to allow the user to submit data relating to assets of an organization's IT estate, the data relating to each asset including values ascribed to parameters common among the assets, the parameters relating to respective features of the assets;
responsive to selection of the second option, processing the data relating to the assets to dynamically generate a portfolio analysis output and using a display screen to render perceptible to the user the portfolio analysis output.

According to another aspect of the present invention, there may be provided a method performed by at least one computer processor executing computer program instructions tangibly stored on at least one non-transitory computer-readable medium, the method comprising using the at least one computer processor to perform operations of:
retrieving from the computer-readable memory data relating to assets in different domains of an IT estate, the data relating to each asset including a corresponding level of dynamism and a corresponding level of integration for said asset;
categorizing each of the assets into a building block having a certain model, such that the assets categorized into a building block of a given model include those assets for which the corresponding levels of dynamism for those assets are within a predetermined range of dynamism levels for the given model and the corresponding levels of integration for those assets are within a predetermined range of integration levels for the given model;
creating suggested operational units by aggregating building blocks from different domains but of the same model;
rendering perceptible to a user an indication of the suggested operational units resulting from the aggregating.

According to another aspect of the present invention, there may be provided a non-transitory computer-readable medium storing instructions which, when read and interpreted by a processor of a computer system that also comprises an interface, cause the computer system to perform operations of:
retrieving from the computer-readable medium data relating to IT assets in different domains of an IT estate, the data relating to each IT asset including a corresponding level of dynamism and a corresponding level of integration for said asset;
categorizing each of the IT assets into a building block having a certain model, such that the assets categorized into a building block of a given model include those assets for which the corresponding levels of dynamism for those assets are within a predetermined range of dynamism levels for the given model and the corresponding levels of integration for those assets are within a predetermined range of integration levels for the given model;
creating suggested operational units by aggregating building blocks from different domains but of the same model;
rendering perceptible to a user an indication of the suggested operational units resulting from the aggregating.

According to another aspect of the present invention, there may be provided a method performed by at least one computer processor executing computer program instructions tangibly stored on at least one non-transitory computer-readable medium, the method comprising using the at least one computer processor to implement an IT transformation tool configured for:
retrieving from the memory data relating to IT assets in different domains of an IT estate, the data relating to each IT asset including a corresponding level of dynamism and a corresponding level of integration for said asset;
categorizing each of the IT assets into a building block having a certain model, such that the assets categorized into a building block of a given model include those assets for which the corresponding levels of dynamism for those assets are within a predetermined range of dynamism levels for the given model and the corresponding levels of integration for those assets are within a predetermined range of integration levels for the given model;
creating suggested operational units by aggregating building blocks from different domains but of the same model;
rendering perceptible to a user an indication of the suggested operational units resulting from the aggregating.

### BRIEF DESCRIPTION OF THE DRAWINGS

These and other aspects may now be better understood with reference to the accompanying drawings, in which:

FIGS. 1 and 2 illustrate functional block diagrams of example hardware/network architectures that may be used to support embodiments of the present invention.

FIG. 3 is a flow chart illustrating a non-limiting example process executed by a user of an end user device.

FIGS. 4A and 4B illustrate non-limiting example GUI options of an IT transformation tool with various selectable regions.

FIGS. 5 and 6 illustrate different non-limiting example graphical representation of risk factors.

FIG. 7 is a flow chart illustrating an operation of an IT transformation tool when used for industrialization, according to a non-limiting example.

FIG. 8 illustrates a functional block diagram of a typical IT organization.

FIGS. 9A and 9B illustrate a conceptual view of three non-limiting operational models, according to a non-limiting example.

FIG. 10A and 10B illustrate non-limiting example decision dashboards.

FIG. 11 shows a non-limiting example of aggregation that may be performed by an aggregation wizard.

FIGS. 12A and 12B illustrate a non-limiting example graphical representation of a set of example building blocks.

FIG. 13 illustrates a non-limiting conceptual diagram of an industrialized delivery module.

FIGS. 14-15 illustrates non-limiting example comparative scoring information based on the industrialized delivery model.

FIG. 16 is a non-limiting flow chart illustrating an operation of the IT transformation tool when used for industrialization.

FIGS. 17-19 illustrate non-limiting example savings that can be gained from industrialization on a per-lever basis.

FIGS. 20-22 illustrate non-limiting example data collection dashboards.

FIG. 23 is a flowchart illustrating a non-limiting process executed by an interactive dashboard tool.

FIG. 24-27 illustrate non-limiting example scoring reports.

FIG. 28 is a non-limiting functional block diagram of an IT transformation tool.

FIG. 29 illustrates an non-limiting example GUI presented by a data capture model of an IT transformation tool.

FIG. 30 illustrates a non-limiting portfolio analysis report.

FIG. 31 illustrates a non-limiting functional block diagram of a dynamic portfolio analysis engine.

FIG. 32 shows a non-limiting example of software assets being aggregated into operational units versus domains.

FIGS. 33-47 and 60-63 illustrate different non-limiting example scorecards with graphically representable data structures representing one or more software assets in an IT estate.

FIG. 48 is a non-limiting flowchart illustrating operations that may be carried out by a scorecard module.

FIG. 49 illustrates a non-limiting example of elements of an output screen caused to be output by an interactive dashboard tool.

FIGS. 50A-57 illustrate non-limiting example representations of the output screen of FIG. 49.

FIGS. 58A-G illustrate tables of non-limiting example raw parameters and their corresponding value possibilities.

FIG. 59 illustrates a table of non-limiting examples of derived parameters.

FIGS. 64 and 65 illustrate different non-limiting example graphical classifications of software assets.

FIGS. 66-68 illustrate different non-limiting example graphical benchmark sub-reports.

FIG. 69 is a non-limiting flowchart illustrating a process executed by a dynamic portfolio analysis engine.

FIG. 70-77 illustrates different non-limiting example graphical sub-reports.

FIG. 78 is a non-limiting flow chart illustrating a process executed by a rationalization suggestion module.

FIG. 79 illustrates a non-limiting example mapping of a level of dynamism.

FIG. 80 illustrates a non-limiting example list of possible improvement actions.

FIG. 81 illustrates non-limiting example baseline and maximum savings percentages of each lever.

FIG. 82 illustrate non-limiting example savings estimates.

FIGS. 83A-K illustrate non-limiting examples of aggregation from an as-is model to a to-be model.

### DETAILED DESCRIPTION

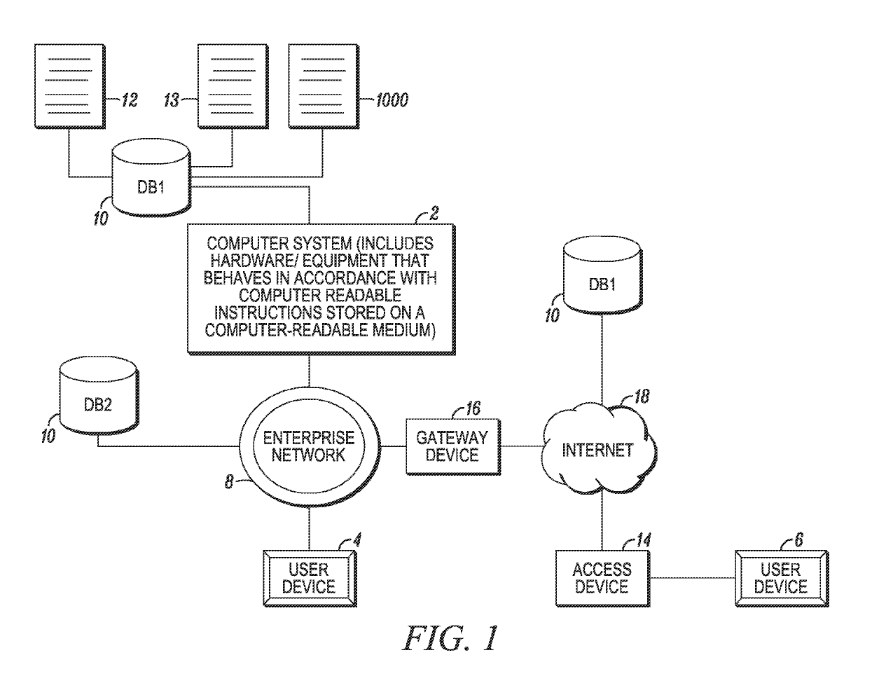

FIG. 1 shows a hardware/network architecture that may be used to support embodiments of the present invention. The architecture may include a computer system 2 (such as a desktop computer, mainframe, server, or distributed set of computers/servers) and one or more user devices 4, 6. Some user devices (e.g., user device 4) may be connected to the computer system 2 via an enterprise network 8 (e.g., a LAN). Other user devices (e.g., user device 6) may be connected to the computer system 2 via the Internet 18 or other data network. To this end, the user device may access the Internet 18 or other data network via an access device 14. Examples of a user device 4, 6 may include a laptop computer, desktop computer, tablet, smartphone, watch or wearable device, to name a few non-limiting possibilities. The computer system 2 may be connected to the Internet 18 or other data network via a gateway device 16 and, possibly, the enterprise network 8. The computer system 2 may include or have access to a memory 10. The memory 10 may comprise one or more databases, including one or more of a database that is integrated within the computer system 2, a database that is connected directly to the computer system 2, a database that is accessible via the enterprise network 8 and/or a database that is accessible via the Internet 18 or other data network.

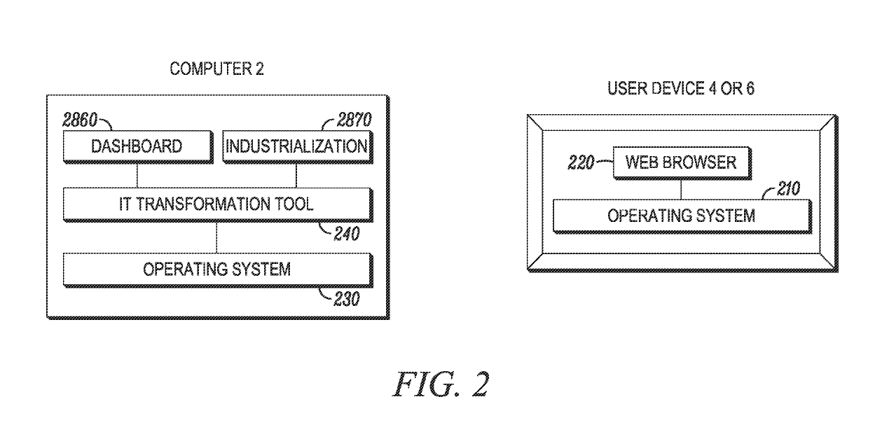

FIG. 2 shows a functional architecture that may be used to support embodiments of the present invention, wherein the computer system 2 and/or the user device 4, 6 execute novel functionality. It should be understood that the computer system 2 and the user device 4, 6 may have any suitable physical configuration that allows the functionality described herein to be executed. This could include, for example, architectures that include a central processing unit connected to one or more memory devices (e.g., magnetic disk, solid state drive, USB drive, flash drive, etc., any of which may implement ROM, RAM, EEPROM, phase change memory, etc.), an I/O interface (connected to output devices such as a screen (including a touchscreen), keyboard, microphone, etc.) and/or a network interface by one or more buses. The central processing unit (including one or more microprocessors) may execute computer-readable instructions stored in the respective memory (e.g., memory 10 in the case of computer system 2) in order to carry out the aforesaid functionality, which is described in greater detail herein below. In some embodiments, therefore, a general purpose computer with a central processing unit executing the instructions may be transformed into a specific computer executing the novel functionality described herein.

It should be appreciated that it is not material whether the computer uses binary or quantum or other forms of computing. Thus, references to a “computer” (or a “processor” or “central processing unit”) are intended to cover existing as well as future technologies capable of executing the functionalities disclosed herein.

The functional architecture of FIG. 2 may be described as having a computer-side functional component and a user-side functional component implemented by the respective hardware executing computer-readable instructions stored in memory.

The user-side functional component represents functionality that may be carried out by user device 4 or 6. The user-side functional component may include an operating system 210, which may be capable of instantiating a variety of processes, applications, services, modules or sub-modules, such as, for example, a web browser 220.

For its part, the computer-side functional component represents functionality that may be carried out by the computer system 2. The computer-side functional component may include an operating system 230. The operating system 230 may be capable of instantiating a variety of processes/applications/services including an IT transformation tool 240. The IT transformation tool 240 may be instantiated as a result of computer-readable instructions being executed by one or more processors of the computer system 2 (i.e., at least one “computer processor”). The IT transformation tool 240 may thus be implemented as a set of computer program instructions tangibly stored on at least one non-transitory computer-readable medium and executable by the at least one computer processor. Execution of these instructions involves the at least one computer processor being used to perform a variety of operations. For example, the IT transformation tool 240 may be used for instantiating one or more additional processes, applications, services, modules or sub-modules, such as, for example, an interactive dashboard tool 2860 and an industrialization tool 2870, which will be described in further detail later on.

In some embodiments, the computer system 2 comprises a management console and therefore also doubles as a user device. In such a configuration, the computer system 2 implements both the computer-side functional component and the user-side functional component.

In one aspect, the IT transformation tool 240 may be characterized as having been specifically developed to help users, such as consultants (internal and external), auditors and chief information officers (CIOs), obtain consolidated access to insightful information on vital parameters that impact the overall IT efficiency of an organization, and set up appropriate KPIs (key performance indicators) to steer change. Accordingly, the IT transformation tool 240 may be implemented as a software-as-a-service (SaaS) solution that not only provides the right level of information, but also assists in identifying transformation levers, and in tracking the effectiveness of actions that are put in place. In addition, some embodiments of the IT transformation tool 240 may facilitate a user's understanding of the organization's IT characteristics by virtue of rich visualization capabilities and a graphics-oriented approach.

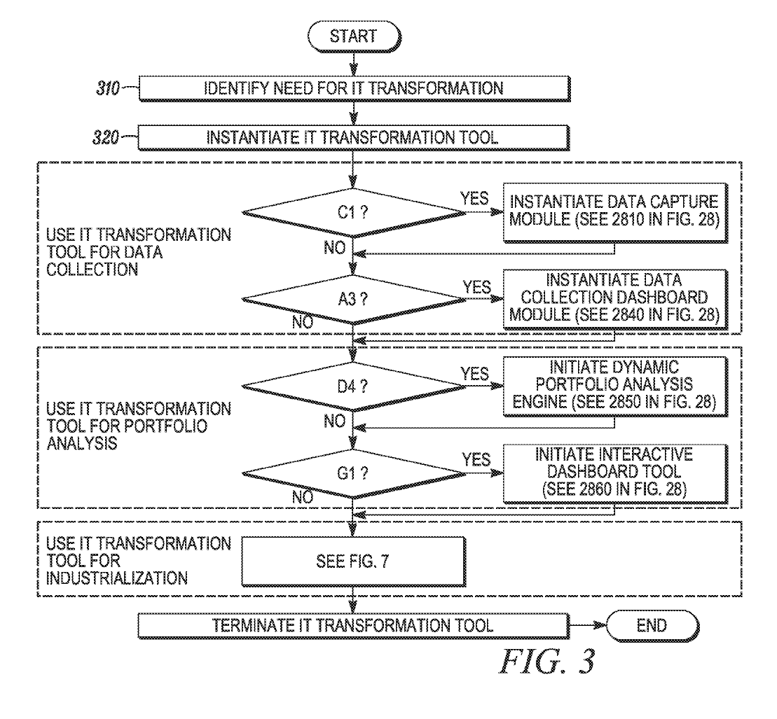

FIG. 3 represents a process that may be carried out by a user of an end user device such as user device 4 or user device 6, or computer system 2 (in the case where a management console is provided). At step 310, the user first identifies the organization's need for an IT transformation. Then, at step 320, the user may instantiate (invoke) the IT transformation tool 240 by using a graphical user interface (GUI) on the end user device 4, 6, 2. This can be done in a variety of ways.

For example, in the case where the user employs a web browser 220 implemented by the operating system 210, the web browser 220 establishes communication with the operating system 230 of the computer system 2 and provides the GUI through which the IT transformation tool 240 may be instantiated. In another example, an app may be installed on the user device 4, 6 and this app may establish a connection with the operating system 230, and provides the GUI through which the IT transformation tool 240 may be instantiated. In yet another example, the user may employ a management console at the computer system 2. The management console implements the operating system 210, which provides a GUI through which the IT transformation tool 240 may be instantiated. In the latter case, the operating systems 210 and 230 may be one and the same, meaning that the IT transformation tool 240 may launched on the user device itself.

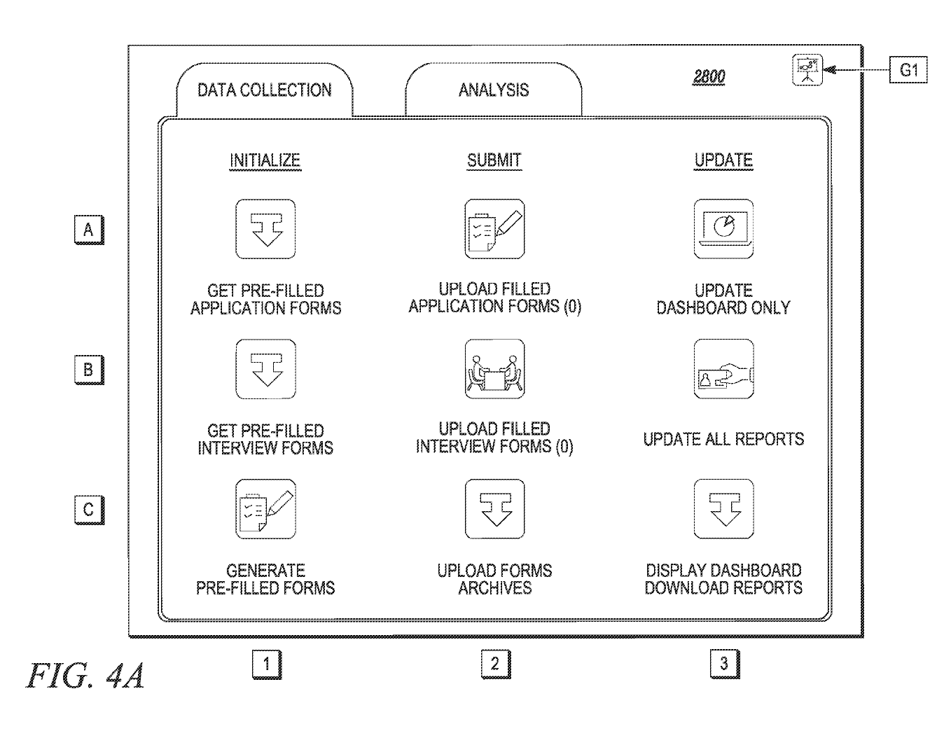

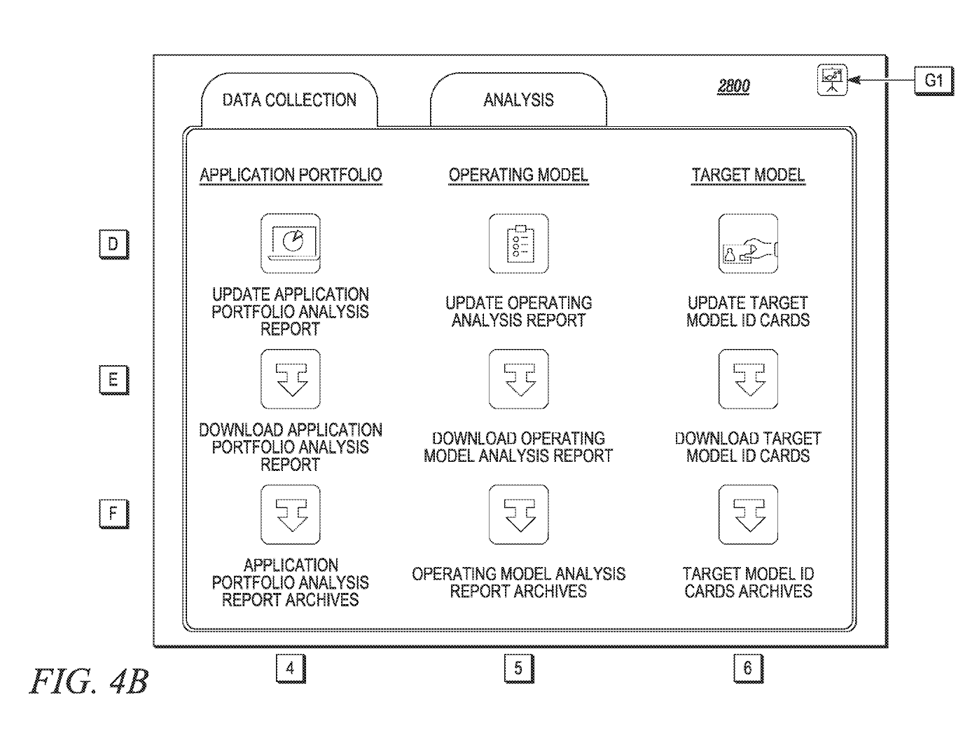

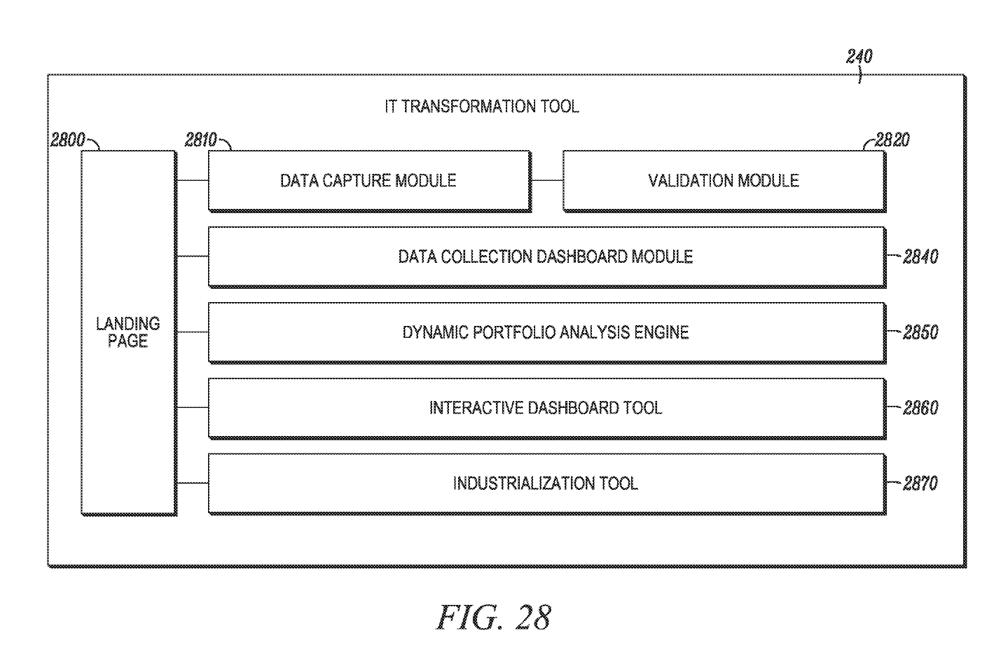

Once instantiated, the IT transformation tool 240 may present a landing page 2800 which can be made up of sub-pages such as the sub-pages shown in FIGS. 4A and 4B, each sub-page being accessible, for example, via a separate tab. Use of the IT transformation tool 240 may additionally involve instantiating one or more modules of the IT transformation tool 240 (FIG. 28) from the landing page 2800. Specifically, these modules may be accessed through GUI options presented to the user by the landing page 2800 of the IT transformation tool 240. FIGS. 4A and 4B show example of GUI options that may be associated with selectable regions of a landing page 2800 displayed on a screen. A particular option may be selected by tapping with a finger, clicking with a mouse, entering a keystroke, etc. The various GUI options are labeled by their coordinates as A1, A2, A3, B1, B2, B3, C1, C2, C3, D4, D5, D6, E4, E5, E6, F4, F5 and F6 for convenience. There is also a GUI option labeled G1, which is outside the main grid. Of course, the number, layout and labeling of GUI options is not limited to what is illustrated in FIGS. 4A and 4B. In other embodiments, for example, there may be a single landing page 2800 with no sub-pages, or there may be other configurations such as windows or layers of menus, etc.

The user may select a GUI option depending on a variety of parameters, such as the user's intended/desired use the IT transformation tool 240. FIG. 3 shows three non-limiting examples, including use of the IT transformation tool 240 for data collection, use of the IT transformation tool 240 for portfolio analysis and use of the IT transformation tool 240 for industrialization.

For example, selection of any of options C1 and A3, inter alia, may signify that the IT transformation tool 240 is to be used for data collection. Use of the IT transformation tool 240 for data collection may enable the compilation and updating of a “software applications data container” pertaining to the organization's “IT estate”. The “IT estate” may refer to the set of installed software assets (e.g., desktop software applications, mobile apps, source code, etc.) being used by or licensed to the organization. The consequences of selecting options C1 and A3 are described herein below in the section entitled “Data Collection”.

Also, selection of any of options D4 and G1, inter alia, may signify that the IT transformation tool 240 is to be used for portfolio analysis. Use of the IT transformation tool 240 for portfolio analysis may allow the compilation of a variety of reports, benchmarks and/or metrics, and can also be used to instantiate the interactive dashboard tool 2860. As well, use of the IT transformation tool for portfolio analysis can allow the production of reports suggesting rationalization/decommissioning of individual software assets. The consequences of selecting options D4 and G1 are described herein below in the section entitled “Portfolio Analysis”.

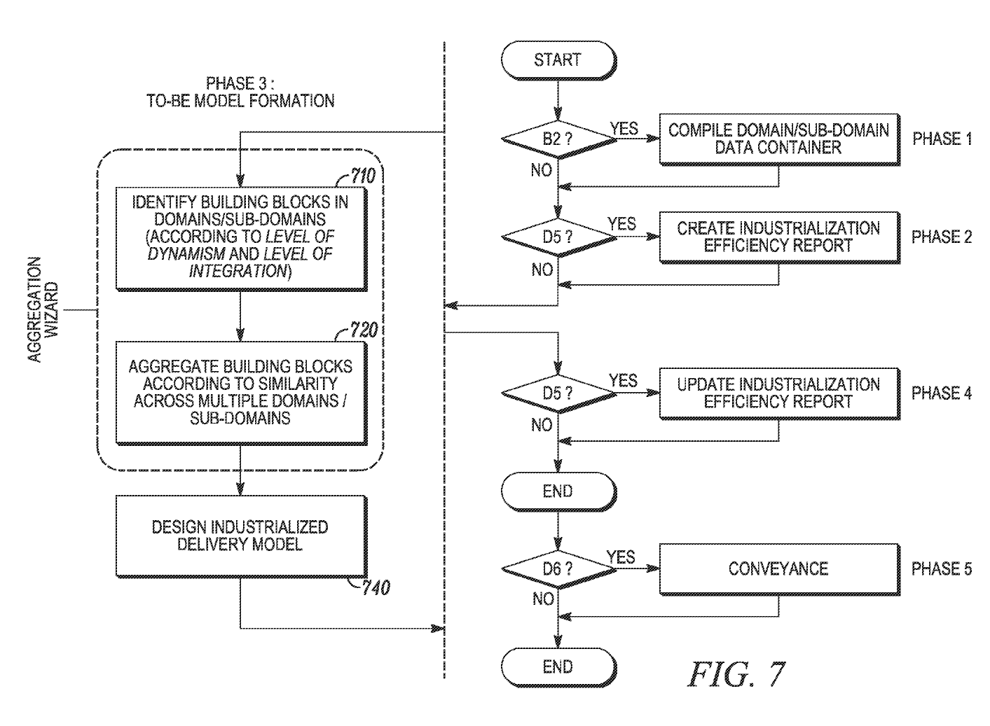

Also, selection of any of options B2, D5 and D6 may signify that the IT transformation tool 240 is to be used for industrialization. Use of the IT transformation tool 240 for industrialization may allow additional information to be gathered about the organization and can allow creation of a target industrial model. Upon selection of one of the aforementioned options, the IT transformation tool 240 proceeds with the steps shown in FIG. 7, which will be described herein below in the section entitled “Industrialization”.

### (i) Data Collection

With continued reference to FIG. 28, operation of the IT transformation tool 240 when used for data collection (in particular, further to selection of any of options C1 and A3) will now be described.

Option C1

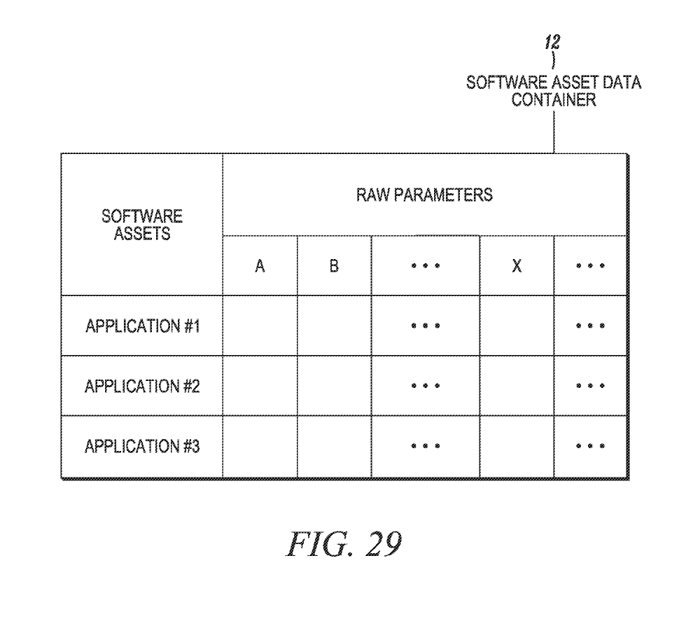

The selection of option C1 from the landing page 2800 may instantiate a data capture module 2810 of the IT transformation tool 240. The data capture module 2810 may cause the computer system 2 to present a graphical user interface (GUI) that provides an opportunity for the user to load a template from the memory 10. With reference to FIG. 29, the template 2900 may include a table of rows and columns whose entries are initially blank. Each row identifies a corresponding software asset (e.g., desktop software application, mobile app, source code, etc.) that may form part of the organization's IT estate. Each column in a particular row identifies a particular “raw” parameter for the software asset corresponding to that row. A “raw” parameter may refer to a category of data that is entered by the user into the template 2900, for one or more software assets in the IT estate corresponding to an IT transformation project.

As the template 2900 is populated with entries, they are stored/recorded in the form of a software asset data container 12 for the IT transformation project, which is stored in the memory 10 (see also FIG. 1). In the memory 10, the software asset data container 12 may be linked to a particular IT transformation project by way of an index or identifier. The value ascribed to a certain raw parameter could be a score, a level, an actual count of an event, a YES/NO answer, a description, etc., potentially from a limited menu of choices. When the IT estate consists of a large number of software assets, or where there is a large number of raw parameters to be evaluated, it is possible for multiple users to participate in the populating/completion of the software asset data container 12 for the IT transformation project.

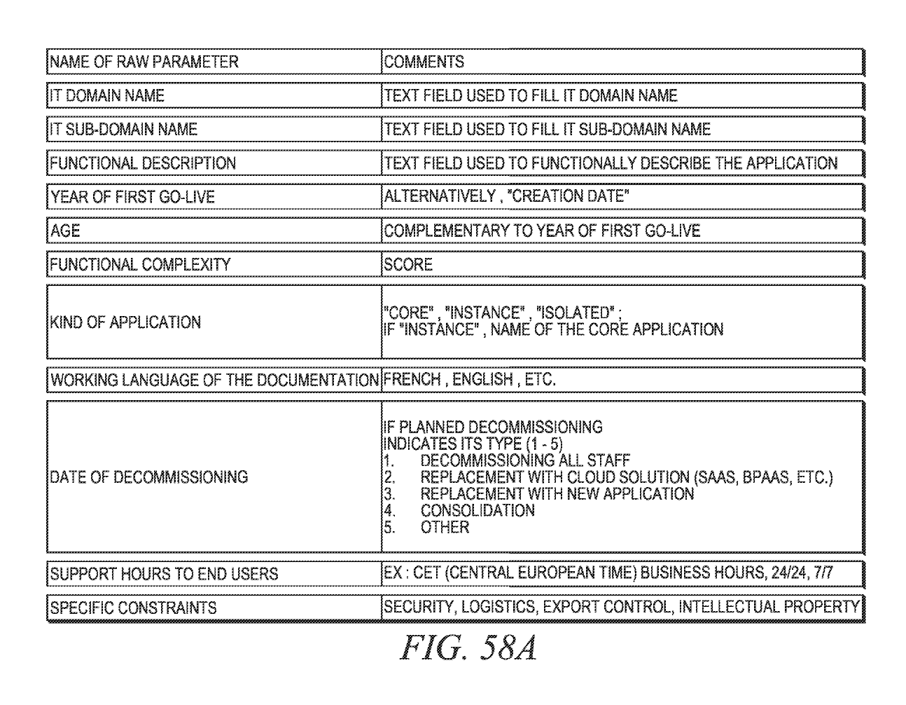

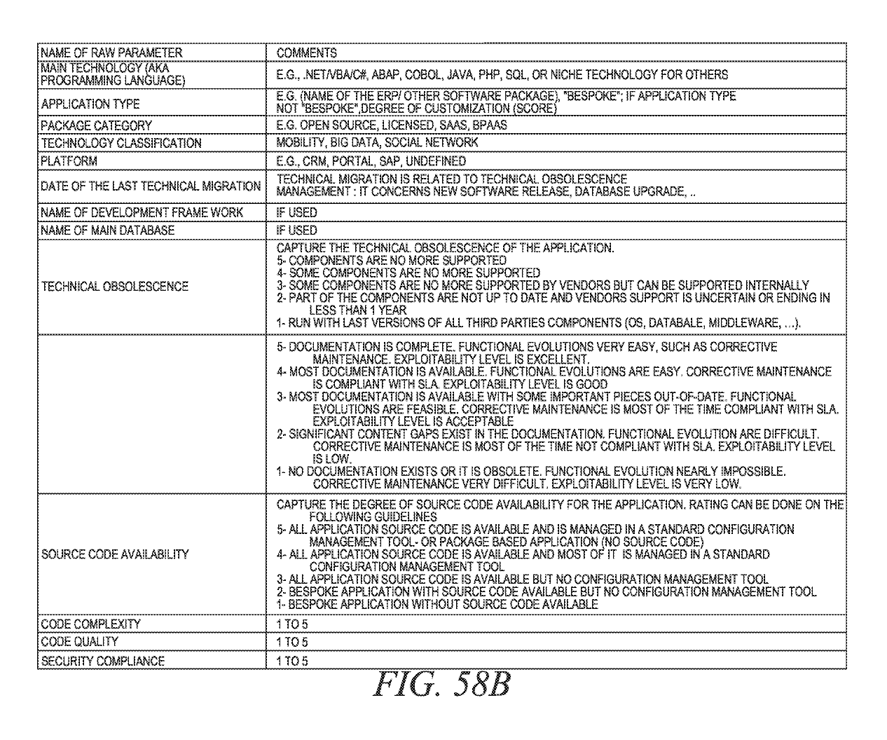

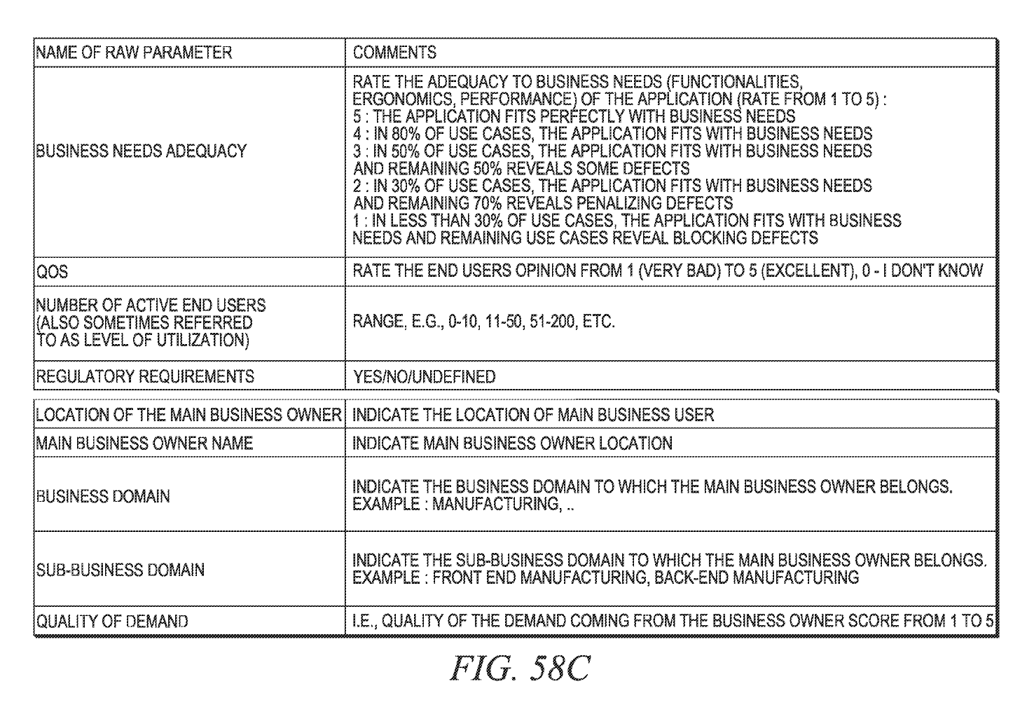

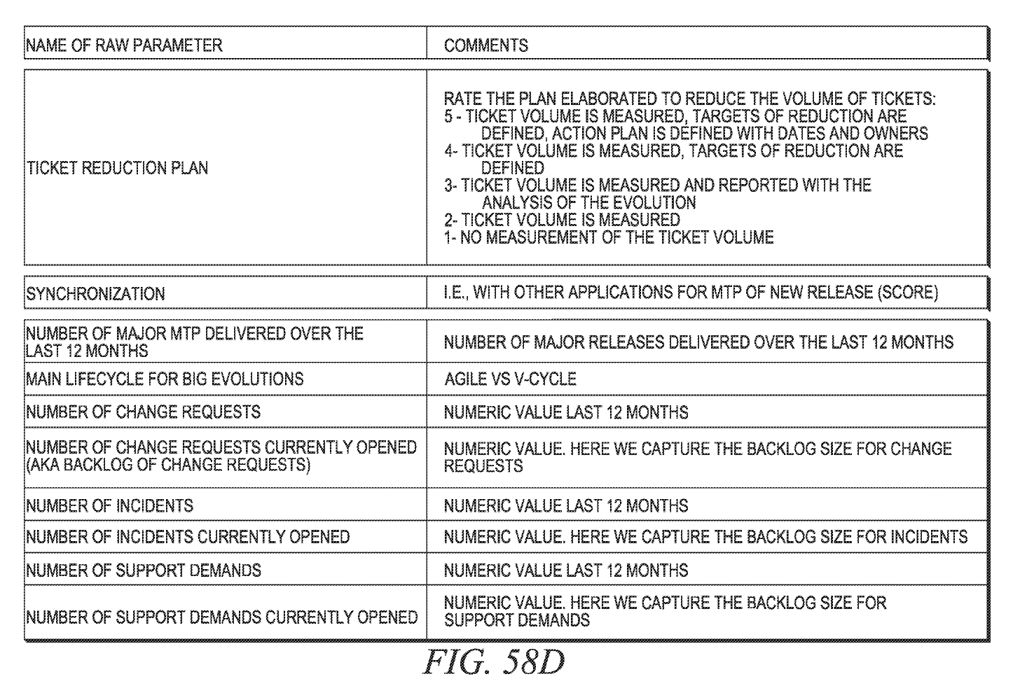

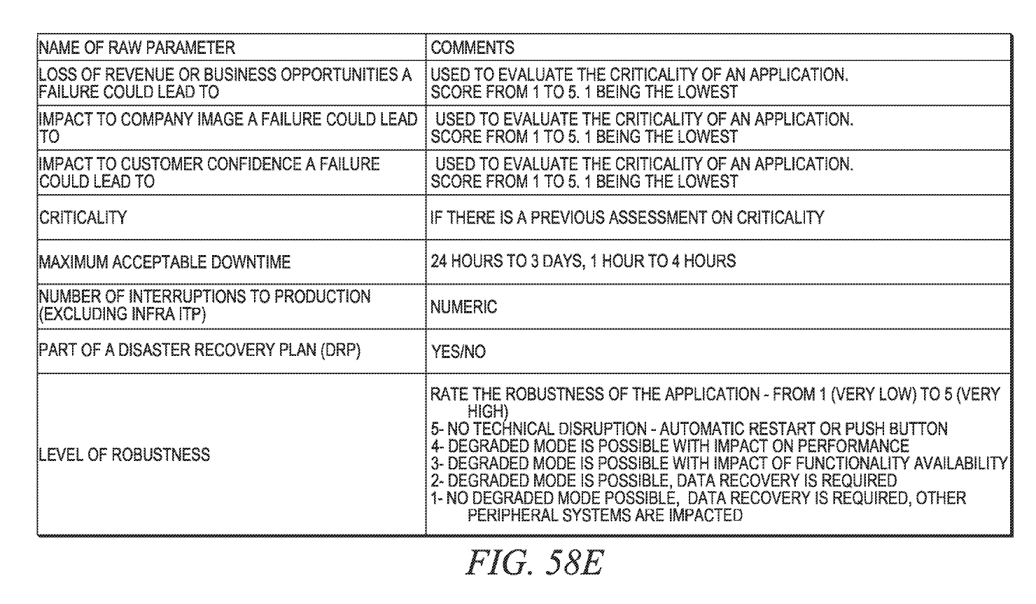

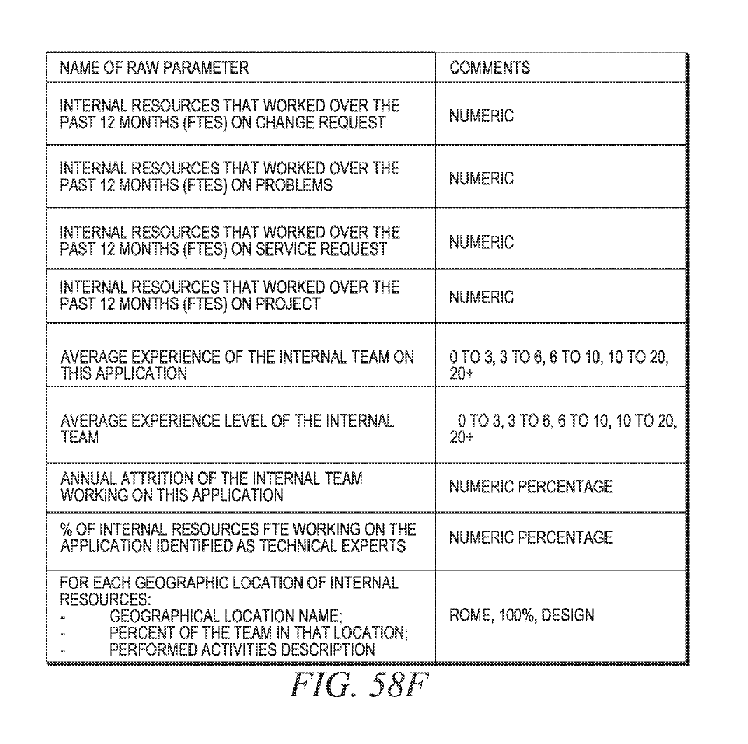

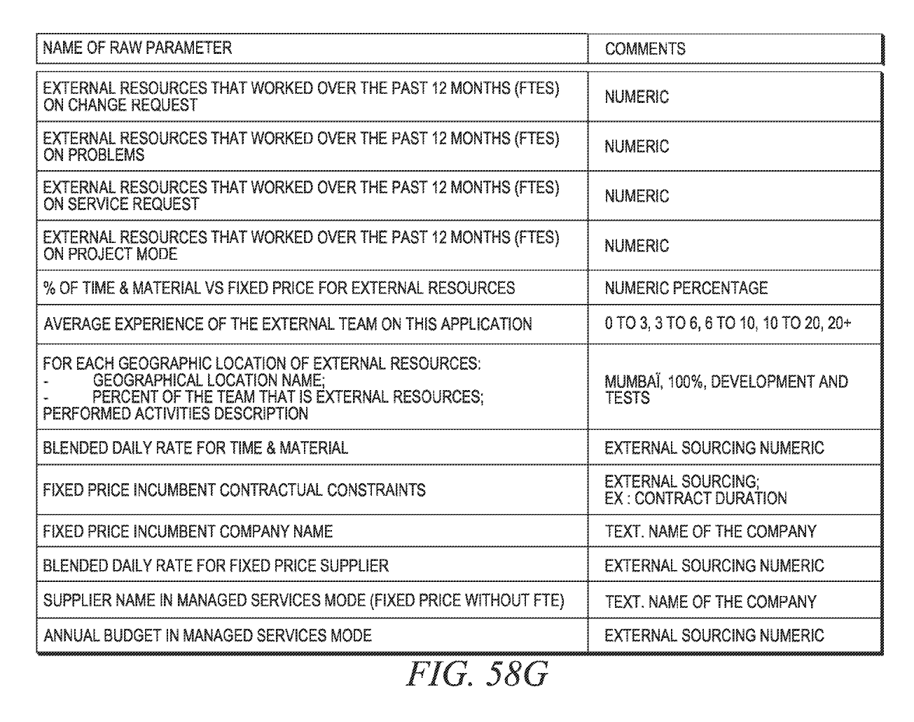

Non-limiting examples of raw parameters are listed in FIGS. 58A to 58G, together with examples of possible values that can be taken on by particular raw parameters.

Other raw parameters are of course possible and within the scope of the present invention. Conversely, it is not necessary to include, in the software asset data container 12, an entry for each of the aforementioned raw parameters. Moreover, it is also possible to categorize/divide the set of raw parameters into categories. Non-limiting examples of categories include:
o General information (FIG. 58A)
Main technical elements (FIG. 58B)
Business angle (FIG. 58C)
Lifecycle (FIG. 58D)
Criticality (FIG. 58E)
Internal sourcing (FIG. 58F)
External sourcing (FIG. 58G)

In addition, the data capture module 2810 can be rendered “intelligent” by providing data quality control of certain entries. For example, when a proposed value is submitted for a particular entry of the software asset data container 12, the data capture module 2810 may use a set of rules to validate this proposed value against permitted (or disallowed) values (also stored in the memory 10), which may themselves be preconfigured or computed from other entries in that row (or other rows). This allows the user to be certain that the data entered has a minimum threshold of validity. To this end, the data capture module 2810 may invoke a validation module 2820. The validation module 2820 may be a process defined by computer-readable instructions stored in the memory 10 and executed by the computer system 2.

For example, consider a rule whereby when the user has specified that the Application Type for a particular application is “bespoke”, the Degree of Customization for the particular application field must be specified in the software asset data container 12, otherwise no Degree of Customization should be supplied. In the case where this rule is not respected, this may be detected by the validation module 2820, and the data capture module 2810 may in turn issue an error message to the user via the aforementioned GUI. Multiple such rules can be embedded in the functionality of the data capture module 2810, resulting in a computerized assist being provided to a user during data entry.

With the software asset data container 12 having been completed by one or more users and captured (e.g., stored in the memory 10), the user may proceed to instantiate other modules of the IT transformation tool 240.

Option A3

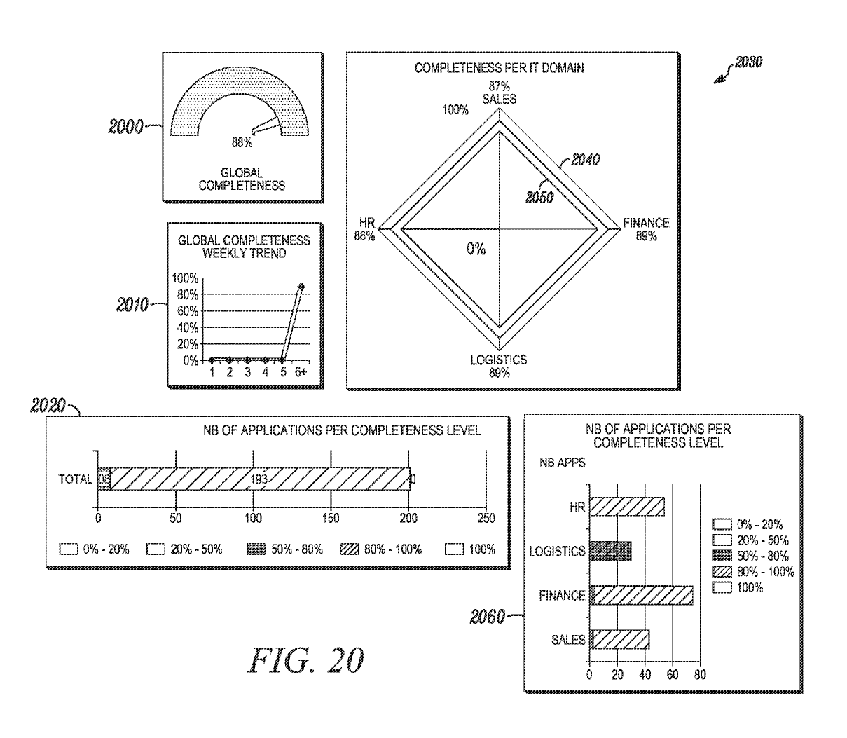

The selection of option A3 from the landing page 2800 may instantiate a data collection dashboard module 2840 of the IT transformation tool 240. In other embodiments, it may be possible to directly instantiate the data collection dashboard module 2840 directly, without going through the landing page 2800, such as by way of a separate mobile app or icon. The data collection dashboard module 2840 may cause the computer system 2 to create and/or update a data collection dashboard (an example of which is shown in FIGS. 20-22). The data collection dashboard provides the user with an indication of the progress at which data collection (i.e., the progress of completion of the software asset data container 12) is occurring within the organization (e.g., in different departments of the organization). It is noted that the user who instantiates the data collection dashboard module 2840 may differ from the user who completes the software asset data container 12 using the data capture module 2810.

In an example, the data collection dashboard may include a variety of “completeness components”, each of which may convey completeness of the software asset data container according to one or more aspects.

Thus, for example, and with reference to FIG. 20, a global completeness component 2000 may illustrate the number of entries in the software asset data container 12 that have been completed as of the present time as a percentage of the total number of entries that are expected to be completed. Although illustrated as a needle diagram in FIG. 20, the global completeness component 2000 could be expressed in any other suitable form, including an alphanumeric display of the percentage, a pie diagram, a completion bar, a virtual thermometer, etc.

In addition, a progressive completeness component 2010 may illustrate the progressive (i.e., over time) evolution of completeness, starting with 0 at the outset and tending towards 100 percent at the end. The progression can be illustrated in terms of a data point, line, symbol, etc., for each week, day, hour, month or any other increment. Increments along either axis can be linear, logarithmic or other.

In addition, completeness may be measured at the level of individual software assets, i.e., to what extent a particular row of the software asset data container 12 (corresponding to a particular software asset) is complete. In that sense, the rows corresponding to different software assets may be at different degrees of completion and rows having a degree of completion within a certain range may be ascribed a different indicator (e.g., color), so as to convey to the user the relative proportion of software assets that are within different bands of degrees of completion. In the example shown, a chart 2020 illustrates that the rows for 193 (out of a total of 201) software assets are 80-100% complete while the rows for the remaining 8 software assets are 50-80% complete.

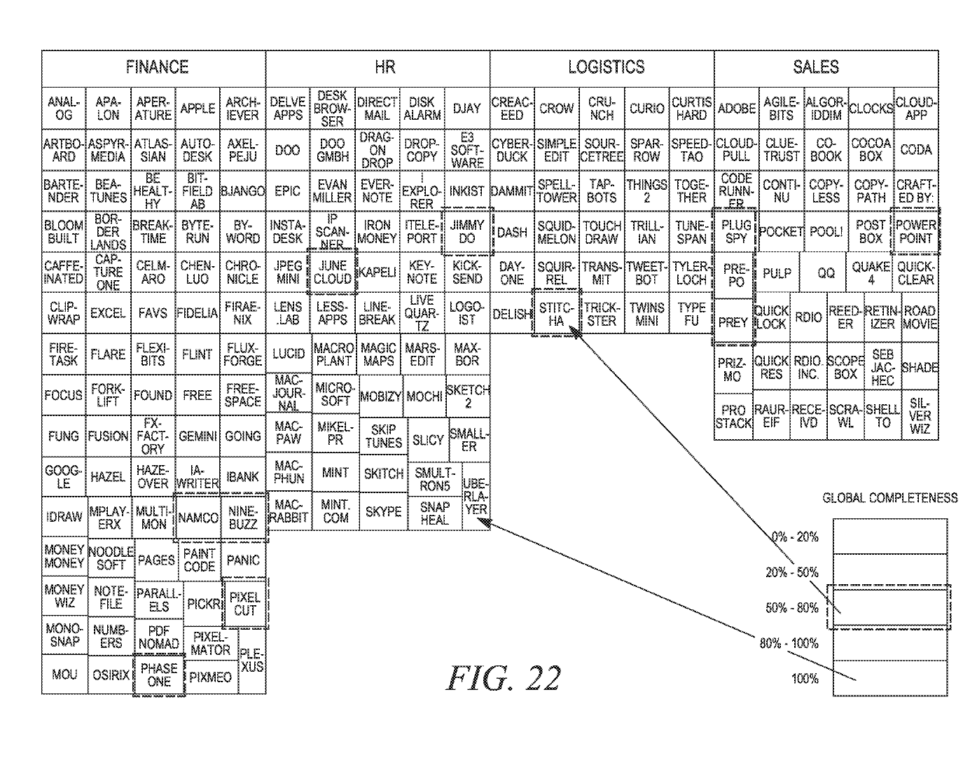

In a variant (see FIG. 22), each individual software asset can be represented, optionally in alignment with its corresponding IT domain (in this case, the IT domains include Finance, HR, Logistics and Sales), and can be encoded in accordance with the band to which it belongs. Thus, in the example of FIG. 22, it is seen that eleven (11) software assets (4 from Finance, 2 from HR, 1 from Logistics and 4 from Sales) are in the 50%-80% completion band, while the remaining (>100) software assets are in the 80%-100% completion band.

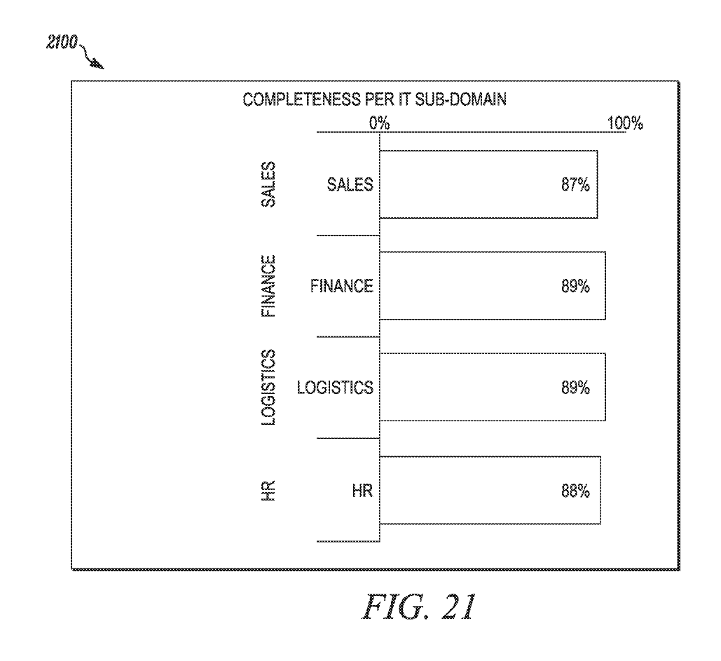

In addition, as shown in FIG. 21, a per-domain completeness component 2100 can be generated. This component computes an overall degree of completeness of all rows corresponding to software assets associated with a particular IT domain (e.g., HR, Logistics, Finance, Sales), as determined from the IT Domain Name raw parameter. This can allow the user to pinpoint domains for which it is taking longer to complete the software asset data container 12, or may be indicative of a particular domain being so shortstaffed that it is dragging down the global completeness percentage (as seen from the global completeness component 2000).

In addition, a relative completeness component 2030 (see FIG. 20) may convey the same results as the per-domain completeness component 2100 (see FIG. 21), however in this case, a regular polygon 2040 with X vertices is drawn, each vertex representing a respective IT domain at 100% completion. In this case, the four vertices form a square. Inside, a second polygon 2050 is drawn in which the vertices correspond to the individual IT domains but have a proximity to the corresponding vertex of the regular polygon 2040 that is inversely proportional to the percent completeness of the rows of the software asset data container 12 for the software assets in that specific IT domain. In the illustrated example, completeness in each of the IT domains is in the 87-88% range and therefore the inside polygon 2050 very closely resembles a smaller version of the outside (regular) polygon 2040. However, when some domains are significantly more or less complete than other domains, this would be readily perceived by the user as the inside polygon would appear significantly deformed relative to the outside polygon. As such, the user may be inclined to take measures to investigate the possible cause of delay/imbalance so as to stimulate or accelerate completion of the software asset data container 12.

In addition, a per-domain tally component 2060 may be generated. This component determines the number of rows within each band of completeness for software assets in a given IT domain, as determined from the IT Domain Name raw parameter. In that sense, the rows of the software asset data container 12 corresponding to different software assets may be at different degrees of completion and software assets for which the corresponding row of the software asset data container 12 has a degree of completion within a certain range may be ascribed a different indicator (e.g., color, shading, thickness, etc.), so as to convey to the user the relative proportion of software assets for which the corresponding rows of the software asset data container 12 are within a particular band of degrees of completion. Results may be conveyed in such a way as to show, for each IT domain, the total number of rows to be completed and the degree of completeness of each row of the software asset data container 12 (where each tow is associated with a software asset).

One feature of the aforementioned completeness components is that they can be dynamic, meaning that they change as the entries in the software asset data container 12 are populated. That is to say, the source of the data used to convey the completeness components may be the memory 10 in which the software asset data container 12 is stored. As such, changes in the software asset data container 12 may be automatically reflected, in real time, in the output of the various completeness components generated by the data collection dashboard module 2840. Clearly such a feature goes well beyond what would be achievable if completeness of the software asset data container 12 were to be measured or signaled by a human being.

Of course, it is clear that various forms or degrees of completeness could be conveyed in various other ways that would be visually meaningful, so as to provide the user with valuable insight into the state of completeness of the software asset data container 12.

In an embodiment, the data collection dashboard could also be generated/partitioned into micro-reports on a per-department (or per-IT subdomain) basis and distributed to department heads, allowing them to assess how completion of the software asset data container is progressing.

### (ii) Portfolio Analysis

With continued reference to FIG. 28, operation of the IT transformation tool 240 when used for portfolio analysis (in particular, further to selection of options D4 and G1) will now be described.

Option D4

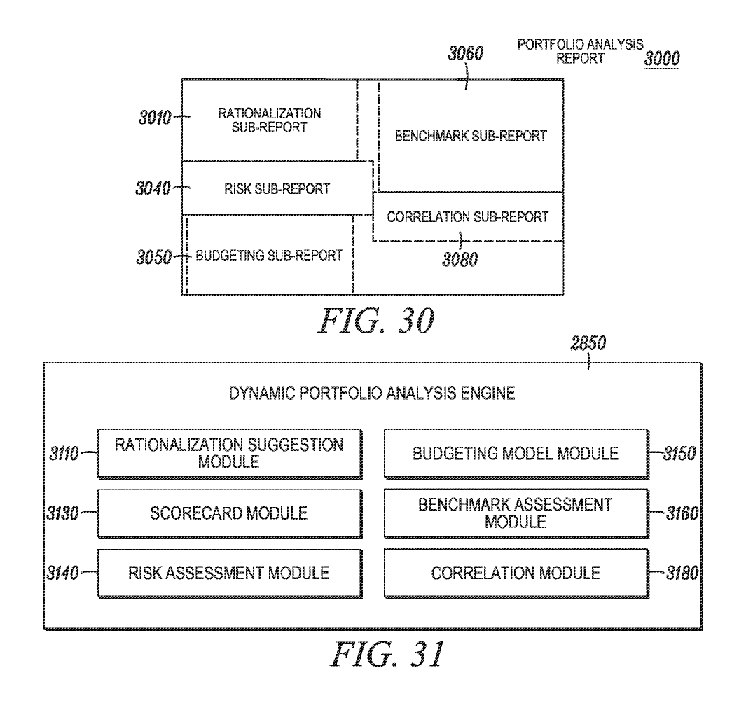

The selection of option D4 from the landing page 2800 may instantiate a dynamic portfolio analysis engine 2850 of the IT transformation tool 240. Specifically, the selection of option D4 signals that the user wishes to use the dynamic portfolio analysis engine 2850 in order to create or update a portfolio analysis report 3000 (see FIG. 30). The portfolio analysis report 3000 may be dynamically constructed based on the information in the software asset data container 12, which may be updated dynamically as conditions change or the software asset data container becomes more heavily populated.

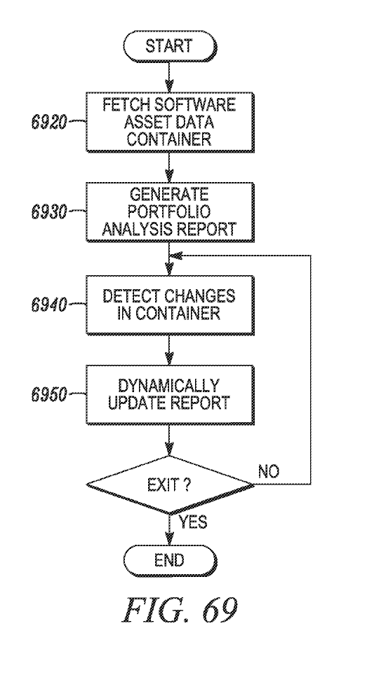

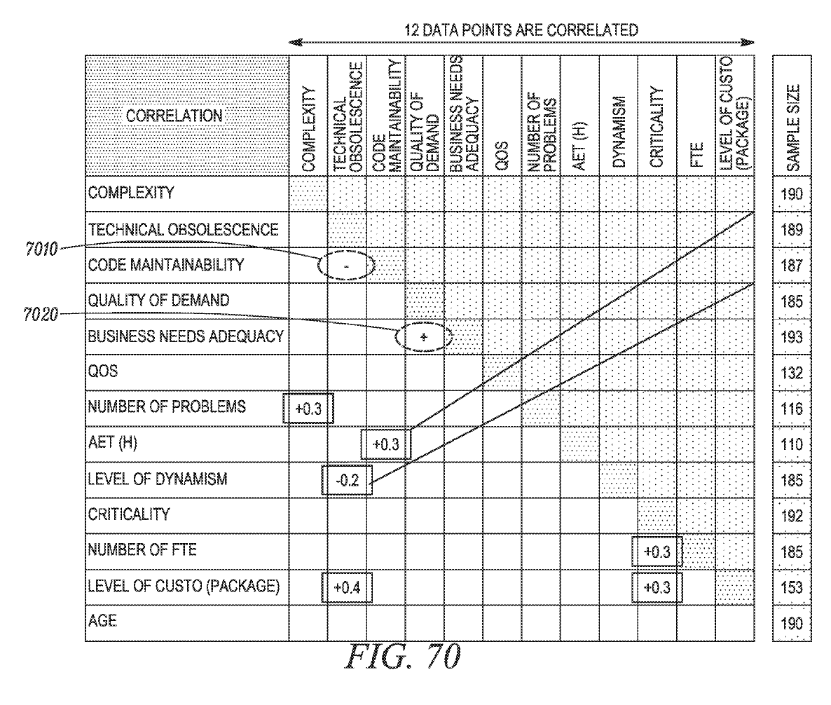

With reference to FIG. 69, there are shown steps in a process executed by the dynamic portfolio analysis engine 2850 in generating and updating the portfolio analysis report 3000. Specifically, at step 6920, the software asset data container 12 is accessed/fetched from the memory 10. At step 6930, the portfolio analysis report 3000 is generated based on the content of the software asset data container 12 and caused to be displayed on an output device (e.g., a screen of devices/systems 4, 6, 2). At step 6940, changes in the software asset data container 12 are detected. Such changes may manifest themselves as changes to the values ascribed to the raw parameters in certain entries of the software asset data container 12 and/or the appearance of altogether new entries in the software asset data container 12. At step 6950, the portfolio analysis report 3000 is updated and caused to be displayed on the output device. Further changes to the software asset data container 12 may result in further adjustments to the contents of the portfolio analysis report 3000 and the manner in which it is displayed on the output device, and so on. Due to the loopback nature of the process executed by the dynamic portfolio analysis engine 2850 and due to the computational power of the processor 2, changes that could affect the user's perception of the organization's IT effectiveness will become apparent in real-time or near-real time.

Step 6930, i.e., generation of the portfolio analysis report 3000, will now be described in greater detail for ease of understanding. The portfolio analysis report 3000 may include a variety of sub-reports generated by a variety of sub-modules of the dynamic portfolio analysis engine 2850, as shown in FIG. 31. The individual sub-modules of the dynamic portfolio analysis engine 2850 may be implemented as subsets of computer program instructions tangibly stored on at least one non-transitory computer-readable medium (e.g., in the memory 12) and executable by the at least one computer processor of the computer system 2. The individual sub-modules may be instantiated individually by the user, or they may be instantiated on an as-needed basis by the dynamic portfolio analysis engine 2850. The sub-modules may include one or more of the following non-limiting set of sub-modules:
a scorecard module 3130;
a rationalization suggestion module 3110;
a risk assessment module 3140;
a budgeting module 3150;
a benchmark assessment module 3160;
a parameter correlation module 3180.

The aforementioned sub-modules will now be described in greater detail.

Scorecard Module

The scorecard module 3130, may produce “scorecards” that bring to light a wide set of characteristics of the software assets in the IT estate. These characteristics can include the raw parameters mentioned above as having been entered by one or more users, as well as one or more “derived” parameters. A “derived” parameter may be derived from one or more raw parameters and possibly one or more other derived parameters, but in contrast to a raw parameter is not supplied by the user. Once computed, the derived parameters may be stored in the software asset data container 12 alongside the raw parameters, or elsewhere in the memory 10.

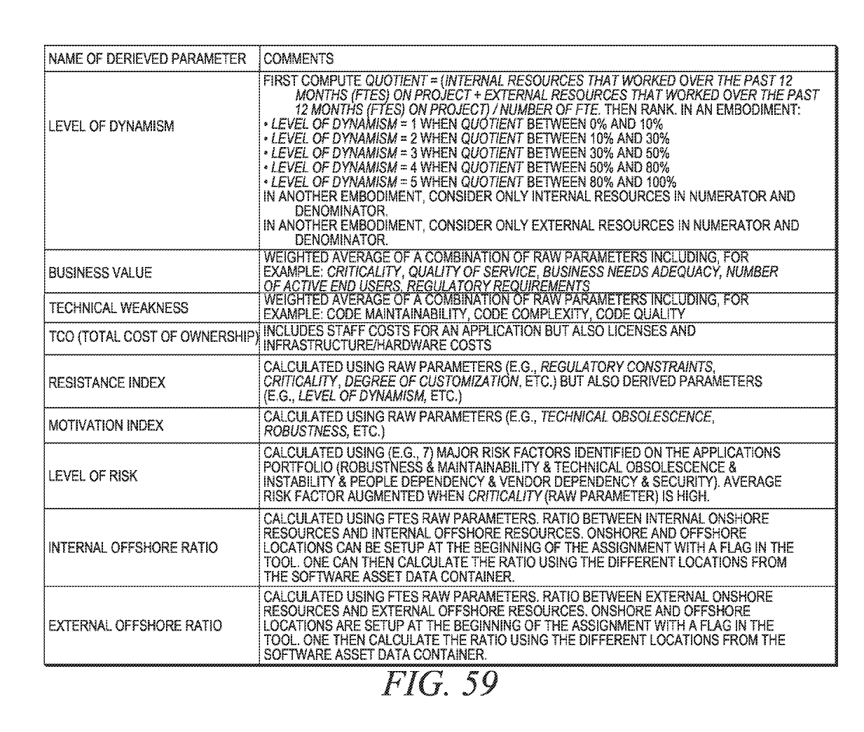

Non-limiting examples of derived parameters are shown in FIG. 59. In addition, there is provided an explanation of how the derived parameters are computed.

To create the scorecards illustrative of raw parameters and derived parameters, the scorecard module 3130 may execute a computer-implemented process. This process may be performed by at least one computer processor executing computer program instructions tangibly stored on at least one non-transitory computer-readable medium (such as the memory 10). In particular, this process could be instantiated as part of the IT transformation tool 240, and therefore could be performed by the at least one computer processor in the computer system 2.

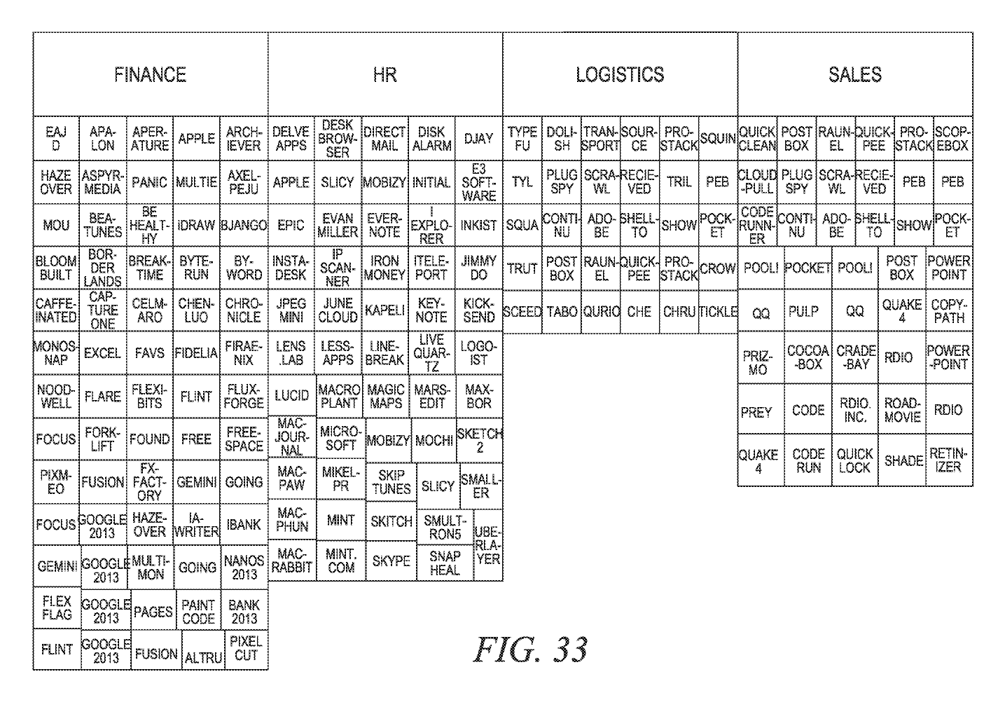

In accordance with a non-limiting embodiment, and with reference to FIGS. 33 to 47 and 60-63, a scorecard can be viewed as including a graphically representable data structure defining a group of graphical elements, each of which represents one (or more) of the software assets in the IT estate and can be conveyed to the user in a perceptible form. Although the graphical elements may on some drawings be illustrated as rectangular “bricks”, it should be understood that this is not a requirement, as the graphical elements may be graphically conveyed as triangles, circles or even non-geometric figures. The graphical elements may also have a two-dimensional or three-dimensional appearance.

The scorecard module 3130 may implement a mechanism for allowing the identity of the software asset represented by each of the graphical elements to be ascertained by the user. This can be achieved through providing a hyperlink that is graphically accessible by the user (e.g., by clicking, tapping, mousing over, etc.), or through displaying the name of the software asset in proximity (or within) the graphical element, or through a variety of other mechanisms.

Moreover, each graphical element may be graphically displayed so as to simultaneously and independently convey the value of at least two (raw or derived) parameters related to the underlying software asset. It is envisaged that when displayed collectively within a scorecard, all the graphical elements convey the same at least two parameters of the respective software asset represented by each brick.

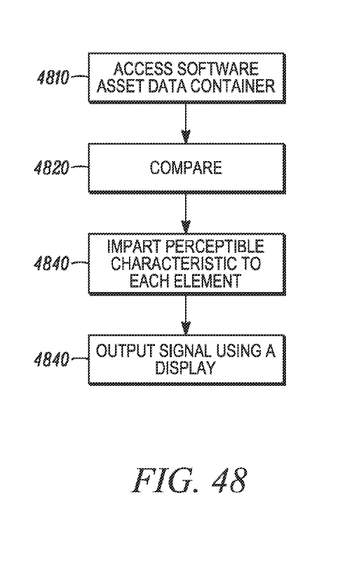

Accordingly, execution of the scorecard module 3130 may include a variety of operations, as shown in the flowchart in FIG. 48 that will now be described.

A first operation 4810 may include communicating with the memory 10 to access the software asset data container 12, which includes raw parameters (collected) and derived parameters (derived).

A subsequent operation 4830 may include comparing one or more of the raw and/or derived parameters to predetermined thresholds that are stored in the memory 10.

A further operation 4840 may include imparting to each graphical element a plurality of independent perceptible characteristics, each perceptible characteristic corresponding to the value ascribed to a corresponding one of the (raw or derived) parameters related to the software asset represented by that graphical element. Examples of perceptible characteristics that are of a visual nature may include on-screen position (horizontal, vertical, azimuthal, radial, etc.), color, size, border thickness, transparency, font, shape or other. This perceptible characteristic is modulated (e.g., changed in quantity, intensity or style) from one graphical element to the next based on the value of the corresponding parameter, as applicable to the software asset represented by the graphical element in question. While the perceptible characteristics are described in detail below as being mostly visual characteristics, this is not to be considered a limitation of the present invention.

Finally, the scorecard module 3130 may execute an operation 4850 in which a signal is output to a display, the signal conveying the graphical elements and in particular their respective perceptible characteristics.

By way of non-limiting example, a first perceptible characteristic of each graphical element may be the size of the graphical element and the corresponding parameter of the software asset represented by that graphical element may be Number of FTE (which can be the sum of Internal Resources that Worked Over the Past 12 Months (FTEs) on Change Request, Internal Resources that Worked Over the Past 12 Months (FTEs) on Problems, Internal Resources that Worked Over the Past 12 Months (FTEs) on Service Request, Internal Resources that Worked Over the Past 12 Months (FTEs) on Project, External Resources that Worked Over the Past 12 Months (FTEs) on Change Request, External Resources that Worked Over the Past 12 Months (FTEs) on Problems, External Resources that Worked Over the Past 12 Months (FTEs) on Service Request and External Resources that Worked Over the Past 12 Months (FTEs) on Project in FIGS. 58F and 58G).

Therefore, simply stated, in this example, the size of a graphical element representing a particular software asset reflects the number of full-time equivalent employees assigned to the particular software asset.

Also, a second perceptible characteristic of each graphical element may be a location of the graphical element along an x-direction and the corresponding parameter of the underlying software asset may be IT Domain Name (raw parameter). Therefore, simply stated, the location along the x-axis of a graphical element that represents a particular underlying software asset is related to the IT Domain to which the particular software asset belongs.

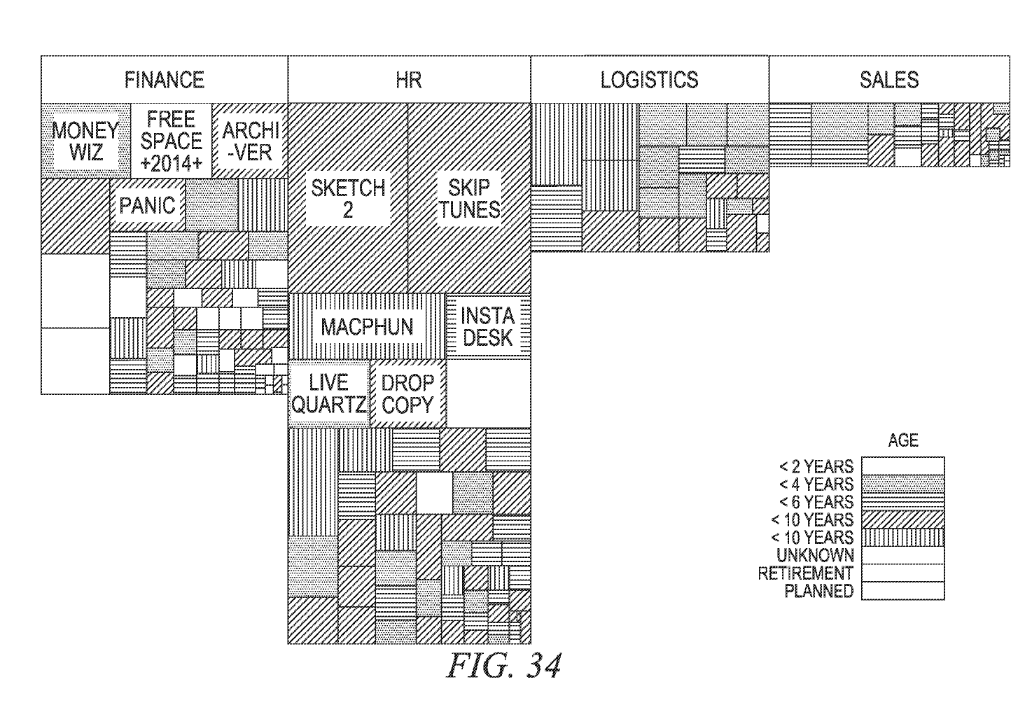

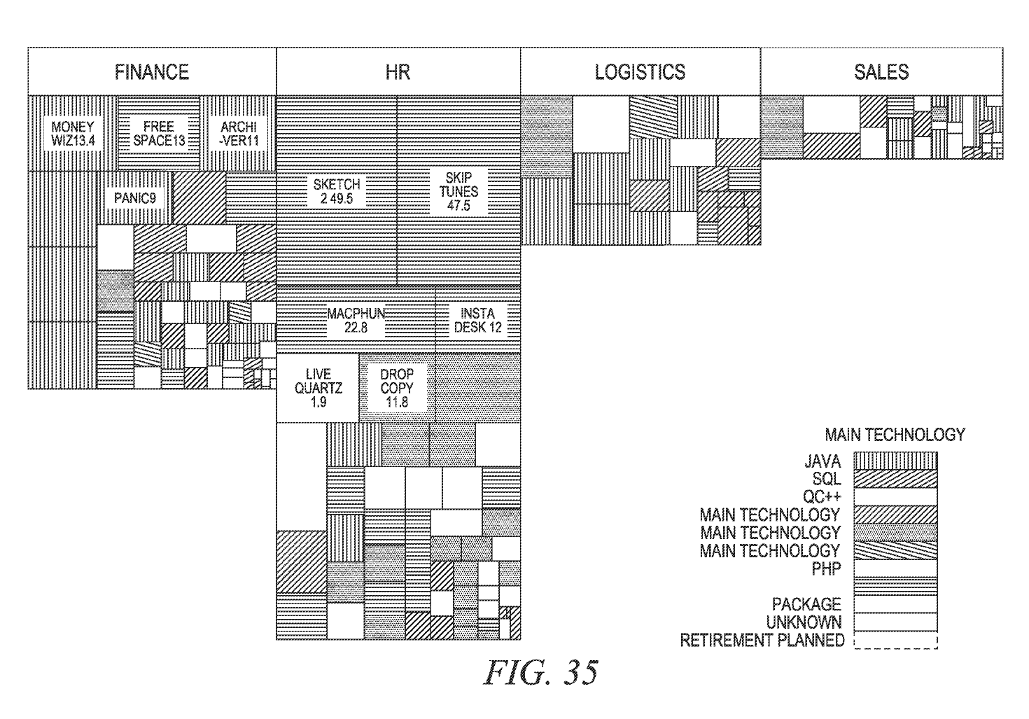

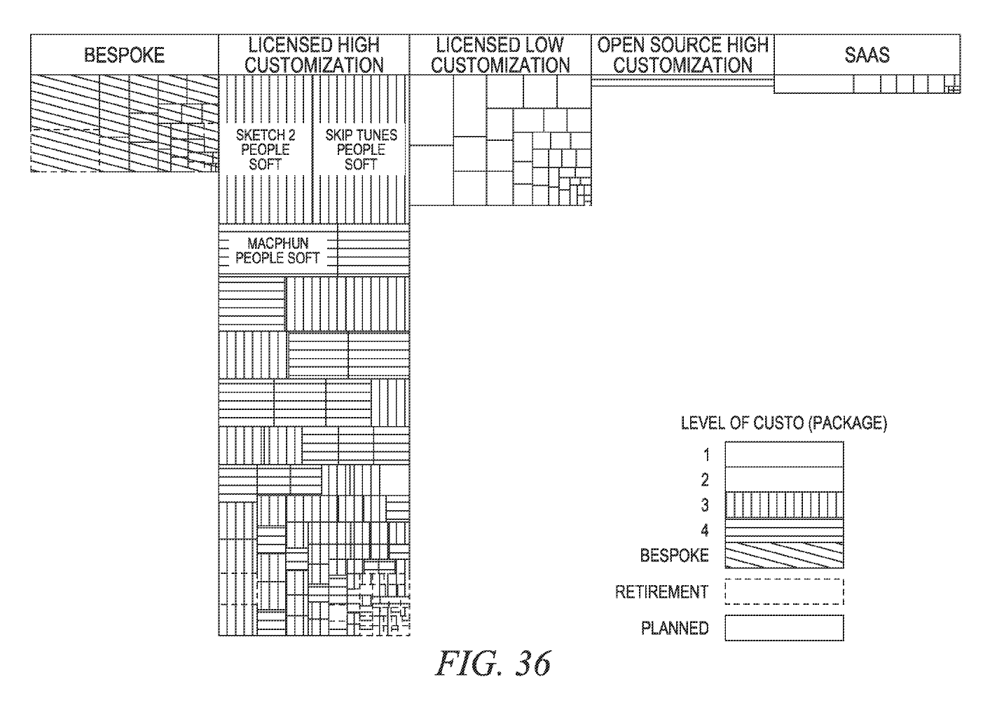

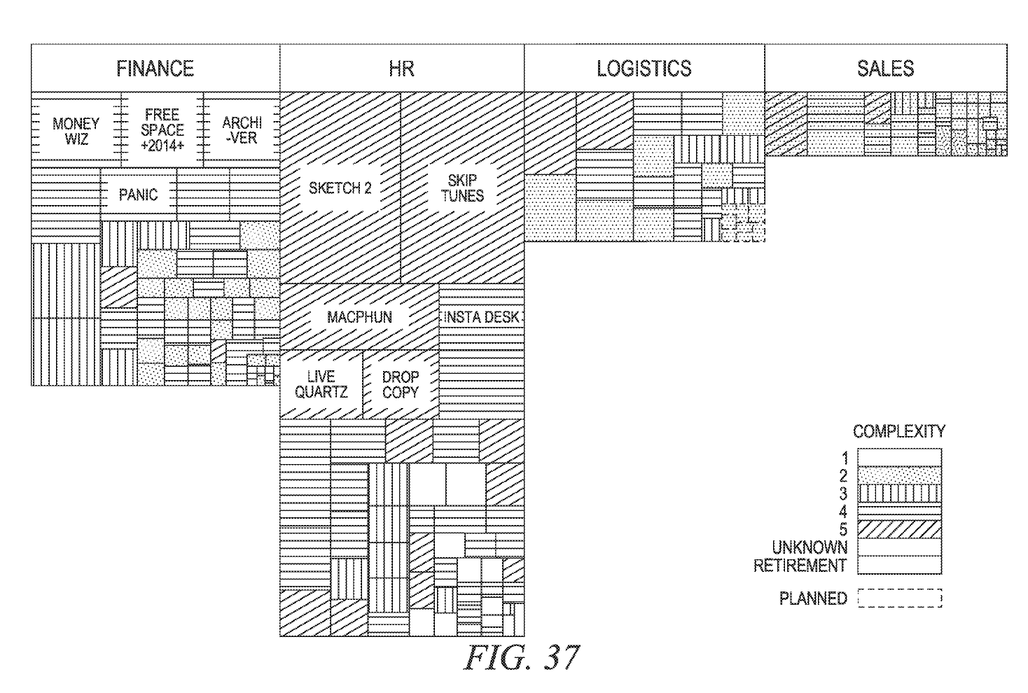

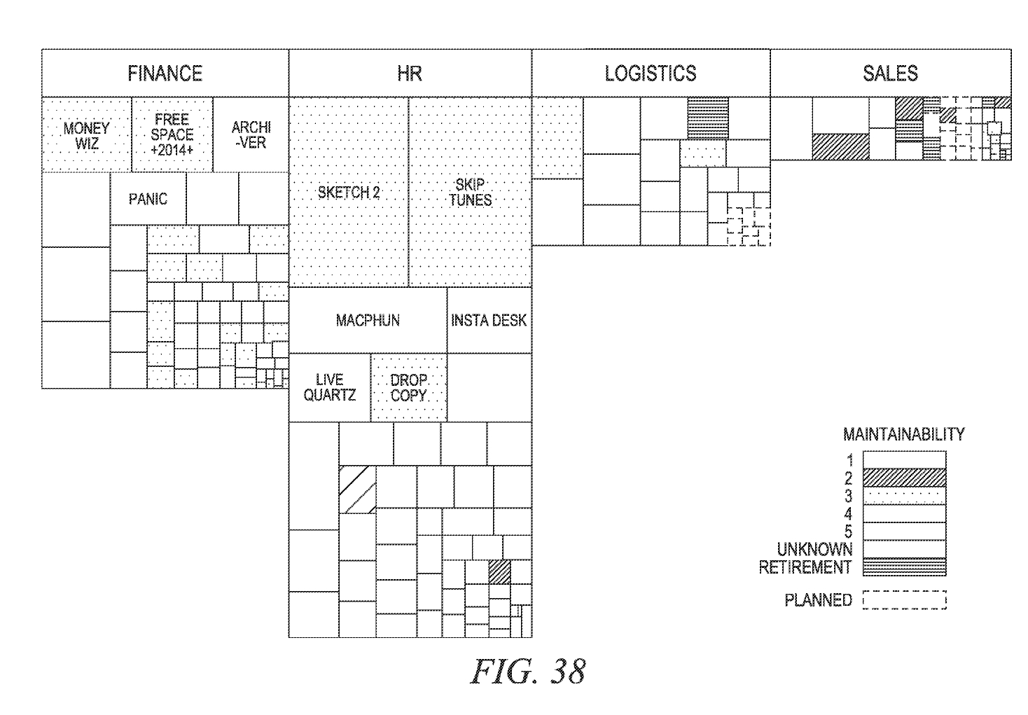

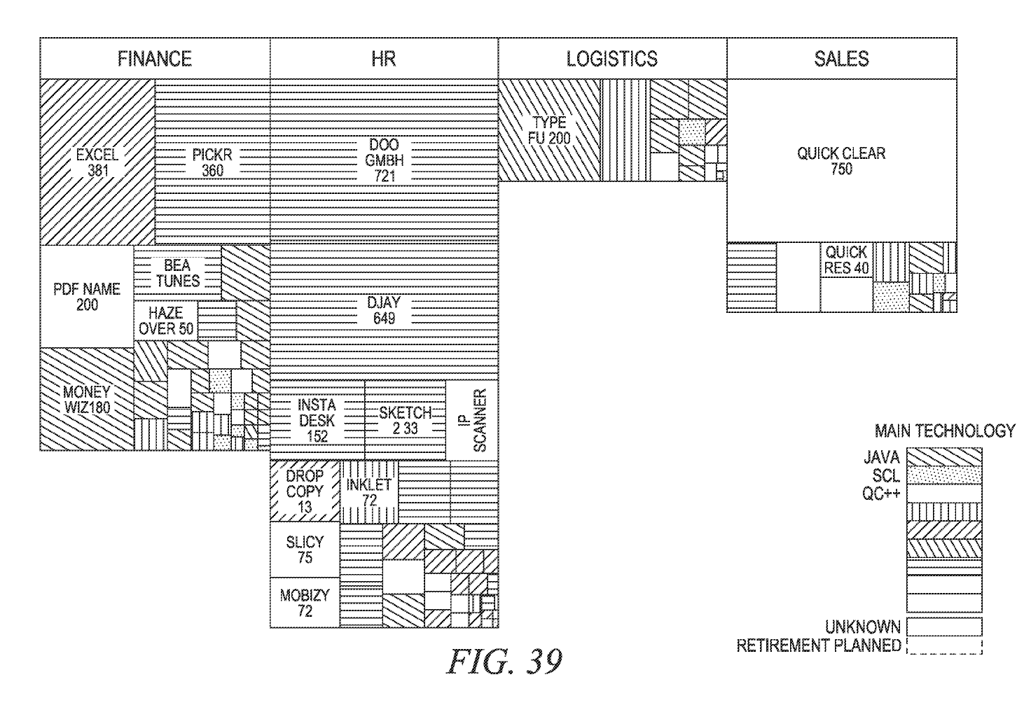

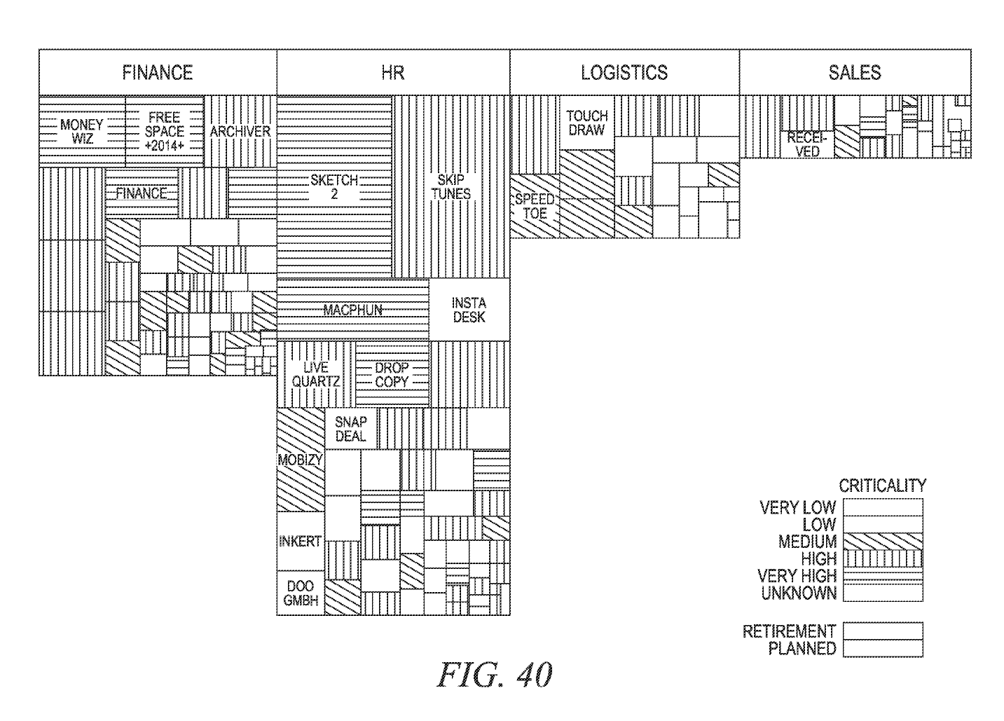

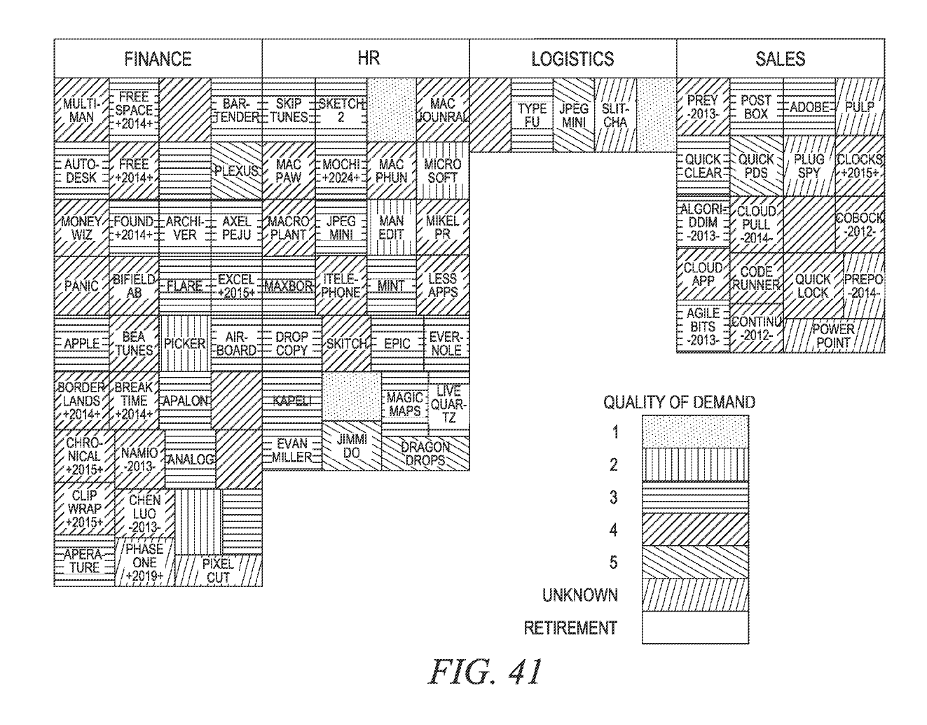

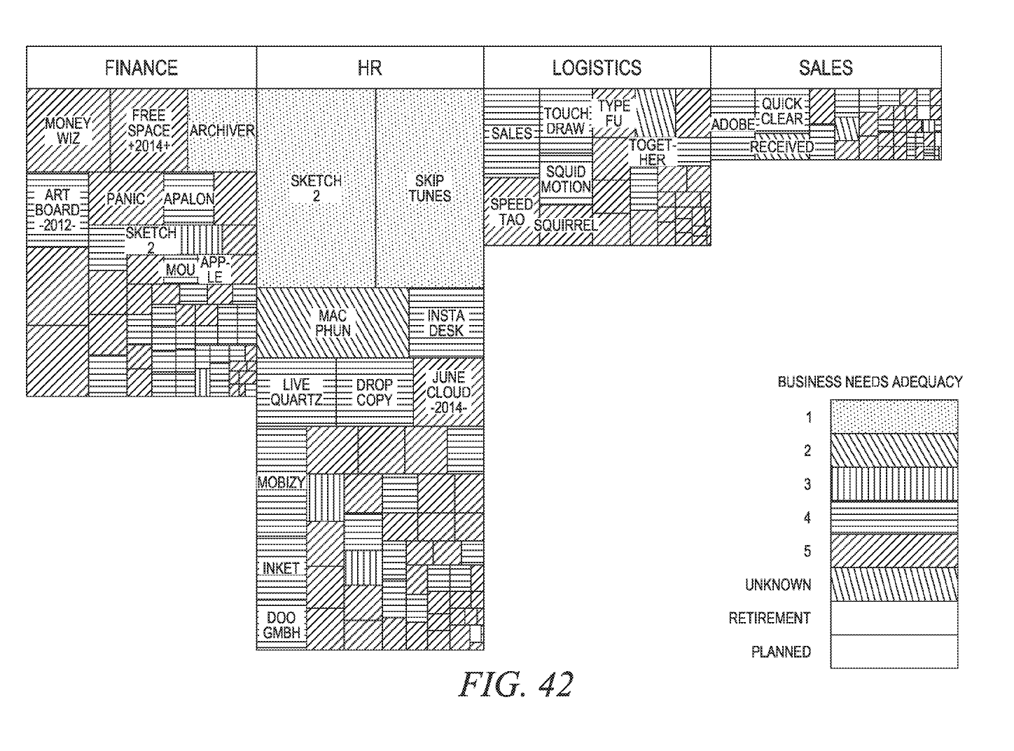

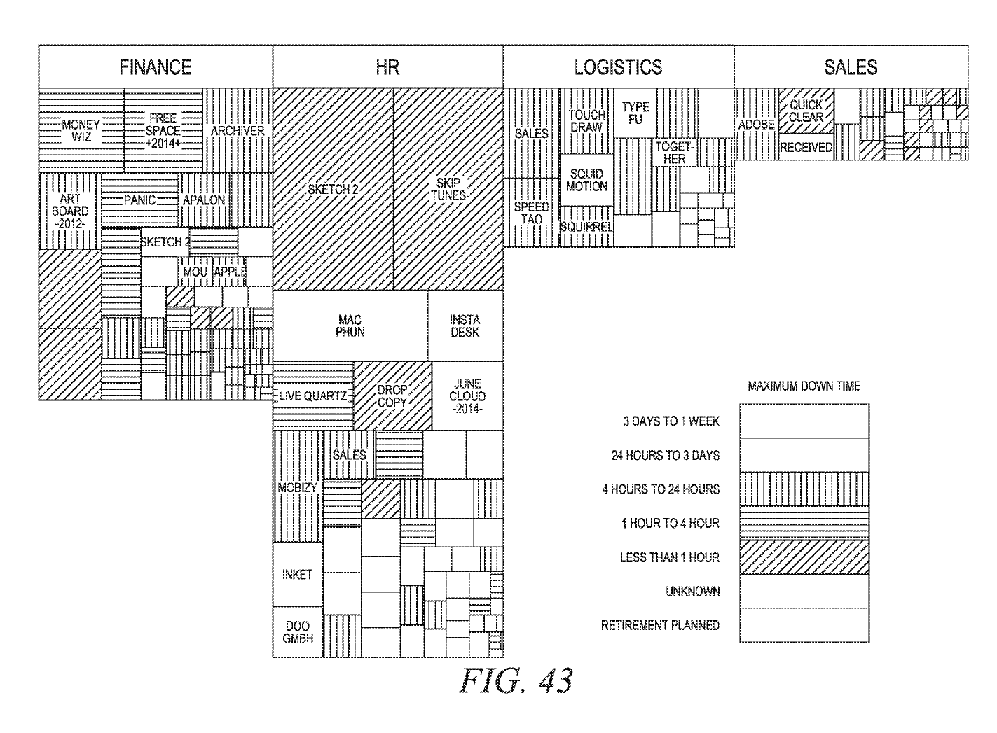

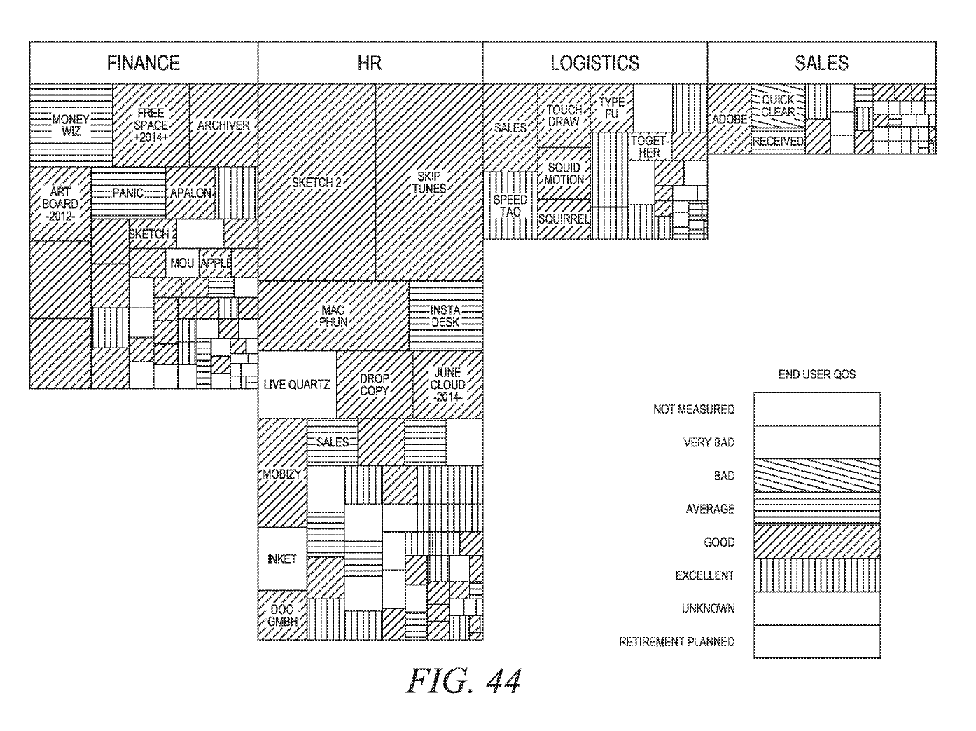

A third perceptible characteristic may also be conveyed by the graphical element. For example, this could be by way of the graphical element's color (and/or the color or thickness of the border). The corresponding parameter of the particular underlying software asset may be, for example, another one of the aforementioned raw or derived parameters. Different examples where the third perceptible characteristic corresponds to one of the raw parameters are shown in some of the accompanying drawings:
Date of Decommissioning (see FIG. 33)
Year of First Go-Live (see FIG. 34)
Main Technology (aka Programming Languages) (see FIG. 35)
Degree of Customization (see FIG. 36)
Functional Complexity (see FIG. 37)
Code Maintainability (see FIG. 38)
Number of Incidents Currently Opened (see FIG. 39)
Criticality (see FIG. 40)
Quality of Demand (see FIG. 41)
Business Needs Adequacy (see FIG. 42)
Maximum Acceptable Downtime (see FIG. 43)
QOS (see FIG. 44)

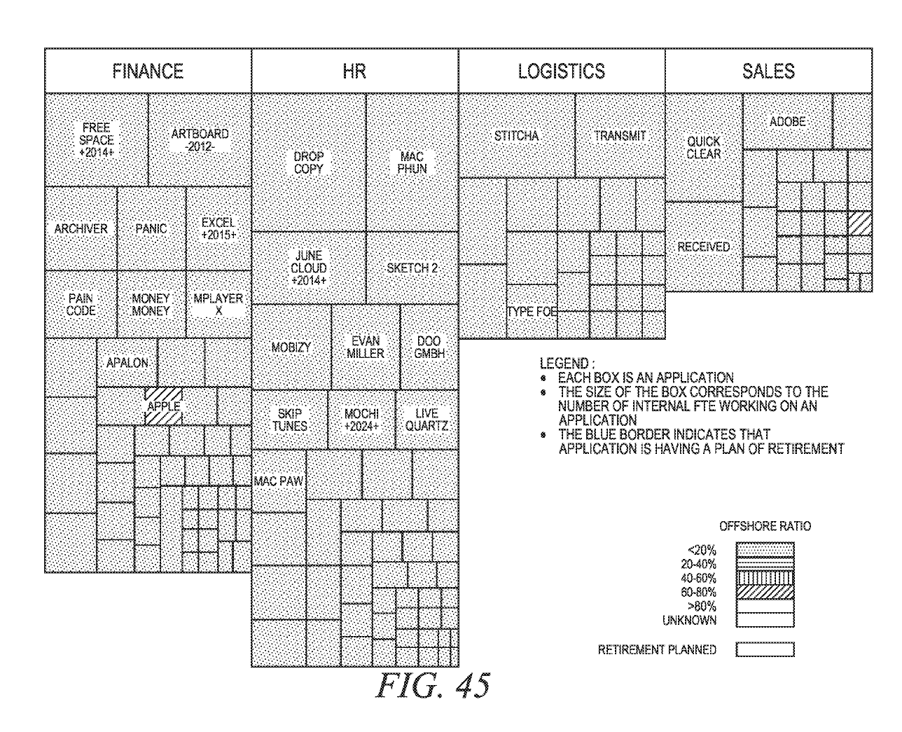

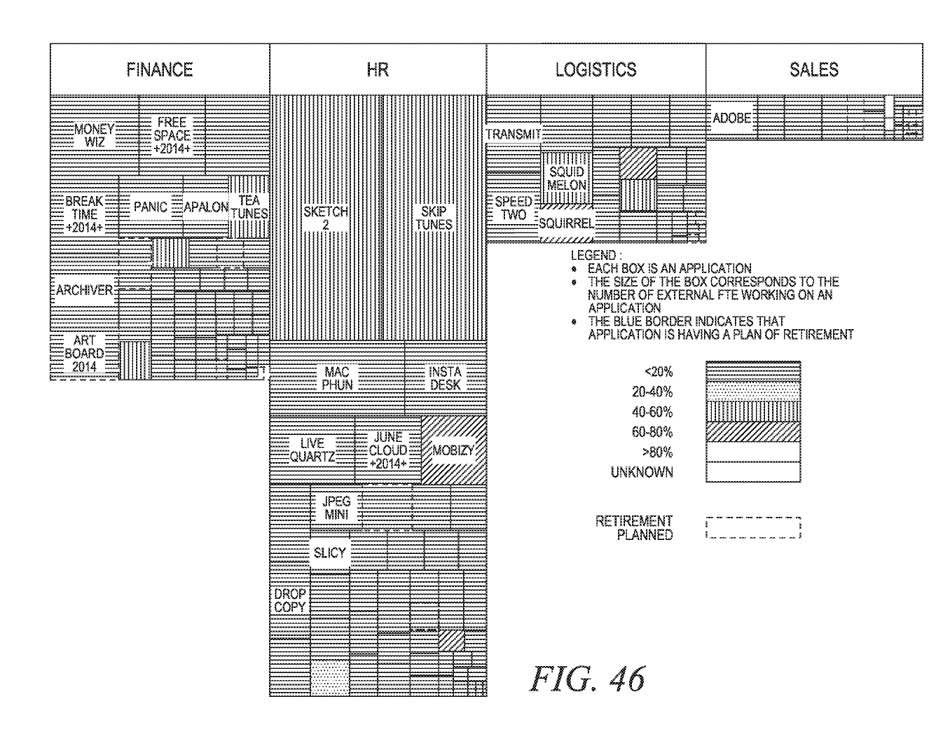

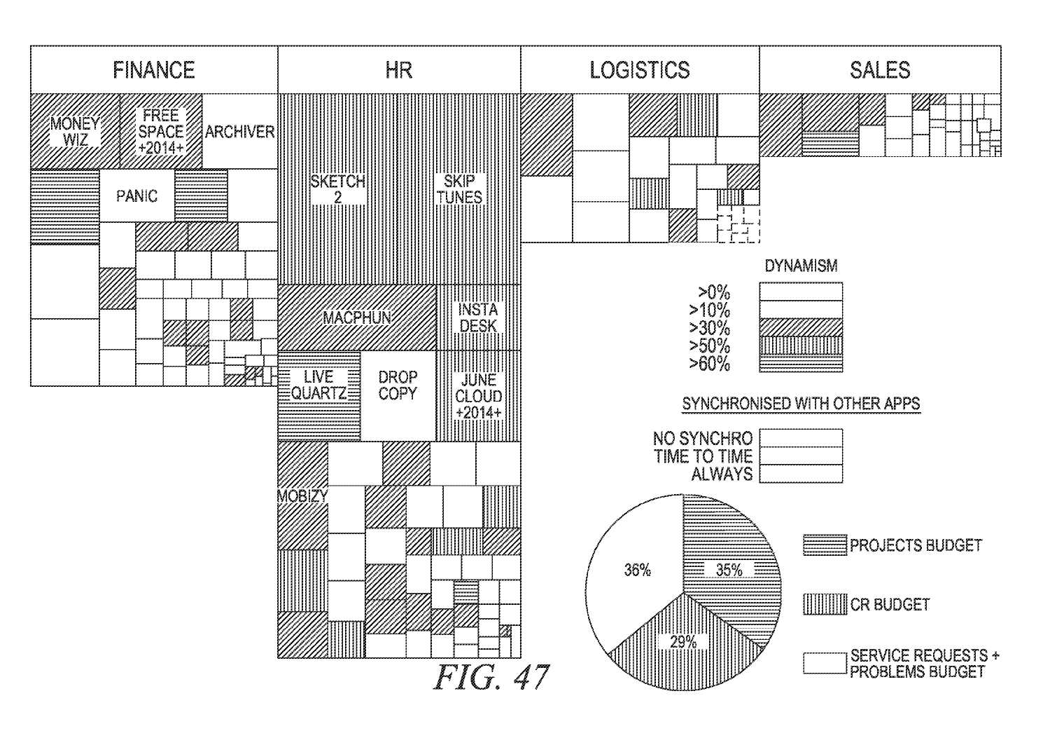

In other examples, the parameter corresponding to the third perceptible characteristic (in this non-limiting example case, the color of the graphical element) may also be any one of the following derived parameters:
Internal Offshore Ratio (see FIG. 45)
External Offshore Ratio (see FIG. 46)
Level of Dynamism (see FIG. 47)

According to another non-limiting embodiment, it is envisaged that all graphical elements could be made of equal size. For example, in the above cases, all graphical elements represented could be made to have the same size, and the other two perceptible characteristics would remain representative of the corresponding parameters as indicated above.

In yet another alternative embodiment, one or more of the perceptible characteristics may be a font, a border thickness, a fill/texture of the graphical element, etc.

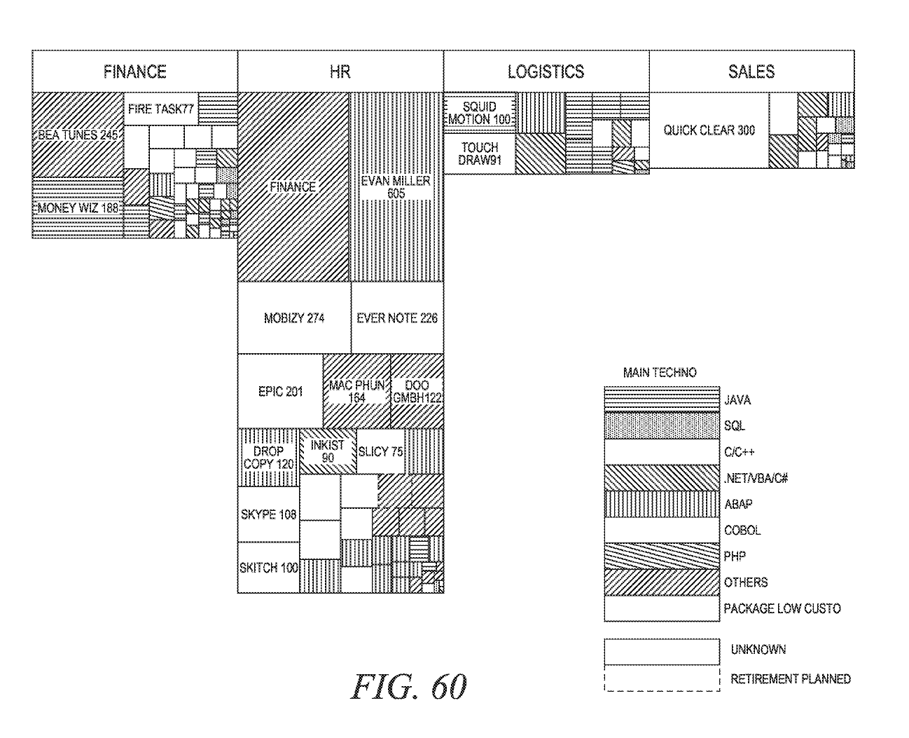

In another alternative embodiment shown in FIG. 60, a first perceptible characteristic of each graphical element may be the size of the graphical element and the corresponding parameter of the software asset represented by that graphical element may be Number of Change Requests Currently Opened. Therefore, simply stated, the size of a graphical element representing a particular software asset reflects the number of change requests logged in connection with the particular software asset. The second perceptible characteristic of each graphical element may be a color of the brick while the corresponding parameter of the software asset represented by that graphical element may be Main Technology. Therefore, simply stated, the location along the x-axis of a graphical element representing a particular software asset is related to the technology area (e.g., Java, SQL, etc.) to which the associated software asset belongs.

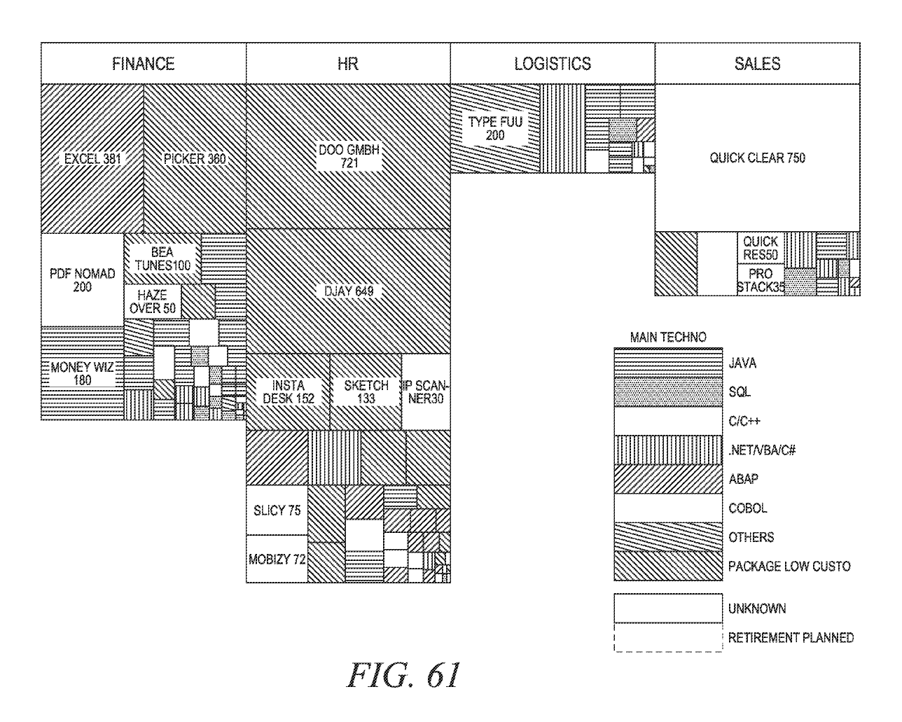

In another alternative embodiment shown in FIG. 61, a first perceptible characteristic of each graphical element may be the size of the graphical element and the corresponding parameter of the software asset represented by that graphical element may be Number of Incidents Currently Opened. Therefore, simply stated, the size of a graphical element representing a particular software asset reflects the number of incidents currently opened and involving the particular software asset. The second perceptible characteristic of each graphical element may be a color of the graphical element while the corresponding parameter of the software asset represented by that graphical element may be Main Technology. Therefore, simply stated, the location along the x-axis of a graphical element representing a particular software asset is related to the technology area (e.g., Java, SQL, etc.) to which the particular software asset belongs.

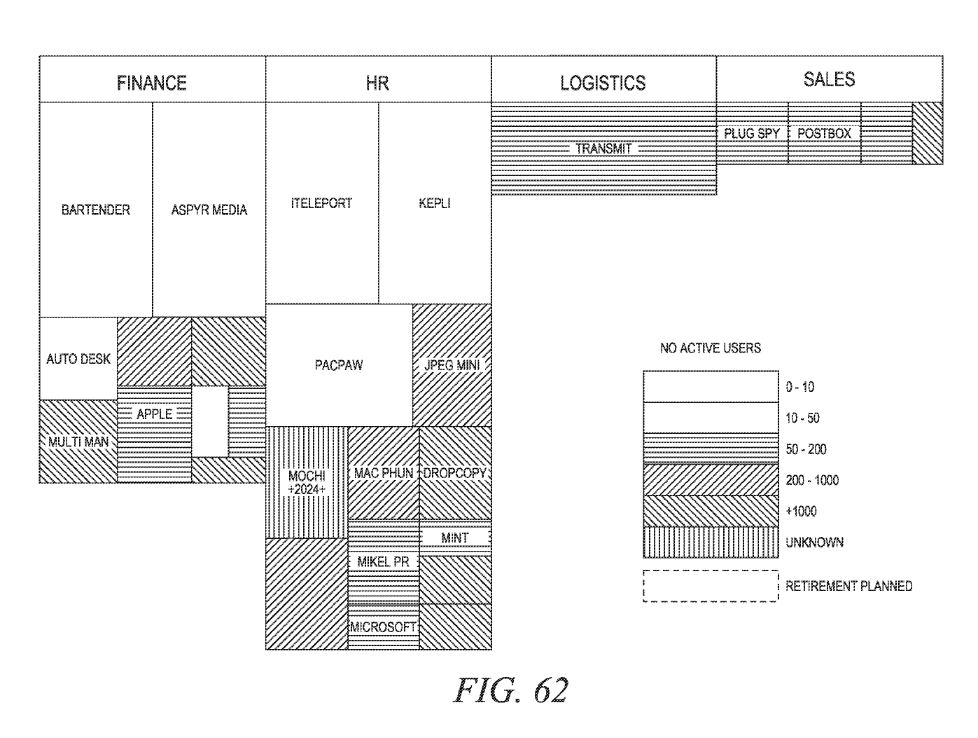

In another alternative embodiment shown in FIG. 62, a first perceptible characteristic of each graphical element may be the size of the graphical element and the corresponding parameter of the software asset represented by that graphical element may be IT Domain Name. Therefore, simply stated, the location along the x-axis of a graphical element representing a particular software asset is related to the IT Domain to which the particular software asset belongs. The second perceptible characteristic of each graphical element may be a color of the graphical element while the corresponding parameter of the software asset represented by that graphical element may be Number of Change Requests Currently Opened

Therefore, simply stated, the location along the x-axis of a graphical element representing a particular software asset is related to the number of outstanding change requests for the particular software asset that have not been serviced.

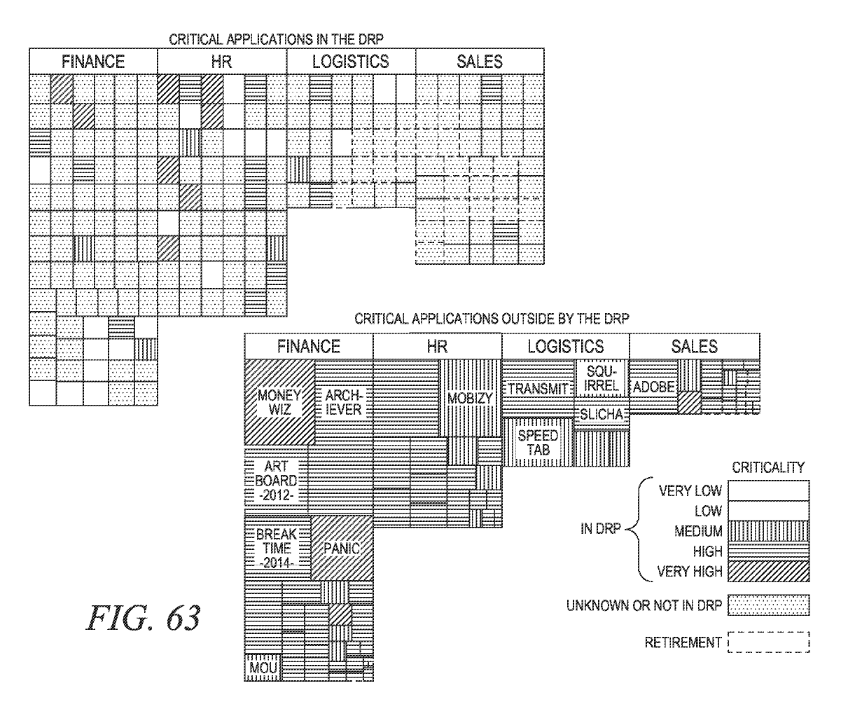

In another alternative embodiment shown in FIG. 63, a first perceptible characteristic of each graphical element may be the size of the graphical element the corresponding parameter of the software asset represented by that graphical element may be IT Domain Name. Therefore, simply stated, the location along the x-axis of a graphical element representing a particular software asset is related to the IT Domain to which the particular software asset belongs. The second perceptible characteristic of each graphical element may be a color of the graphical element while the corresponding parameter of the software asset represented by that graphical element may be Criticality. Therefore, simply stated, the location along the x-axis of a graphical element representing a particular software asset is related to the criticality of the particular software asset. In this case, there are two scorecards provided, one to illustrate software assets within the disaster recovery plan and one to illustrate software assets outside the disaster recovery plan.

It should be appreciated that more than even three perceptible characteristics can be applied to the graphical elements.

The scorecard module 3130 may also produce a scorecard that that includes, for a subset of software assets (e.g., those for which Criticality is above a certain threshold), a comparison of one or more of the following parameters between the software assets that meet the criteria of the subset and the overall set of software assets in the IT estate (to name a few non-limiting examples):
Technology Classification (raw parameter)
Age (raw parameter)
Level of Dynamism (derived parameter)
Functional Complexity (raw parameter)
Percent of the Team that is External Resources (raw parameter)

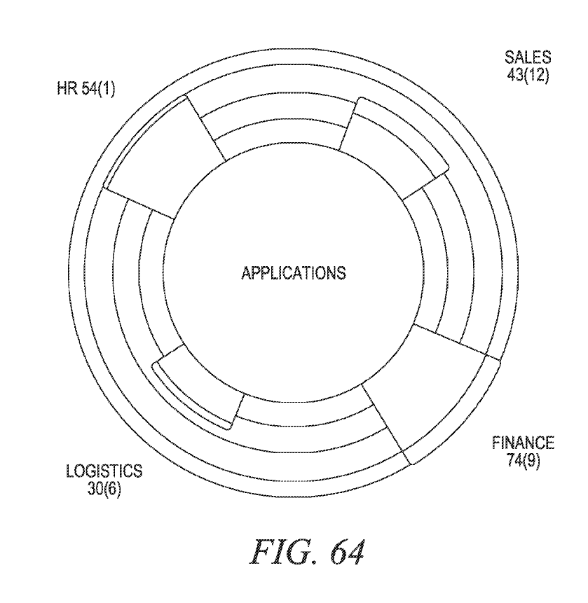

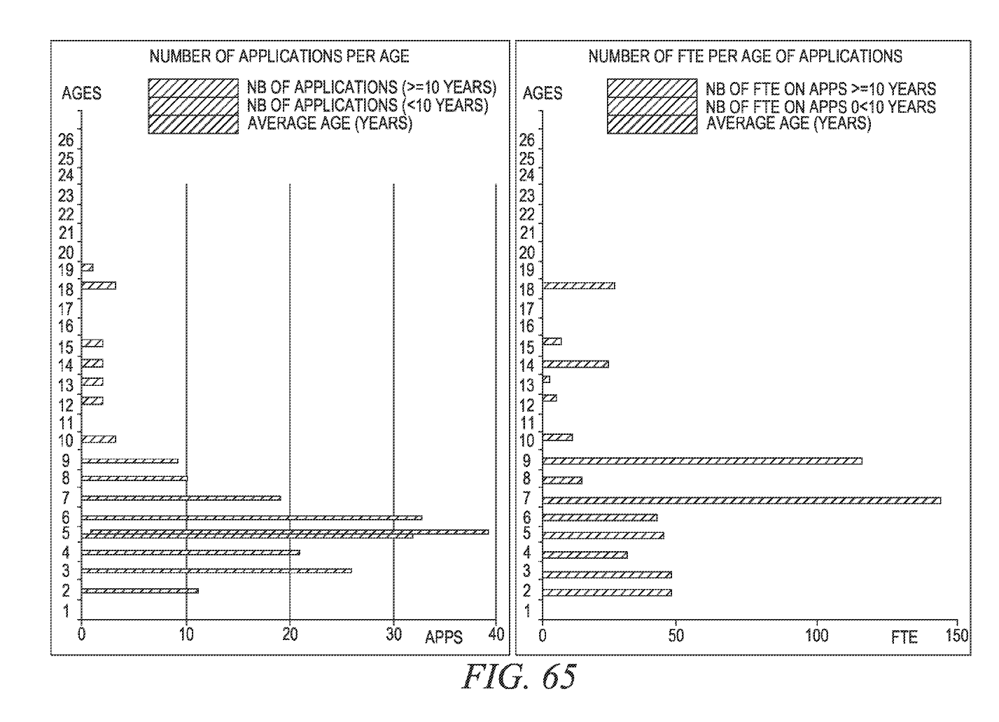

FIGS. 64-65 demonstrate ways in which the software assets can be classified, depending on the value ascribed to a particular parameter. In the case of FIG. 64, the parameter is IT Domain Name (raw parameter) and the results are shown in a radius graph including radially projecting bars, illustrating that 54 software assets fell into the HR domain, 43 fell into the Sales domain, 30 fell into the Logistics domain and 74 into Finance The bar for a particular IT domain protrude by an amount that corresponds to the number of software assets in that domain, showing the relative weight (in terms of number of software assets) of each domain. As well, the number of software assets in a particular IT domain that are critical (e.g., for which Criticality is above a certain threshold) can be illustrated shown by way of a different shading, color, etc. within or in proximity to the bar for the corresponding IT domain.

In the case of FIG. 65, one of the parameters is Age (raw parameter). The left-hand graph shows a count of the software assets falling into each particular age category. The right-hand graph goes beyond a mere count, and expresses the incidence of a first parameter, namely Number of FTE (raw parameter), per second parameter, namely Age (raw parameter). The results are shown in a bar graph from which it may be ascertained how much staff is working on older versus newer software applications, which can allow the user and/or the system to conclude whether, for example, a certain requisite ratio is being respected. This information is not obtainable from traditional data points, and until the data is presented in a convenient manner as shown herein, one cannot expect that well thought out decisions will be made. Both the left- and right-hand graphs show average values as well using a different color or line pattern.

Benchmark Assessment Module

The benchmark assessment module 3160 may produce at least one “benchmark sub-report” 3060 as a subset of the portfolio analysis report 3000. The benchmark sub-report 3060 allows the organization's performance data to be tracked and compared with industry practices. This comparison may allow a quicker understanding of the strengths and weaknesses of the organization's IT and identify areas of improvement so that specific transformation actions can be put in place to close the gaps in performance.

To create the benchmark sub-report 3060, the benchmark assessment module 3160 may execute a computer-implemented process. This process may be performed by at least one computer processor executing computer program instructions tangibly stored on at least one non-transitory computer-readable medium (such as the memory 10). In particular, this process could be instantiated as part of the IT transformation tool 240, and therefore could be performed by the at least one computer processor in the computer system 2.

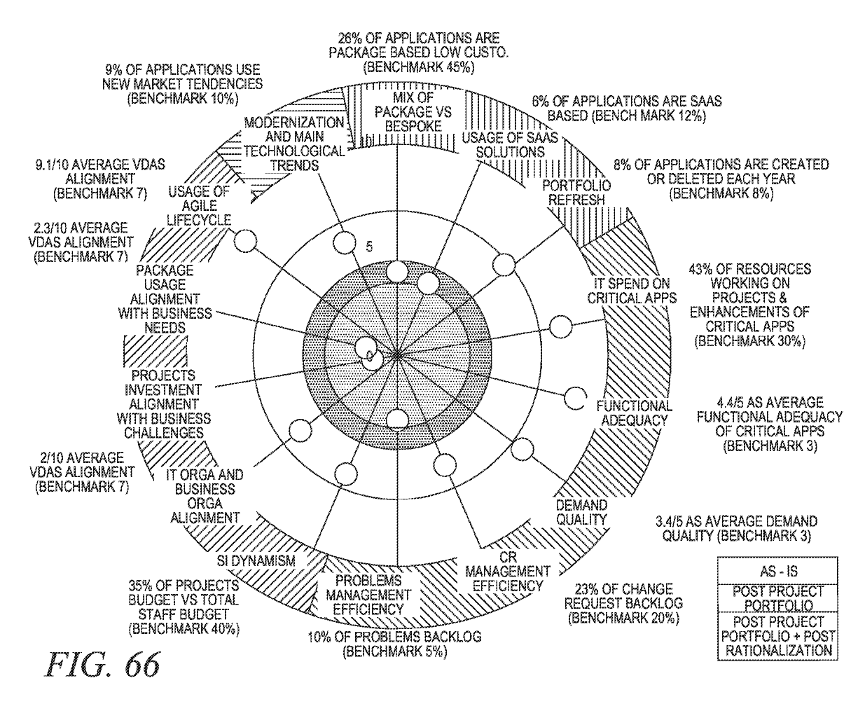

In accordance with a non-limiting embodiment, and with reference to FIGS. 66-68, a benchmark sub-report 3060 can be viewed as including a graphically representable data structure defining a group of graphical elements, conveyed to the user in a (e.g., graphical) perceptible form. In a non-limiting embodiment, the benchmark sub-report 3060 may be presented in the form of profiling meters, with each profiling meter tracking different ones of the raw and derived parameters that impact a specific “performance class”. Non-limiting examples of a performance class include Business Agility, Cost Efficiency and Risk.

For the profiling meter associated with a given performance class, and for each parameter that impacts the given performance class, the value ascribed to each such parameter, averaged over the set of software assets in the IT estate, can be compared with a specific benchmark for that parameter (stored in the memory 10) and, based on the discrepancy with the benchmark, rated (scored) on a scale of 1 (worst) to 10 (best) to arrive at an average score for that parameter and the given performance class. For example, a score below 5 could be indicated in a different color (e.g., red), and could be indicative of the need for remedial actions to improve the score.

FIGS. 66-68 show examples of profiling meters that are in the shape of wheels, namely a

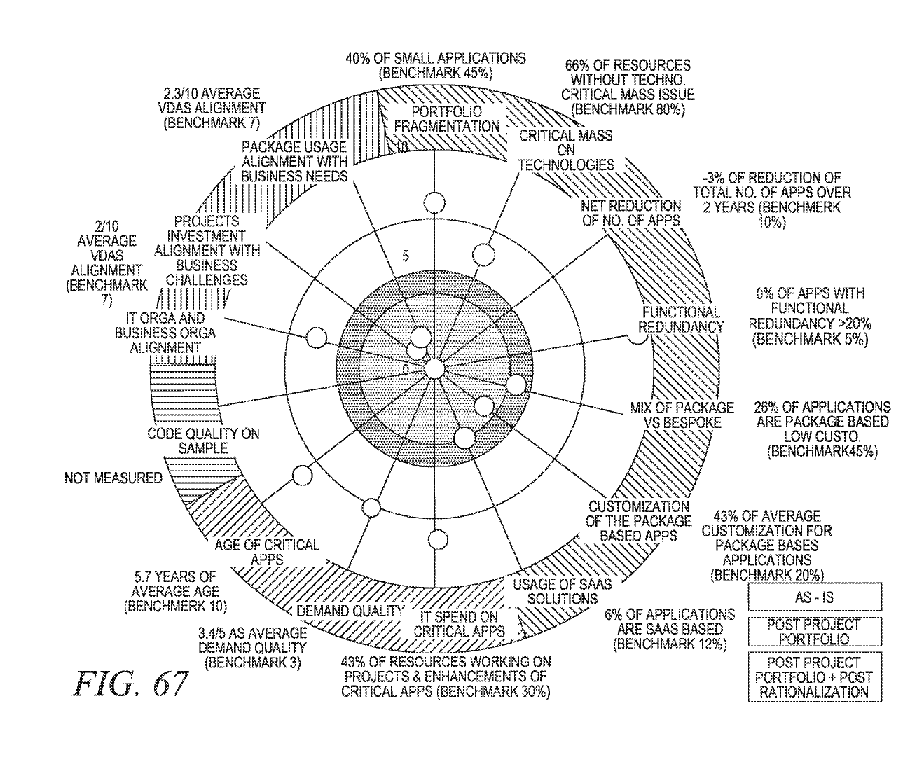

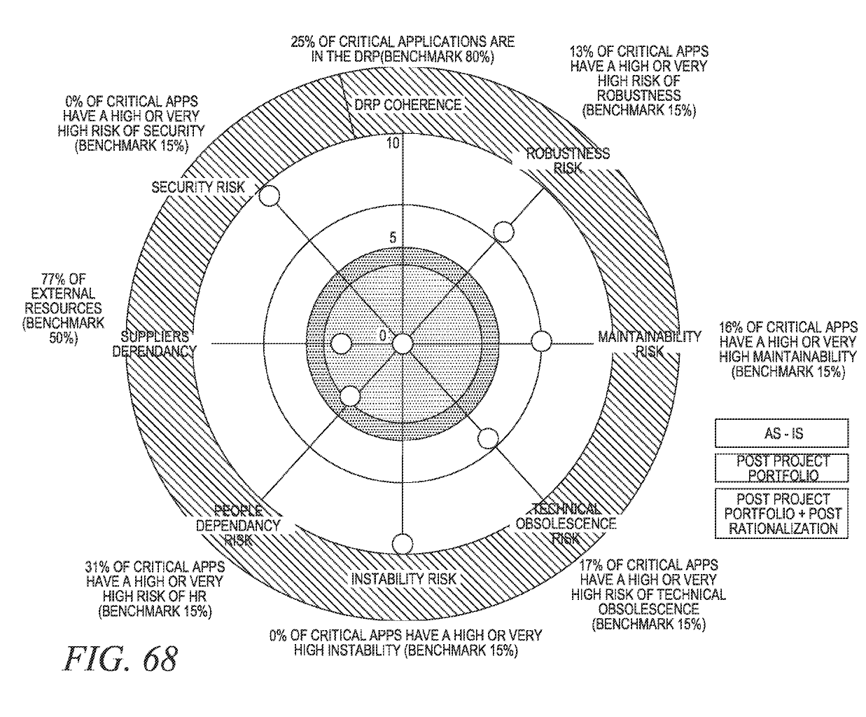

Business Agility wheel (FIG. 66), a Cost Efficiency wheel (FIG. 67) and a Risk wheel (FIG. 68). In the case of a particular wheel (which is of course only one non-limiting way to graphically express a profiling meter), it is seen that there are various parameters being monitored and compared against a benchmark. From a graphical standpoint, the discrepancy between the monitored value and the benchmark is expressed as a data point that occupies a certain radial distance between the center and the outer edge of the wheel. As such, a first data point for a first parameter that is closer to the center than a second data point for a second parameter represents a parameter whose ascribed value is lower, relative to its respective benchmark, than for second parameter.

Also shown in the bottom right corner of FIGS. 66-68 is an indicator that shows whether the profiling meters are representative of the current IT estate, of the IT state after a decommissioning phase or of the IT estate after both a decommissioning phase and a rationalization phase. This allows a user to compare various hypothetical IT transformation options predictively and proactively, likely allowing cost-effective decisions to be made with greater confidence than if there were no access to the profiling meters or IT transformation tool 240.

By way of non-limiting example, raw and derived parameters tracked for Business

Agility may include one or more of the following parameters, some of which may not appear in FIGS. 58A-59:
Mix of package versus bespoke
Usage of SaaS solutions
Portfolio Refresh
IT Spend on critical apps
Functional Adequacy
Demand quality
Change requests management efficiency
Problems management efficiency
SI Dynamism
IT and business organization alignment
Projects investment alignment with Business challenges
Package usage alignment with business needs
Usage of agile lifecycle
Modernization and main technology trends

By way of non-limiting example, raw and derived parameters tracked for Cost Efficiency may include one or more of the following parameters, some of which may not appear in FIGS. 58A-59:
Portfolio fragmentation
Critical mass on technologies
Reduction of number of applications
Functional redundancy
Mix of package versus bespoke
Customization of package based applications
Usage of SaaS solution
IT Spend on critical apps
Demand quality
Age of critical apps
Code quality
IT and business organization alignment
Projects investment alignment with Business challenges
Package usage alignment with business needs

By way of non-limiting example, raw and derived parameters tracked for Risk may include one or more of the following parameters, some of which may not appear in FIGS. 58A-59:
Disaster recovery plan coherency
Robustness risk
Maintainability risk
Technical obsolescence risk
Instability risk
People dependency risk
Security risk

Parameter Correlation Module

The parameter correlation module 3180 may produce at least one “correlation sub-report” 3080 which, based on the processing of various raw and derived parameters, is capable of indicating which pairs of parameters are “moving” in the same direction and which are not. That is to say, in an ensemble of software assets each having a value ascribed to a first parameter and ascribed to a second parameter, the parameter correlation module 3180 determines whether a higher value ascribed to the first parameter tends to also correspond to a higher value being ascribed to the second parameter (for the same software asset), or vice versa, as well as the extent (strength) of any such (positive or negative) “correlation”.

To create the correlation sub-report 3080, the parameter correlation module 3180 may execute a computer-implemented process. This process may be performed by at least one computer processor executing computer program instructions tangibly stored on at least one non-transitory computer-readable medium (such as the memory 10). In particular, this process could be instantiated as part of the IT transformation tool 240, and therefore could be performed by the at least one computer processor in the computer system 2.

In accordance with a non-limiting embodiment, and with reference to FIG. 70, a correlation sub-report 3080 can be viewed as including a graphically representable data structure defining a group of graphical elements, conveyed to the user in a perceptible form (e.g., graphically). The correlation sub-report 3080 can be stored in the memory 10, output to a display, encoded into a signal and transmitted over a network, etc.

In the example of FIG. 70, the relevant information is presented in the form of a table where, in this case, twelve parameters have been selected for correlation analysis. These parameters are indicated at the head of each row and also at the head of each column. The parameter correlation module 3180 then selects a first combination of differing parameters, accesses the software asset data container 12 and identifies the various software assets having values ascribed to both parameters. (The count of the number of software assets is provided in a column on the right hand side of FIG. 70 entitled “sample size”.) Then, the parameter correlation module 3180 determines, for each of the software assets just identified, the correlation between the value ascribed to the first parameter and the value ascribed to the second parameter. This results in a correlation index that is either positive (where higher (lower) values of the first parameter occur alongside higher (lower) values of the second parameter) or negative (where higher (lower) values of the first parameter occur alongside lower (higher) values of the second parameter). The sign of the correlation index is therefore position or negative to indicate the positive or negative correlation. In addition, the magnitude of the correlation index indicates the strength of the (positive or negative) correlation.

For example, the arrow 7010 leading from a minus sign brings to light the existence of a negative correlation between Technical Obsolescence (raw parameter) and Code Maintainability (raw parameter), which indicates that the two corresponding parameters are evolving in opposite directions, meaning that more obsolete software assets are less maintainable. This behavior is to be expected from an IT estate having a “normal” composition of software assets. For its part, arrow 7020 leading from a plus sign is indicative of higher Quality of Demand (raw parameter) being linked with higher Business Needs Adequacy (raw parameter), also to be expected from a healthy IT estate. On the other hand, a correlation index having the wrong (unexpected) sign or an excessively high or low magnitude can be detected automatically by the IT transformation tool 240 (e.g., by comparison to a threshold) and either logged in the memory 10 or flagged to the user (visually, audibly or via a message). As such, the parameter correlation module 3180 and the correlation sub-report 3080 can be used to spot anomalies in the IT estate in order to trigger the appropriate investigative/corrective processes.

Budgeting Module

The budgeting module 3150 may produce a “budgeting sub-report” 3050 as a subset of the portfolio analysis report 3000. The budgeting sub-report 3050 allows the costs associated with software assets to be tracked and compared. This comparison may allow a quicker understanding of the costs of the organization's IT estate and identify areas of improvement so that specific transformation actions can be put in place to reduce costs over a desired time frame.

To create the budgeting sub-report 3050, the budgeting module 3150 may execute a computer-implemented process. This process may be performed by at least one computer processor executing computer program instructions tangibly stored on at least one non-transitory computer-readable medium (such as the memory 10). In particular, this process could be instantiated as part of the IT transformation tool 240, and therefore could be performed by the at least one computer processor in the computer system 2.

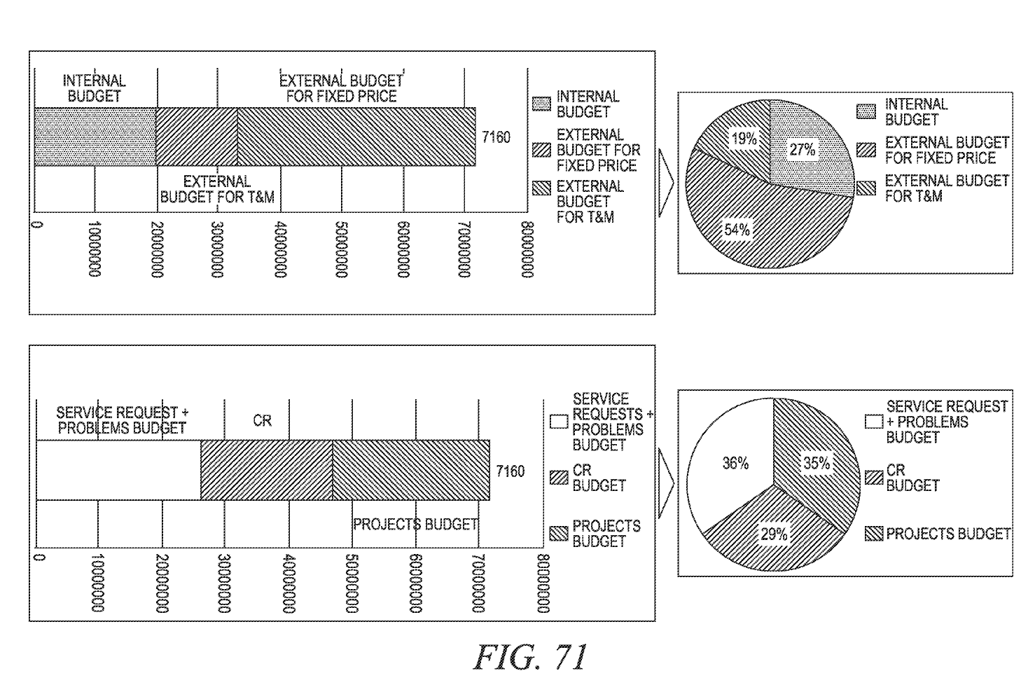

In accordance with a non-limiting embodiment, and with reference to FIG. 71, a budgeting sub-report 3050 can be viewed as including a graphically representable data structure defining a group of graphical elements, conveyed to the user in a perceptible form (e.g., graphically). In a non-limiting embodiment, the budgeting sub-report 3050 may be presented in the form of a first budgeting breakdown (top) and a second budgeting breakdown (bottom), the first budgeting breakdown possibly including information about expenditures broken down based on the engagement model (internal, external for time and material and external for fixed price), while and the second budgeting breakdown may include information about expenditures broken down based on projects, problem management and change requests.

In one non-limiting example, the budget may be calculated using the raw parameters as follows:

(Internal Resources that Worked Over the Past 12 Months (FTEs) on Change Request+Internal Resources that Worked Over the Past 12 Months (FTEs) on Problems+Internal Resources that Worked Over the Past 12 Months (FTEs) on Service Request+Internal Resources that Worked Over the Past 12 Months (FTEs) on Project)

X Blended Daily Rate for Time & Material+(External Resources that Worked Over the Past 12 Months (FTEs) on Change Request+External Resources that Worked Over the Past 12 Months (FTEs) on Problems+External Resources that Worked Over the Past 12 Months (FTEs) on Service Request+External Resources that Worked Over the Past 12 Months (FTEs) on Project)

X (Blended Daily Rate for Time & Material+Blended Daily Rate for Fixed price supplier)

Risk Assessment Module

The risk assessment module 3140 may produce at least one “risk sub-report” 3040 as a subset of the portfolio analysis report 3000. The risk assessment module 3140 may be instantiated (called/activated) by the user, or it may be called by another module of the IT transformation tool 240, such as the rationalization suggestion module 3110 or the scorecard module 3130.

The risk sub-report 3040 contains a risk profile of the IT estate ascertained based on raw and/or derived parameters pertaining to individual software assets, including parameters related to such issues as security, robustness, HR dependence, technology obsolescence, etc. This may allow a quicker and more intuitively understanding of the risks to the organization's IT and identify areas of improvement so that specific transformation actions can be put in place to reduce risks over a desired time frame.

To create the risk sub-report 3040, the risk assessment module 3140 may execute a computer-implemented process. This process may be performed by at least one computer processor executing computer program instructions tangibly stored on at least one non-transitory computer-readable medium (such as the memory 10). In particular, this process could be instantiated as part of the IT transformation tool 240, and therefore could be performed by the at least one computer processor in the computer system 2.

Accordingly, the risk assessment module 3140 determines a derived parameter referred to as a Level of Risk associated with one or more software assets in the IT estate. Computation of Level of Risk can be done by evaluating each of a plurality of risk factors, which themselves may include combinations of raw and derived parameters. Risk factors may include “robustness”, “maintainability”, “technical obsolescence”, “instability”, “people dependency” and “security”, to name a few non-limiting examples. Further details about the risk factors are provided herein below.

Robustness: represents the number of problems and un-planned service interruptions. Cancluated based on Number of Incidents Currently Opened and Number of Interruptions To Production (excluding infra ITP).

Maintainability: corresponds to the Code Maintainability raw parameter collected from the user and stored in the software asset data container 12. This may refer to a combination of the quality of documentation, accessibility of the source code and level of perceived maintainability.

Technical obsolescence: corresponds to the Technical Obsolescence raw parameter collected from the user and stored in the software asset data container 12.

Instability: takes into account the maturity of the software asset. Thus, mature applications (e.g., >10 years) with user dissatisfaction and a significant number of change requests could signal a high score for this risk factor. Computed based on Number of Change Requests, Age, QOS.

People dependency: when high, denotes an insufficient team size to maintain complex and non-SaaS applications. Computed based on Complexity, Package Category, Number of FTE. Weighted by Criticality.

Security: will yield a high score when there is a low level of compliance with security requirements combined with a high expectation regarding security requirements. Computed based on Security Compliance, Required Level of Security (not shown in FIGS. 58A-59)

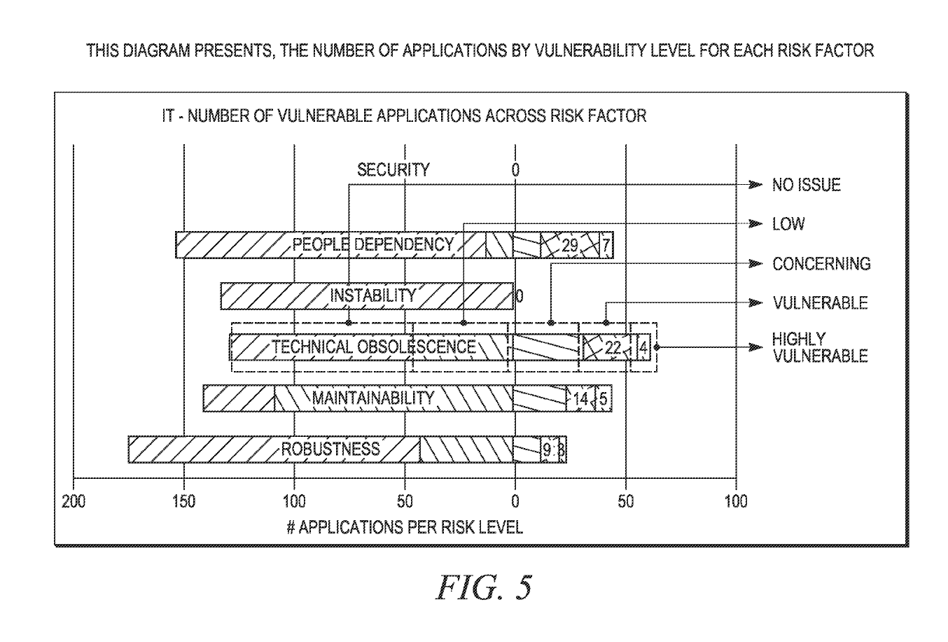

One way to illustrate the risk factors is by way of a bar graph, as shown in FIG. 5, where there is shown a horizontal bar for each risk factor. In particular, each horizontal bar represents the distribution of the software assets according to a specific risk factor. For example, if there are 5 levels for each risk factor, level 1 could indicate low vulnerability, while level 5 could indicate high vulnerability.

For example, taking the people dependency risk factor as an example (the top bar), it will be seen that a significant number of software assets have low vulnerability or do not present an issue, but there are 29 software assets that are considered vulnerable and another 7 assets that are considered highly vulnerable. In the case of the robustness risk factor, it will be seen that a significant number of software assets have low vulnerability or do not present an issue, but there are 9 software assets that are considered vulnerable and another 3 assets that are considered highly vulnerable.

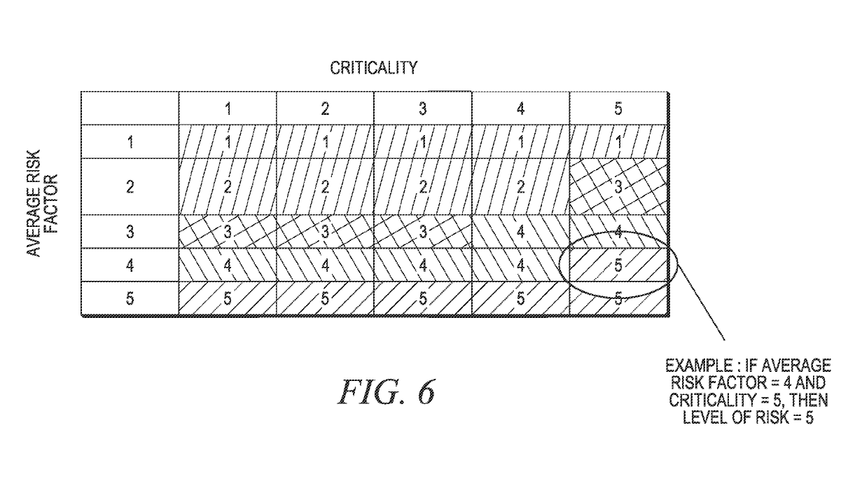

Having computed the risk factors, these may be averaged, in order to obtain an “average risk factor”. For example, if the risk factors range from 1 to 5, the average risk factor will also give a value between 1 and 5. This value could be rounded to the nearest integer. Then, a table such as the one shown in FIG. 6 could be used, which shows the possible values for the average risk factor along the vertical axis and Criticality (raw parameter) along the horizontal axis. The value of a given entry corresponds to the Level of Risk, i.e., the average risk factor taking into account Criticality. In particular, the value of Criticality also ranges from 1 to 5 (although this need not be the case). It is clear that low values of Criticality do not affect the average risk factor, however higher values of Criticality will increase the risk factor at higher levels of risk factor, i.e., risky software assets will appear even more risky. Other weightings are of course possible.

Practically speaking, weighting the average risk factor by criticality means that software assets that are more critical are inherently considered higher risk than those which are less critical, all other things being considered equal. This allows decisions to be taken more prudently when they involve critical assets, because these will be considered more high-risk, when corroborated by other factors.

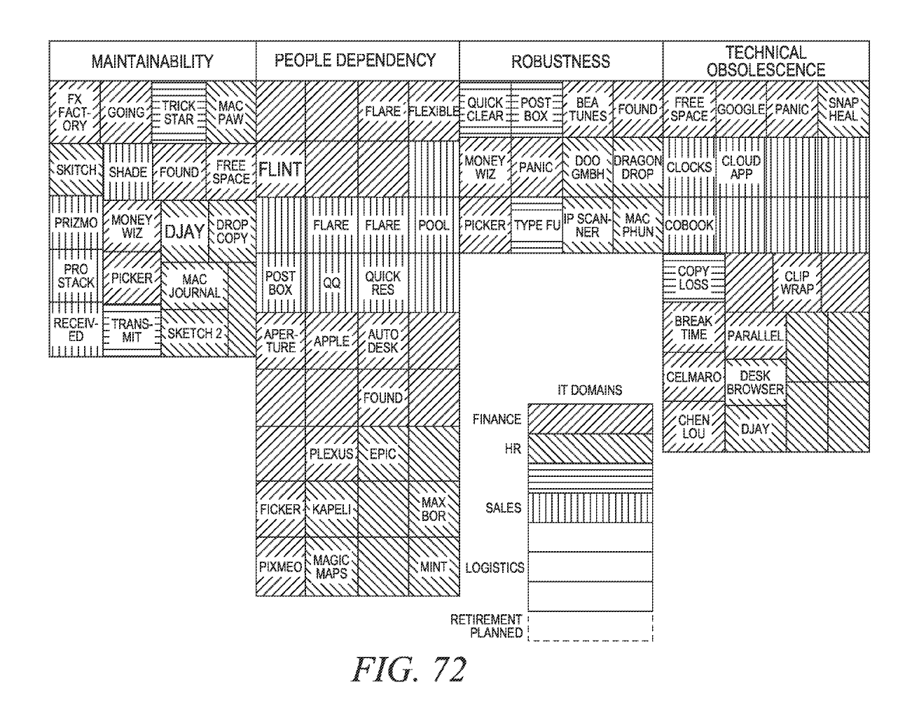

In accordance with a non-limiting embodiment where the risk assessment module 3140 is instantiated by the user, and with reference to FIG. 72, the risk sub-report 3040 can be viewed as including a graphically representable data structure (e.g., a tree map) defining a plurality of graphical elements (in this specific non-limiting case, bricks) representing corresponding software assets with a Level of Risk (derived parameter, e.g., as derived above for Criticality and the average risk factor) above a certain threshold, with a darker border being visible around those bricks that correspond to the highest-risk software assets. The bricks are clustered horizontally according to risk factor, divided into risk levels, and also indicating the number of software assets for each risk level, for each risk factor. In this case, the risk parameters include maintainability, people dependency, robustness and technical obsolescence. The color/shading of each brick is used to illustrate the value ascribed to IT Domain Name (raw parameter) for the corresponding underlying software asset. In the case where the risk assessment module 3140 is instantiated by another module of the IT transformation tool 240 rather than by the user, it is envisaged that the risk assessment module 3140 could output information in a non-graphical form.

Rationalization Suggestion Module

The rationalization suggestion module 3110 may produce at least one “rationalization sub-report” 3010 as a subset of the portfolio analysis report 3000. The rationalization suggestion sub-report 3010 may include a listing of applications and suggested rationalization actions, and may be stored in a file, displayed to the user and/or transmitted as an electronic message. The rationalization sub-report 3010 may help the user to identify specific, targeted rationalization actions on a discrete software asset or a set of software assets. Taking the rationalization actions identified by the rationalization sub-report 3010 may thus improve the business fit of software assets, reduce the level of customization, reduce application count, improve maintainability or reduce the risk of unplanned downtime.

In accordance with a non-limiting embodiment, rationalization sub-report 3010 can be viewed as including a graphically representable data structure defining a group of graphical elements, conveyed to the user in a perceptible form (e.g., graphically or using a text-based approach).

To produce the rationalization sub-report 3010, the rationalization suggestion module 3110 may execute a computer-implemented process. This process may be performed by at least one computer processor executing computer program instructions tangibly stored on at least one non-transitory computer-readable medium (such as the memory 10). In particular, this process could be instantiated as part of the IT transformation tool 240, and therefore could be performed by the at least one computer processor in the computer system 2.

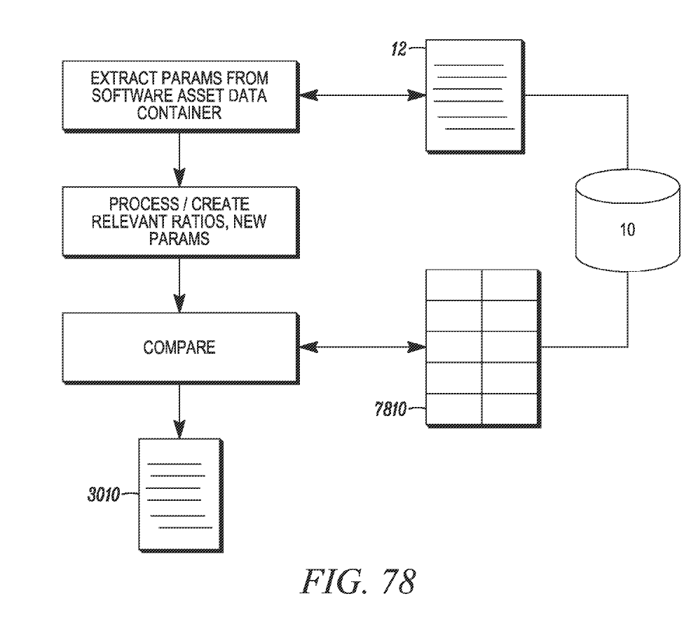

FIG. 78 shows a non-limiting embodiment of the aforementioned process, which includes extracting information about particular assets from the software asset data container 12, in particular the values of specific raw and/or derived parameters for each of these assets. Computations are performed on these specific parameters to obtain a set of indicators. Comparisons are made between the values of these indicators and stored values in a table or database 7810, and the results of these comparisons are mapped into the rationalization sub-report 3010.

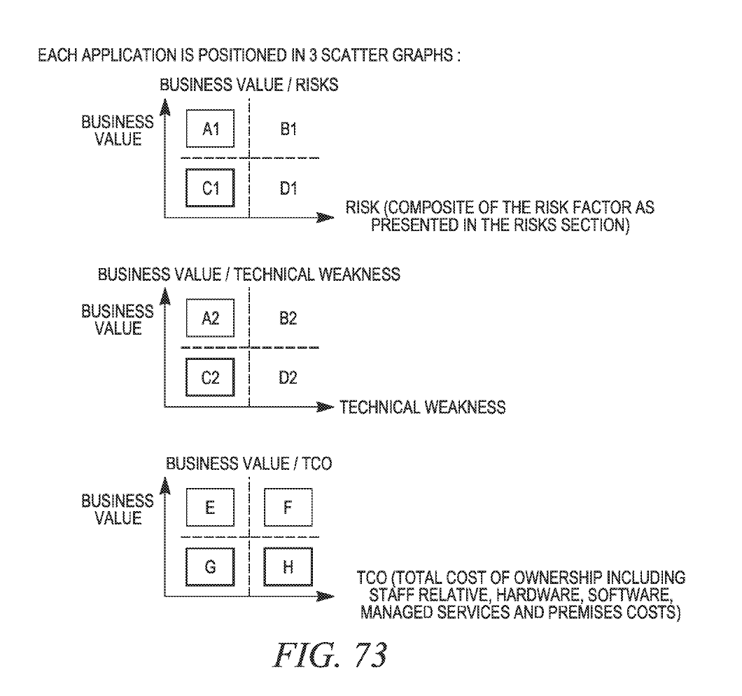

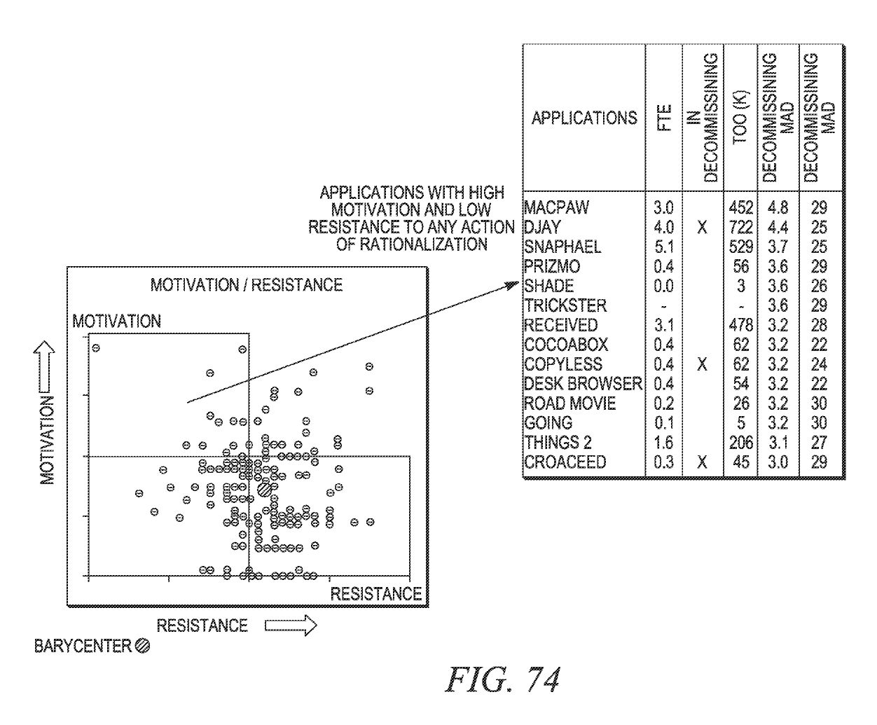

The nature of the rationalization sub-report 3010 may be different in different embodiments. FIG. 73 pertains to a first embodiment (the “filtering” approach), while FIG. 74 pertains to a second embodiment (the “motivation/resistance” approach). Each of these embodiments adopts a different approach for assisting the user in making rationalization decisions. Both embodiments utilize a derived parameter referred to as Business Value (derived parameter, see FIG. 59).

Both embodiments for generating rationalization suggestions are now described, with the understanding that in some cases, they could also be combined. Other techniques for generating rationalization suggestions are of course possible and within the scope of the invention.

The “Filtering” Approach (FIG. 73)

In this embodiment, additional derived parameters are computed, namely Level of Risk, Technical Weakness and TCO (total cost of ownership).

Level of Risk may be obtained from the risk assessment module 3140 as described above, and thus the risk assessment module 3140 may be invoked by the rationalization suggestion module 3110.

Technical Weakness may be computed based on a variety of mainly raw parameters, including Code Maintainability, Functional Complexity, Code Quality, Specific Constraints relating to security and Technical Obsolescence.

TCO may be computed as Total Staff Cost+Hardware Cost+License Cost (not shown in FIGS. 58A-59).

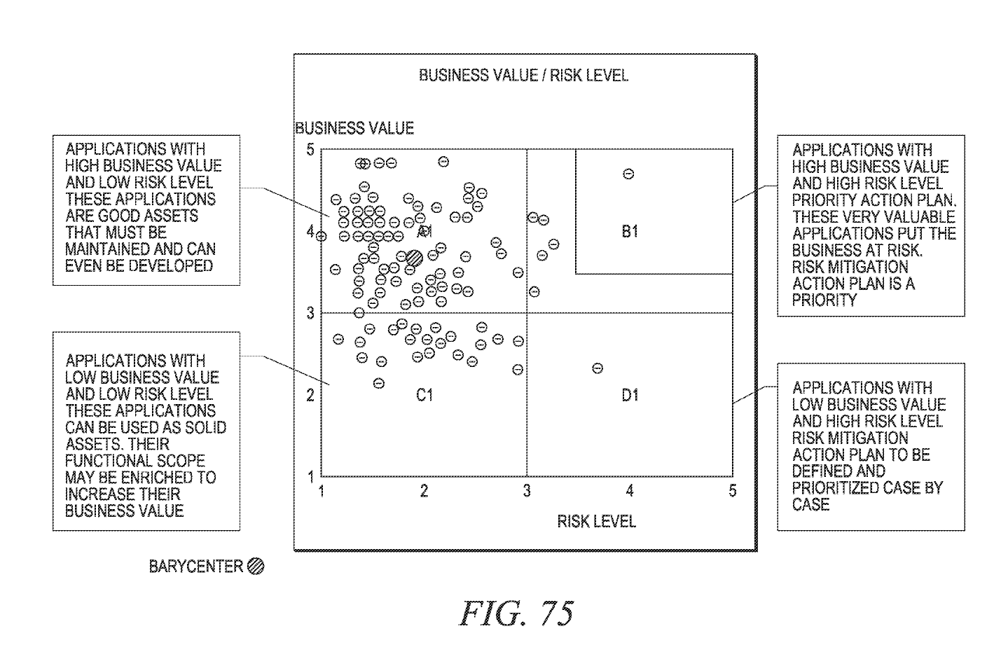

Next, Business Value (derived parameter) is individually compared against Level of Risk (derived parameter), against Technical Weakness (derived parameter) and against TCO (derived parameter), which yields the graphs shown in FIGS. 73 and 75-77. It is noted that there are three graphs in FIG. 73, which are blown up in FIGS. 75, 76 and 77, respectively. The graphs are separated into quadrants, and each software asset occupies one of the quadrants in each of the graphs. Then, a rationalization suggestion is determined as a function of the quadrants in which each software asset is found. This will be explained by way of example.

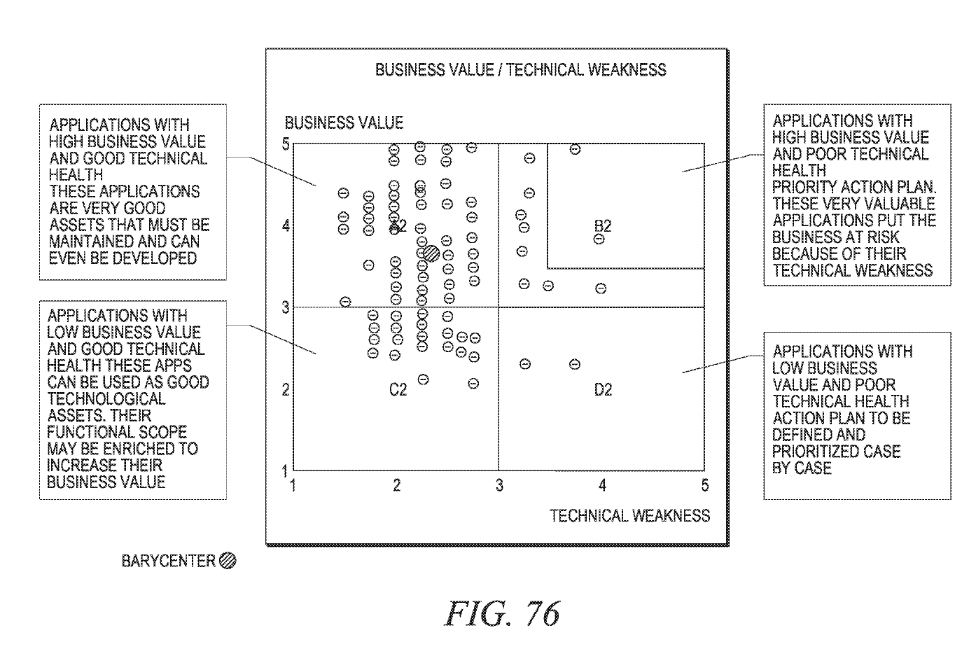

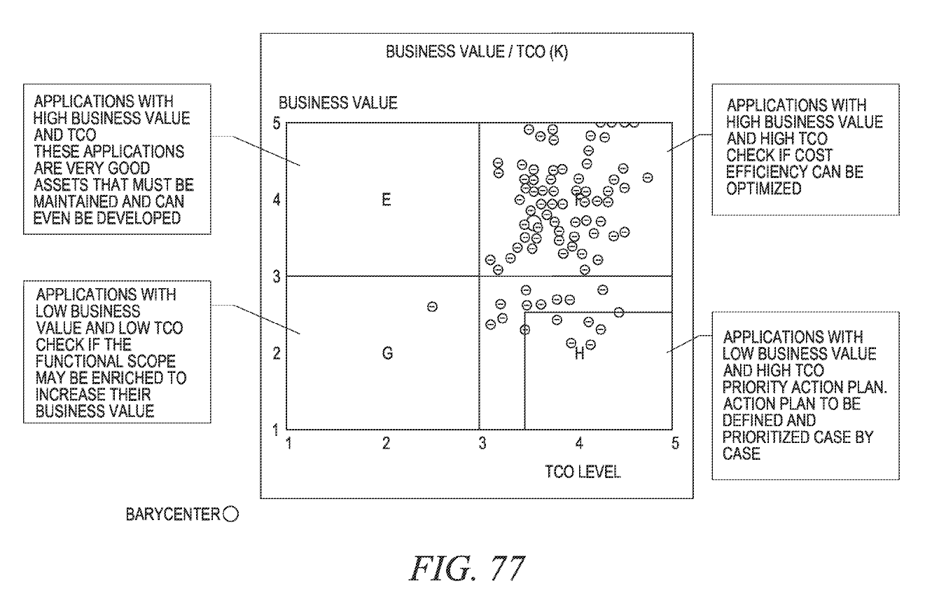

Consider a software asset that occupies quadrants A1 (FIGS. 73 and 75), A2 (FIGS. 73 and 76) and E (FIGS. 73 and 77). Due to its high ratio of Business Value to Level of Risk, Business Value to Technical Obsolescence and Business Value to TCO, such a software asset would be deemed a good asset to be maintained and can even be further developed. Thus, the rationalization suggestion may be to enrich the software asset. Enriching can be viewed as an action related to adding more functionality to an application in order to further reinforce compliance with the business requirements.

On the other hand, consider a software asset that occupies quadrants A1, FIGS. 73 and 75), A2 (FIGS. 73 and 76) and F (FIGS. 73 and 77). Due to its high ratio of Business Value to Level of Risk and Business Value to Technical Obsolescence, such a software asset would be deemed a valuable asset. However, due to the relatively higher TCO, the user is alerted to the need to verify the cost effectiveness of the maintenance and support organization. Thus, the rationalization suggestion may be to continue with the software asset and to optimize such aspects as costs/maintenance/support.

Consider now a software asset that occupies quadrants C1 (FIGS. 73 and 75), C2 (FIGS. 73 and 76) and G (FIGS. 73 and 77). In this case, the software asset has relatively low Level of Risk, Technical Obsolescence and TCO, and thus it could be deemed a basis asset. However, the Business Value is comparatively lower and therefore its functional scope may be enriched to increase its business value. Thus, the rationalization suggestion may be to continue with the software asset, but to choose between enriching it or to going to SaaS (i.e., moving the software asset to the network).

Finally, consider a software asset that occupies quadrants C1 (FIGS. 73 and 75), C2 (FIGS. 73 and 76) and H (FIGS. 73 and 77). Such a software asset could be deemed a solid asset from a risk and technical perspective. However, its high TCO does not fit in with its low Business Value. The rationalization suggestion may therefore be to set up a priority action plan to either freeze, retire or consolidate this software asset, or even to go to SaaS.

Of course, a given software asset may occupy a different combination of quadrants, and may result in different rationalization suggestions forming part of the rationalization sub-report 3010. Also, additional sectors may be defined with more granularity, and different parameters may be compared.

The “Motivation/Resistance” Approach (FIG. 74)

In addition to accessing the Criticality (raw parameter) and computing the Business Value (derived parameter), the rationalization suggestion module 3110 computes derived parameters referred to as the Motivation Index and the Resistance Index.

The Motivation Index refers to a motivation for decommissioning, which may be an index calculated based on various criteria, e.g., as a linear combination of Technical Obsolescence (raw parameter), Code Maintainability (raw parameter), Main Technology (raw parameter), Level of Robustness (raw parameter) and Level of Risk (derived parameter).

The Resistance Index refers to a resistance to decommissioning, which may be an index calculated based on various criteria, and may be higher when the software asset has a low (below a predetermined threshold) Degree of Customization and has high (above predetermined thresholds) Criticality (raw parameter), Business Value (derived parameter), Level of Dynamism (derived parameter), Number of Active End Users (raw parameter), Regulatory Requirements (raw parameter).

The rationalization suggestion module 3110 then may generate suggestions for rationalization based on a comparison of the values of Motivation Index, Resistance Index, Criticality and Business Value to stored thresholds and combinations of thresholds.

For example, a high level (above a predetermined threshold) of Motivation Index, a low level (below a predetermined threshold) of Resistance Index and coupled with a low level (below a predetermined threshold) of Criticality and Business Value for a particular software asset are all indicators that may cause the rationalization suggestion module 3110 to suggest rationalization of that software asset. When coupled with a high level (above a predetermined threshold) of Technical Obsolescence, this may indicate that it may be appropriate to suggest that the software asset be re-platformed or replaced.

Alternatively, a high level (above a predetermined threshold) of Motivation Index, a low level (below a predetermined threshold) of Resistance Index and coupled with a low level (below a predetermined threshold) of Customization (raw parameter, if Application Type not “bespoke”) and Synchronization (raw parameter) for a particular software asset are all indicators that may cause the rationalization suggestion module 3110 to suggest that the software asset is a candidate for SaaS.

In response to receipt of the rationalization sub-report 3010, the IT transformation tool 240 may autonomously, or in response to confirmation from the user, send a message to an IT department of the organization requesting a ticket for implementing one or more of the rationalization suggestions in the rationalization sub-report 3010.

Option G1

The selection of option G1 from the landing page 2800 may be interpreted by the computer system 2 as an indication that the user desires to instantiate the interactive dashboard tool 2860. Subsequently, upon instantiation of the interactive dashboard tool 2860, the one or more processors of the computer system 2 access the software asset data container 12 and generate a signal which, when provided to an output device (e.g., a screen of user device 4 or 6), causes the display of graphical elements that may allow the user to visualize aspects of the IT organization and obtain instant access to key characteristics.

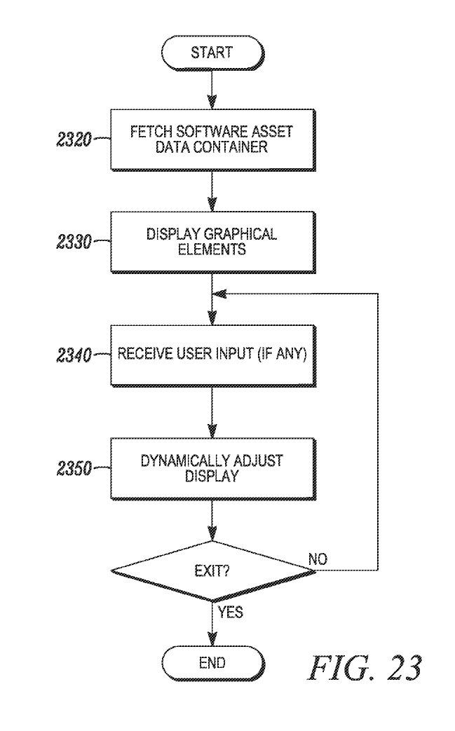

With reference to FIG. 23, there are shown steps executed by the interactive dashboard tool 2860. Specifically, at step 2320, the software asset data container 12 is accessed/fetched from the memory 10. At step 2330, graphical elements are caused to be displayed on an output device, together with a GUI. In various examples, the output device may be one of the devices 4, 6 or a screen connected to or part of the computer system 2. At step 2340, user input is received through the GUI. At step 2350, display of the graphical elements (and the GUI) is dynamically adjusted based on the input received from the user. If the user has not chosen to exit/terminate, the interactive dashboard tool 2860 identifies changes in the software asset data container 12 that may have occurred in the meantime, and readjusts the display of the graphical elements based on such changes. Further user input through the GUI may further adjust the manner in which graphical elements are displayed on the output device, and so on.

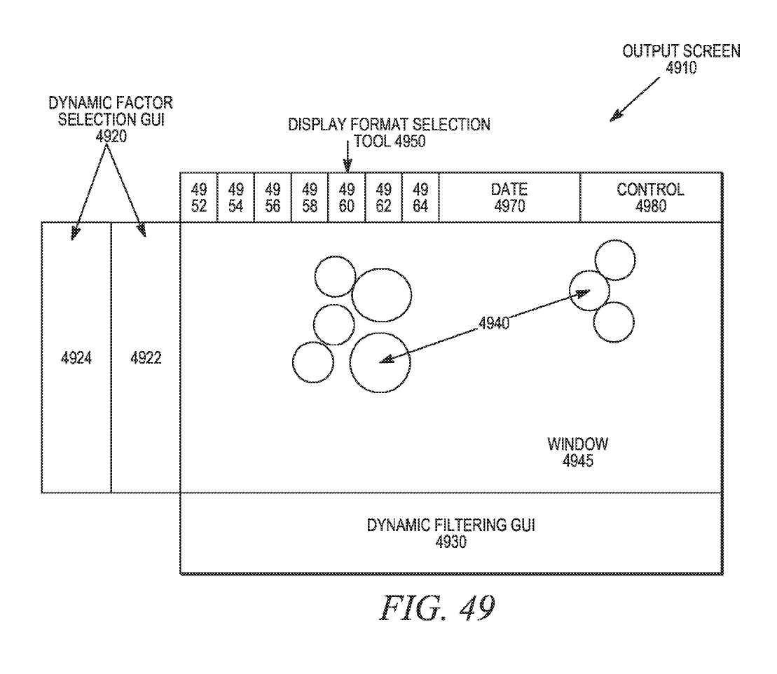

By way of non-limiting example, FIG. 49 shows an example of elements of an output screen 4910 caused to be output by the interactive dashboard tool 2860. The output screen 4910 includes a window 4945 containing graphical elements 4940 and a GUI portion containing user controls. Each of the graphical elements 4940 in the window 4945 may correspond to one or more software assets in the IT estate. The graphical elements 4940 may be geometric shapes such as triangles or circles, or non-geometric figures such as animals, avatars, flowers, etc. Also, depending on the embodiment, the graphical elements 4940 may have a two- or three-dimensional appearance.

One of the features of the interactive dashboard tool 2860 is that the GUI portion of the output screen 4910 includes a display format selection tool 4950 for allowing the user to dynamically (e.g., in real-time) select the display format of the set of graphical elements 4940 to be displayed in the window 4945. The display format selection tool 4950 can include a plurality of options for display. Selection of a given display format via the display format selection tool 4950 dictates the shape and configuration of the graphical elements 4940 shown in the window 4945.

In one non-limiting example, one of the options provided by the display format selection tool 4950 may be a “bubbles” option 4952, further to selection of which the graphical elements 4940 could take on the shape of circular or elliptical “bubbles”, each representing a software asset (or group of software assets) of the IT estate. The bubbles may have perceptible characteristics such as relative on-screen position, size, color, thickness, speed of motion, transparency, sound emitted during mouse-over, etc.

In another non-limiting example, the display format selection tool 4950 may include a “tree map” option 4954, further to selection of which the graphical elements 4940 could occupy individual blocks (or bricks), each representing a software asset (or group of software assets) of the IT estate. The blocks/bricks may have perceptible characteristics such as relative on-screen position, size, color, thickness, shading, sound emitted during mouse-over, etc.

In another non-limiting example, the display format selection tool 4950 may include a “map” option 4956, further to selection of which the graphical elements 4940 could take on a geometric or non-geometric shape in association with a region on a geographic map. Each of the graphical elements 4940 would therefore represent a group of software assets associated with the corresponding region.

In another non-limiting example, the display format selection tool 4950 may include a “histogram” option 4958, further to selection of which the graphical elements 4940 could occupy individual sections of a histogram, each section representing a software asset (or group of software assets) of the IT estate. The sections of the histogram may have perceptible characteristics such as relative on-screen position, size, color, thickness, shading, sound emitted during mouse-over, etc.

In another non-limiting example, the display format selection tool 4950 may include a “Sankey” option 4960, further to selection of which the graphical elements 4940 could be linked to characteristic icons by arrows. Each graphical element 4940 represents a group of software assets. In accordance with the principles of a Sankey graph, the width of the arrow between a graphical element and a characteristic icon would be proportional to the number of links existing between the software assets in the group and the characteristic represented by that icon.

In another non-limiting example, the display format selection tool 4950 may include a

“KPI road” option 4962, further to selection of which the graphical elements 4940 could occupy a point on an imaginary path/road, each point representing a software asset (or group of software assets) of the IT estate. The points may have perceptible characteristics such as relative on-screen position, size, color, thickness, shading, sound emitted during mouse-over, etc.

In another non-limiting example, the display format selection tool 4950 may include a “table” option 4964, further to selection of which the graphical elements 4940 could occupy individual entries in a table, each representing a software asset (or group of software assets) of the IT estate. Each software asset may be associated with one or more rows of the table, whereas the columns are associated with individual parameters.

In a non-limiting embodiment, there may be a one-to-one correspondence between the graphical elements 4940 and individual software assets listed in the software asset data container 12, i.e., each graphical element represents a software asset. Moreover, the perceptible characteristics of a given graphical element 4940 appearing in the window 4945 simultaneously and independently convey corresponding parameters of the software asset represented by the given graphical element 4940. This renders it possible for the user to perceive, in a single view, how multiple software assets compare against one another across a plurality of parameters. Selection of the parameters to be conveyed by the perceptible characteristics of the graphical elements 4940 can be achieved through a dynamic parameter selection GUI 4920 provided by the GUI portion of the interactive dashboard tool 2860. The dynamic parameter selection GUI 4920 is configured for allowing the user to dynamically (e.g., in real-time) select those parameters that are to be conveyed by the perceptible characteristics of the graphical elements 4940. Accordingly, the dynamic parameter selection GUI 4920 may present one or more selectable regions 4922, 4924, each region providing a list of one of more parameters. The interactive dashboard tool 2860 may provide the ability for the user to choose one parameter in each region 4922, 4924, in response to which the interactive dashboard tool 2860 may arrange the graphical elements 4940 in such a way as to convey all selected parameters simultaneously. Although two regions 4922, 4924 are illustrated, additional regions may be provided in the dynamic parameter selection GUI 4920, and additional parameters may be conveyed by the graphical elements 4940. Of course, more than two parameters may be conveyed by respective numbers of perceptible characteristics. Non-limiting examples of parameters that could be made available for selection in the regions 4922, 4924 include one or more of the raw parameters listed in FIG. 58A-G or derived parameters listed in FIG. 59.

As an additional feature, the GUI portion of the interactive dashboard selection tool 2860 may present a dynamic filtering GUI 4930, which allows a user to select filtering criteria. Each filtering criterion may represent a parameter (such as a raw parameter or a derived parameter) and is provided with a threshold that is selectable by the user. In response to selection of a threshold for a given filtering criterion corresponding to a given parameter, the interactive dashboard tool 2860 restricts the contents of the window 4945 to include only those graphical elements 4940 representing software assets for which the given parameter has a value that is equal to or above (or below, depending on the embodiment) the selected threshold. Accordingly, selection of the threshold for a given filtering criterion corresponding to a given parameter can be provided by a controllable graphical element for the given filtering criterion, such as a slider, dial, menu or user-specified numerical entry. It is envisaged that the user may select more than one filtering criterion, with the filters being applied in a compound manner, so as to further restrict the ensemble of software assets eligible for display in the window 4945. It is also envisaged that the dynamic filtering GUI 4930 may in some embodiments provide an area for selecting the thresholds for raw parameters that is separate from an area for selecting derived parameters. It may also be possible to specify, for a given filtering criterion, whether the graphical elements are to represent software assets for which the value of the corresponding parameter is above or below the specified threshold.

As a further additional feature, the GUI portion of the output screen 4910 may provide a date selector 4970, which could allow the user to select a date (e.g., a year), resulting in further restriction of the set of graphical elements 4940 to only those for which the underlying software assets are still expected to be operational (i.e., will not have been decommissioned) by the selected date (or during the selected year). In some embodiments, the date selector 4970 may be implemented as a slider, knob, etc.

User selection of an individual element 4940 may alert the computer system 2 that an individual software asset (or group of software assets) has been chosen for further analysis. User selection can be achieved by way of a mouse click, in a non-limiting example. Other features may be provided in a control GUI 4980 and may include an undo button (which causes the last settings to be reversed), a reset button (which causes the software asset data container to be reloaded from its original form), an unselect button (which unselects all the temporarily selected graphical elements/software assets), a filter button (which removes unselected graphical elements), a hide button (which removes the selected graphical elements), a “top 10” button (selective display to eliminate crowding) and possibly others.

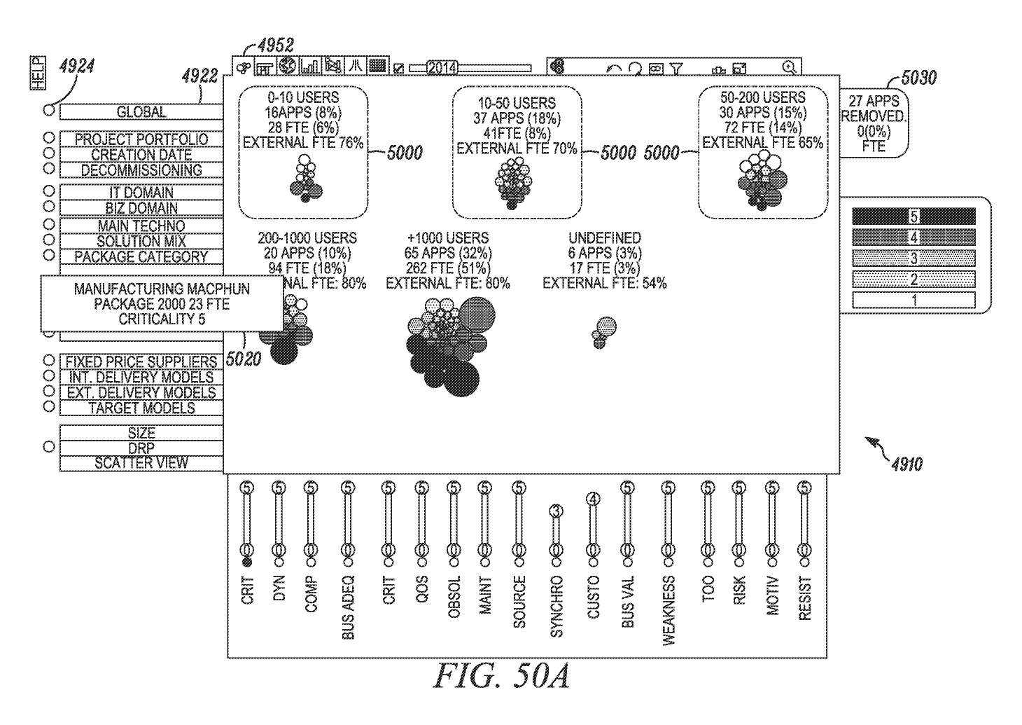

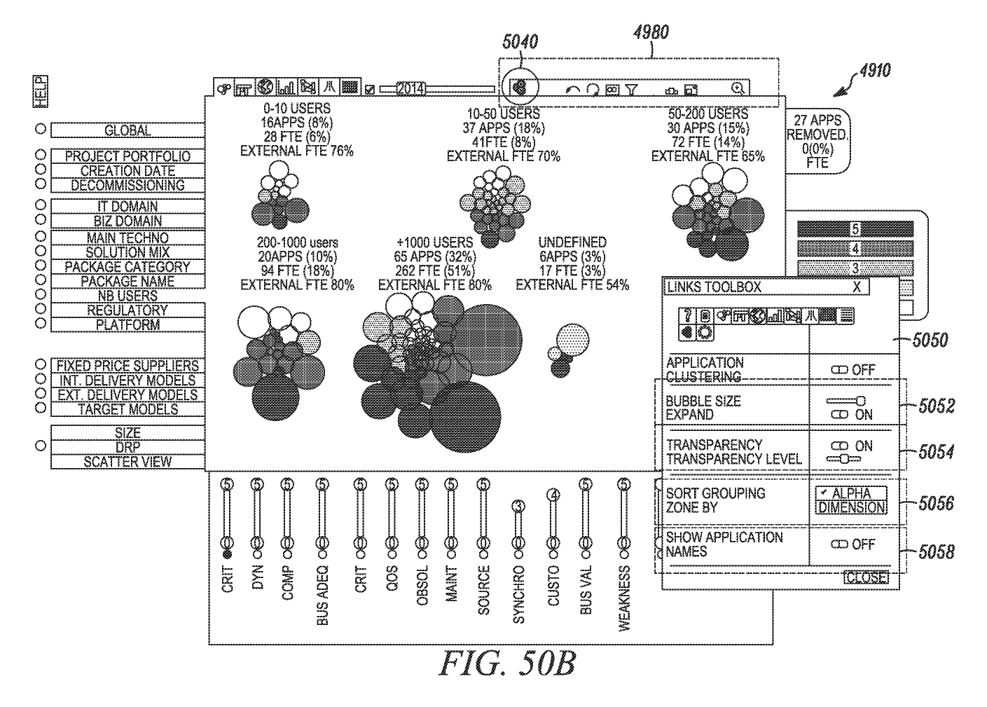

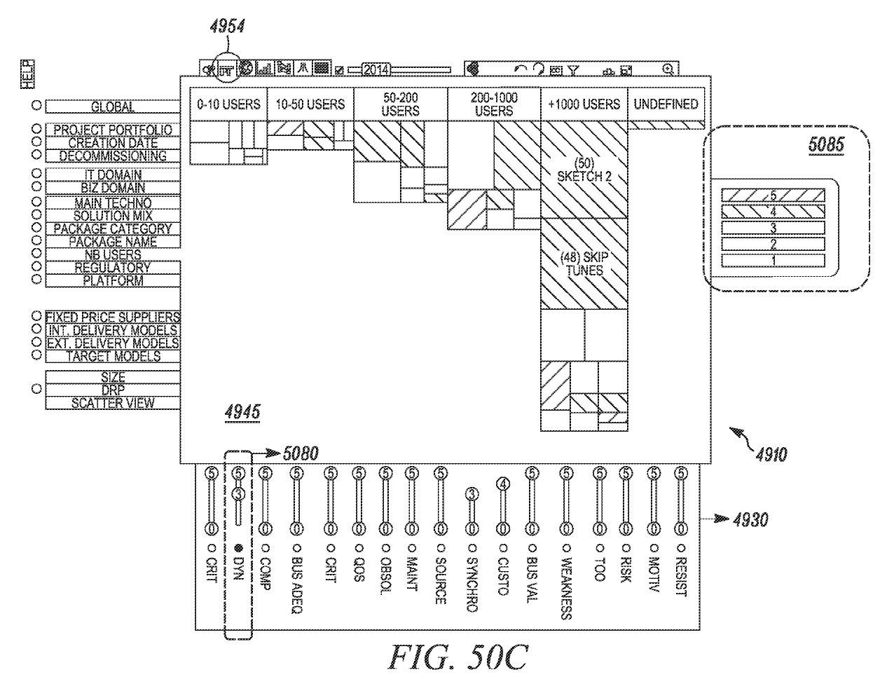

To take a specific non-limiting example, FIG. 50A shows the output screen 4910 in the case where:
The “bubbles” option 4952 has been selected from the display format selection tool 4950;
The selected parameter in region 4922 is Number of Active End Users (raw parameter); and
No parameter is selected in region 4924.

Here it will be seen that different groups 5000 are created, where each group corresponds to a different range of number of users, such as 0-10, 11-50, 51-200, 201-1000 and 1001+. There is also a group for “undefined”, in the case where information about Number of Active End Users was not provided in the software asset data container 12. In addition to positional on-screen aggregation into groups (a first perceptible characteristic), FIG. 50A illustrates a difference in shading (a second perceptible characteristic) amongst the graphical elements 4940 in each group. This could be a default feature that arises when a single parameter is selected in region 4922 and no parameter is selected in region 4924. That is to say, the shading represents a second perceptible characteristic that conveys the value ascribed to a parameter corresponding to a default filtering criterion in the dynamic filtering GUI 4930. In this case, the default filtering criterion corresponds to Criticality. However, it is envisaged that in some embodiments, this default feature is not present, such that there is no shading, which would leave aggregation into groups as the only distinguishing feature amongst the graphical elements 4940.

Also shown in FIG. 50A is an overlay 5020 which optionally appears when the user mouses over, clicks or otherwise expresses interest in a particular graphical element corresponding to a particular software asset. The overlay 5020 may indicate additional information about the particular software asset, possibly including some of the raw and/or derived parameters that might not have been selected in regions 4922, 4924. In this case the overlay 5020 indicates that the software asset representing the selected graphical element 5010 is an application called “MacPhun”, is associated with the “manufacturing” business domain, is part of a package, is associated with 23 full-time equivalent (FTE) employees, was created in 2000 and has a criticality level of 5. Of course, more or less information could be displayed in the overlay 5020 and alternatives to an overlay may be used, such as reserving a portion of the screen for this additional information or opening a new window in which to display this additional information.

Also shown in FIG. 50A is a “removed apps” indicator 5030, shown in the top-right hand portion of the output screen 4910, indicating how many software applications which appear in the software asset data container 12 do not appear in the output screen 4910. There could be a variety of reasons for a particular software asset not appearing in the output screen 4910, and therefore being counted by the removed apps indicator 5030. This could be because the software asset does not meet the filtering criteria, or was not selected, or there is insufficient data in the software asset data container 12 to allow the software asset to be assessed for whether the filtering criteria are met.

The described visualization environment operates to provide real-time, multi-dimensional feedback to the user in an interactive way, allowing de-cluttering of an IT estate and customized filtering in way that is unattainable without computer technology implementing aspects of the present invention.

Shown in FIG. 50B is a bubble graph constructed using similar data as the one in FIG.

50A, with the addition of a toolbox 5050 that can be invoked, for example, by activating/ selecting a toolbox button 5040 in the control GUI 4980. The toolbox 5050 can allow further changes to be made to the way in which the information is displayed on the output screen 4910. For example, the toolbox 5050 may provide an interactive zone 5052 for allowing the user to control a degree of expansion between neighboring bubbles, an interactive zone 5054 for allowing the user to control a transparency of the bubbles, an interactive zone 5056 for allowing the user to control how the various aforementioned groups 5000 would be arranged on the output screen 4910 (for example, left then right, up then down, alphanumerically or by group membership (e.g., largest number of members down to smallest number of members)), and an interactive zone 5058 that allows the user to select whether or not to display, in the vicinity of each bubble, the name of the corresponding underlying software asset. In the case of FIG. 50B, the degree of expansion between neighboring bubbles has been expanded relative to the situation in FIG. 50A. Additional control features and corresponding interactive zones could be provided within the scope of the present invention.

In addition, the toolbox 5050 can provide some of the same selection options as appear in the display format selection tool 4950, thus allowing the user to conveniently change the display format directly from within the toolbox 5050.

In another specific non-limiting example, FIG. 50C shows the output screen 4910 in the case where the same parameter as in FIG. 50A (i.e., Number of Active End Users) was selected in region 4922, no parameter was selected in region 4924, and the “tree map” option 4954 was selected using the display format selection tool 4950. Here it will be seen that different groups are created as vertical strips occupying distinct positions in the window 4945, where each group corresponds to a different range of number of users, such as 0-10, 11-50, 51-200, 201-1000 and 1001+. There is also a group for “undefined”, in the case where this information was not provided in the software asset data container 12. Here, in addition to positional on-screen aggregation into vertical strips having a distinct horizontal on-screen position (a first perceptible characteristic), FIG. 50C illustrates a difference in shading (a second perceptible characteristic) amongst the graphical elements 4940 in each group. This feature arises because of the selection made in the dynamic filtering GUI 4930. In this case, it will be apparent that the user has selected “dynamism” (i.e., Level of Dynamism, which is a derived parameter) as one of the selected parameters (see 5080) in the dynamic filtering GUI 4930. Moreover, the value “3” has been selected, which means (in this example) that the only graphical elements 4940 appearing in the window 4945 are those for which the Level of Dynamism was found to be at least as great as 3. Moreover, shading has been applied in accordance with the Level of Dynamism (see legend 5085). Of course, since no software asset having a Level of Dynamism less than 3 appears in the window 4945, none of the graphical elements 4940 will be attributed a shade associated with a Level of Dynamism less than 3.

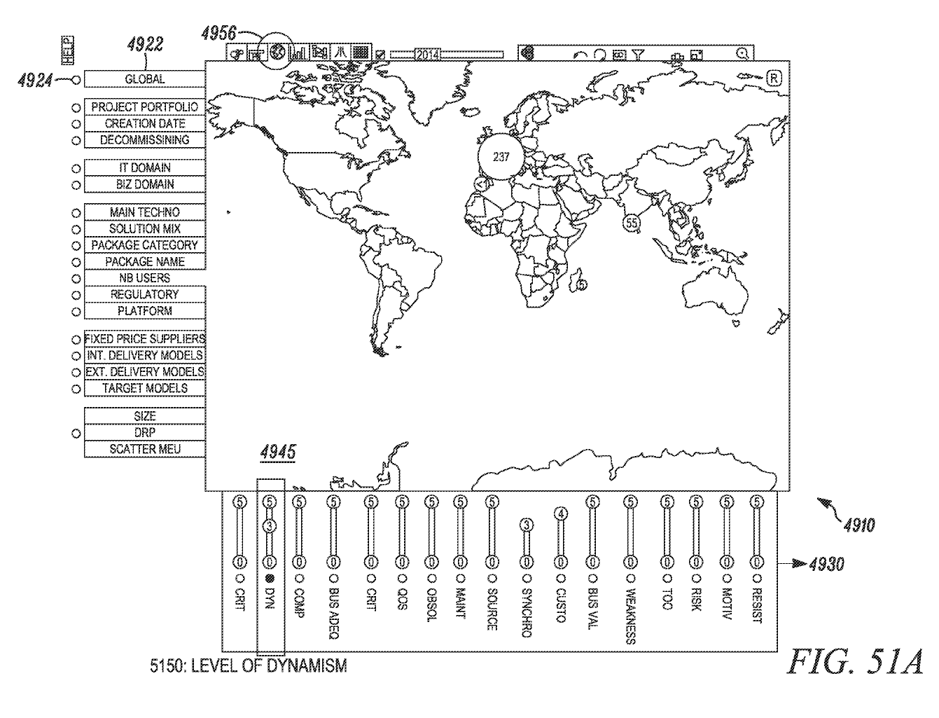

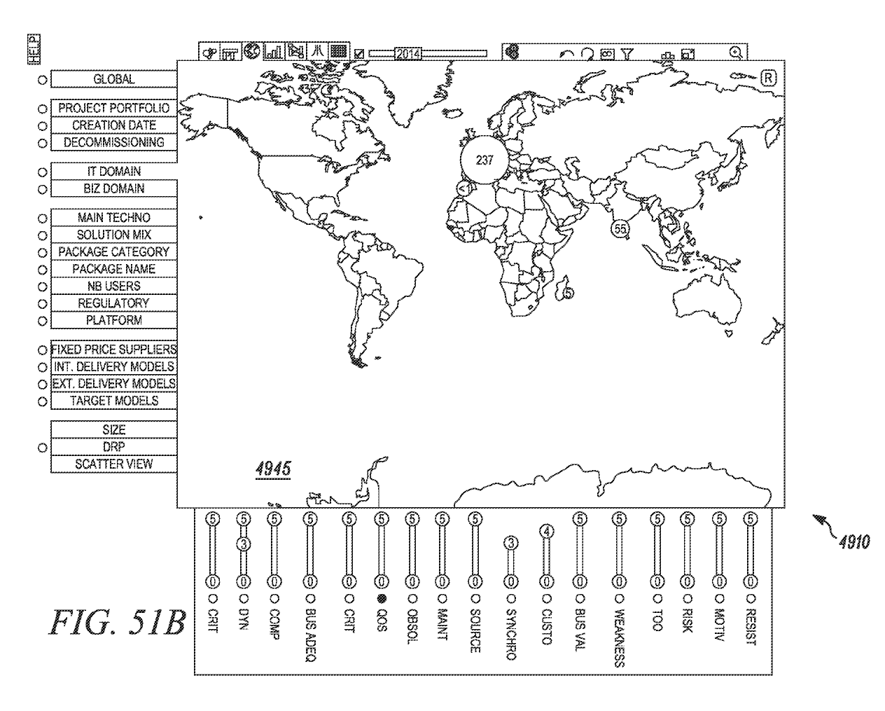

In another specific non-limiting example, FIGS. 51A and 51B shows the output screen 4910 in the case where the “map” option 4956 is selected from the display format selection tool 4950. Here it will be seen that any selections made in regions 4922 and 4924 do not modify the appearance of the window 4945, because the only parameter used by the interactive dashboard tool 2860 is the Location of the Main Business Owner (raw parameter), which in this case has per-country granularity but in other cases may have any desired level of granularity. However, selections made via the dynamic filtering GUI 4930 are still applied, which means that the number of applications that are actually distributed throughout the map will be restricted to those that, in this case, have a Level of Dynamism (see 5150) above a certain threshold.

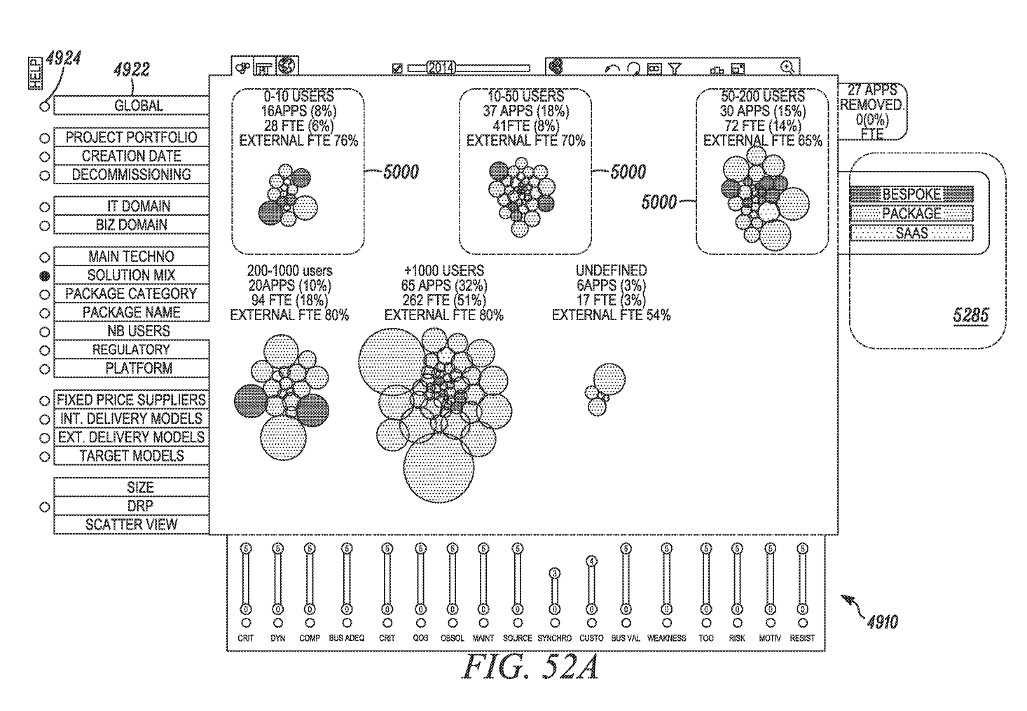

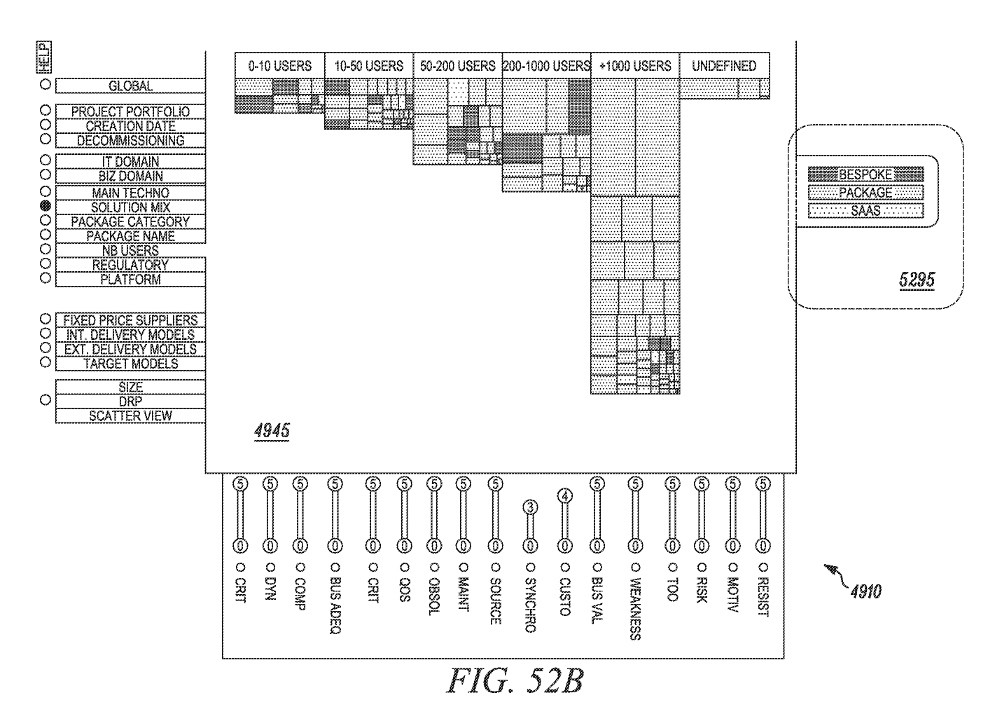

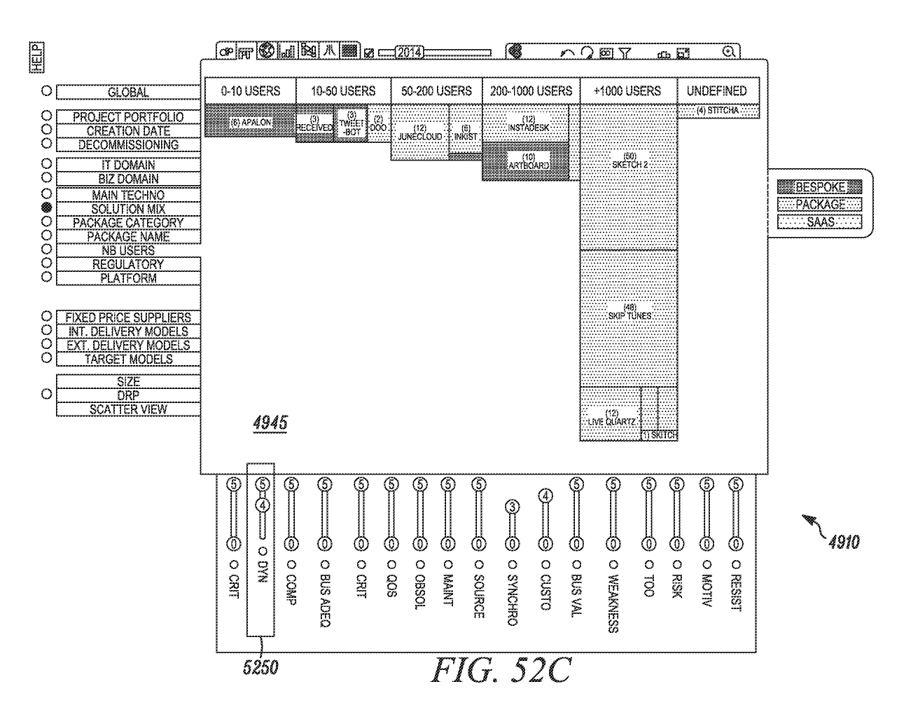

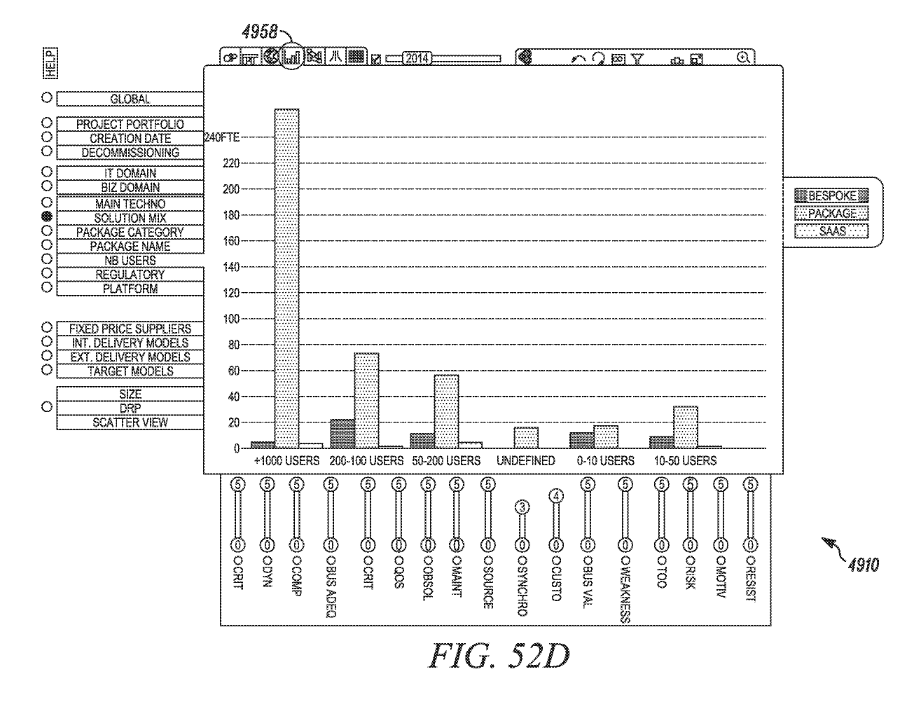

To take another specific non-limiting example, FIG. 52A shows the output screen 4910 in the case where the first selected parameter (in region 4922) is the Number of Active End Users and the second selected parameter (in region 4924) is Application Type (also sometimes referred to as “solution mix”). It is seen that in addition to different groups 5000 being created, each group corresponding to a different range of Number of Active End Users, the graphical elements in each group are shaded in accordance with the value (or range of values) of the second selected parameter. Specifically, different aggregations 5000 are created for software assets with 0-10, 11-50, 51-200, 201-1000 and 1001+ users, as in FIG. 50A. However, within each aggregation/group, the graphical elements are provided with a color/shade that is defined by a legend 5285 (shown in the right hand side in FIG. 52A). Here, it will be seen that different colors/shades are provided for “bespoke”, “package” and “SaaS” application types, referring to the values ascribed to the Application Type of the software assets represented by the graphical elements 4940.

A tree map equivalent of FIG. 52A is shown in FIG. 52B. In particular, FIG. 52B shows the output screen 4910 in the case where the same parameter as in FIG. 52A (Number of Active End Users) was selected in region 4922, the same parameter as in FIG. 52A (Application Type) was selected in region 4924, and the “tree map” option 4954 was selected from the display format selection tool 4950. Here it will be seen that different groups are created as vertical strips occupying distinct positions in the window 4945, where each group corresponds to a different range of number of users, such as 0-10, 11-50, 51-200, 201-1000 and 1001+. There is also a group for “undefined”, in the case where this information was not provided in the software asset data container 12. Here, in addition to positional on-screen aggregation into vertical strips having a distinct horizontal on-screen position (a first perceptible characteristic), FIG. 52B illustrates a difference in shading (a second perceptible characteristic) amongst the graphical elements 4940 in each group. This shading feature, which is accompanied by a legend 5295 on the right-hand side, illustrates the specific Application Type (Bespoke, Package or SaaS) for each software asset illustrated as a brick/block in one of the vertical strips.

FIG. 52C shows the same data as FIG. 52B, except that the dynamic filtering GUI 4930 has been utilized to apply a filter to the Level of Dynamism parameter. As a result, the window 4945 includes only those graphical elements 4940 corresponding to software assets with a Level of Dynamism at least as high as a certain threshold (in this case, 4).

A histogram equivalent of FIG. 52C is shown in FIG. 52D. In particular, FIG. 52D shows the output screen 4910 in the case where the same parameter as in FIG. 52C (Number of Active End Users) was selected in region 4922, the same parameter as in FIG. 52C (Application Type) was selected in region 4924, and the “histogram” option 4958 was selected from the display format selection tool 4950. Here it will be seen that different groups are created as clusters distributed horizontally along an axis. Each cluster corresponds to a different range of number of users, such as 0-10, 11-50, 51-200, 201-1000 and 1001+. There is also a cluster for “undefined”, in the case where this information was not provided in the software asset data container 12. Here, in addition to positional on-screen aggregation into clusters having a distinct horizontal on-screen position (a first perceptible characteristic), FIG. 52D shows, within each cluster, a histogram illustrating how many software assets there are within that cluster that are considered “bespoke”, “package” or “SaaS”. A shading (see legend on the right-had side of the output screen 4910) is added to indicate the difference between each Application Type (“bespoke”, “package” or “SaaS”), although this is not required as there could be a correspondence between, for example, the relative position of each column within each histogram and the associated Application Type.

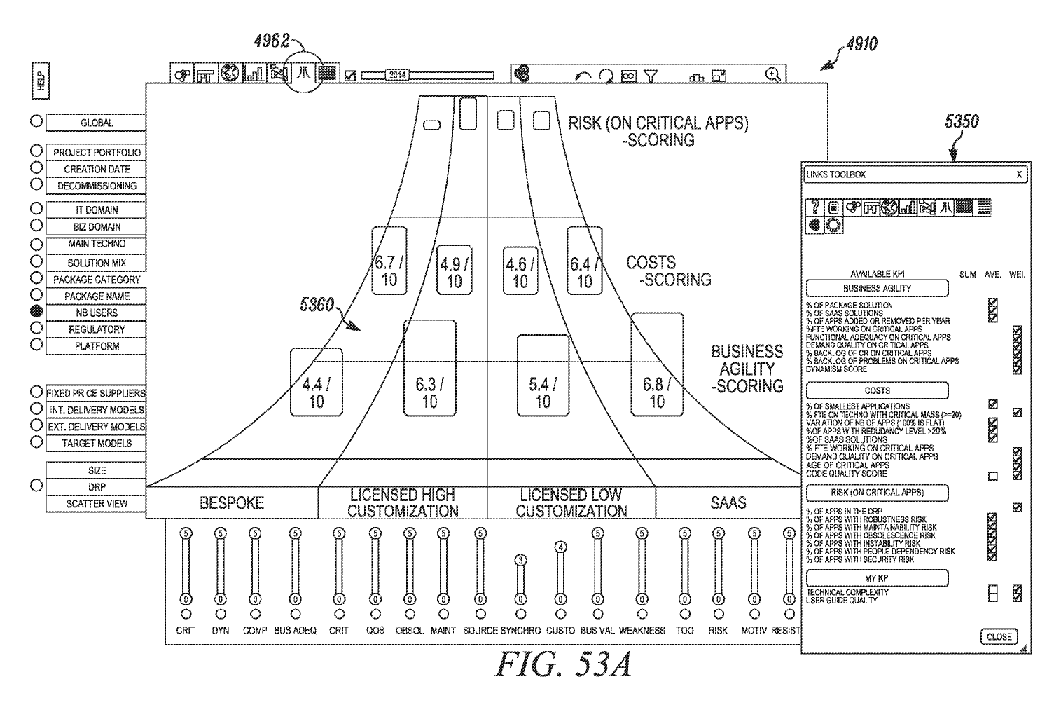

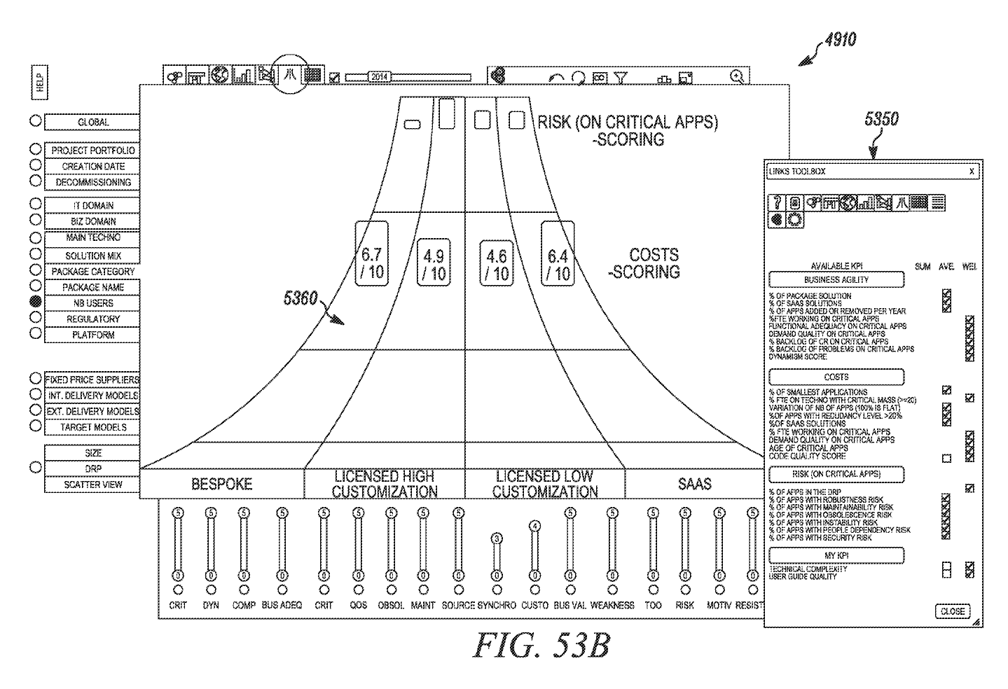

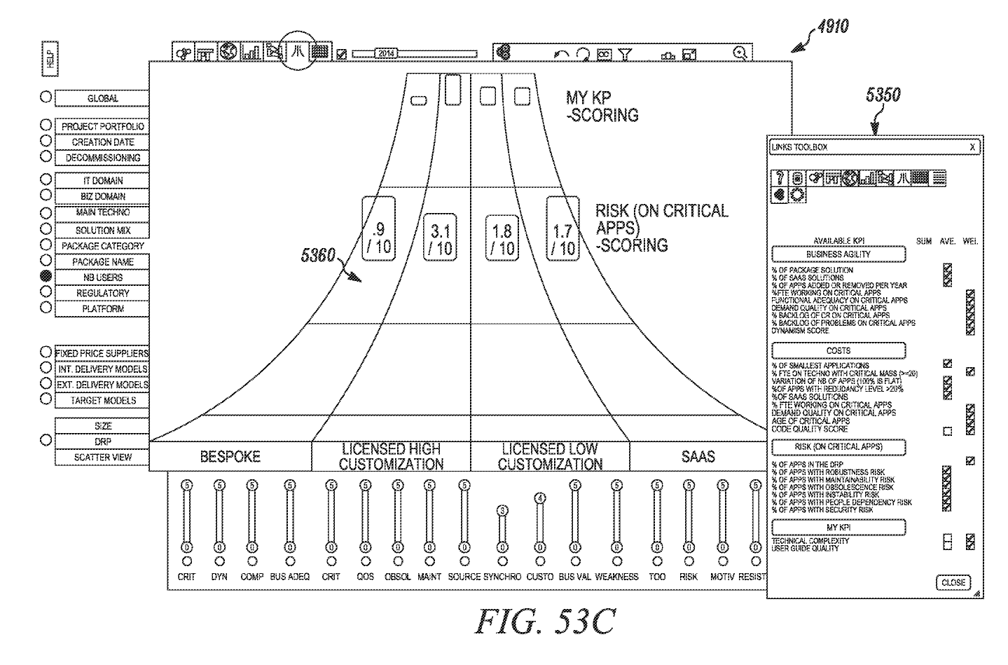

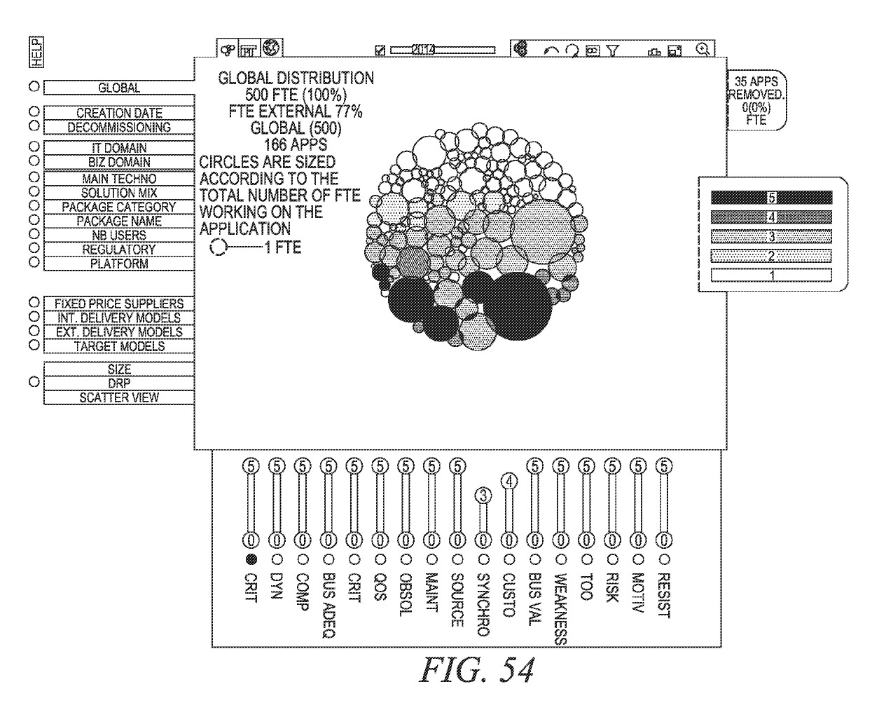

FIGS. 53A-53C show an example where the “KPI road” option 4962 has been selected from the display format selection tool 4950. Also illustrated is a toolbox 5350, in which the user is given the option to select one of three main benchmarks, namely Business Agility, Cost Efficiency and Risk (which have been described herein above). These are shown as horizontal slices (i.e., markers) on an imaginary “road” 5360 visible on the output screen 4910. Lanes along this road are created for each potential value of the selected parameter, which is in this case Package Category (raw parameter). In this case there are four such lanes along the imaginary “road”, namely “bespoke”, “licensed high customization”, “licensed low customization” and “bespoke”. Selection of one of the benchmarks through the toolbox 5350 causes the “road” visible in the output screen to “advance” or go “backwards” (see FIGS. 53A-53C in sequence), while showing, at each marker, the corresponding benchmark, for each lane.

One may also use the interactive dashboard tool 2860 to create different views of the portfolio dynamically for custom analysis—grouped either by any desired parameter, such as a raw parameter or a derived parameter. One may also download these custom views as visual graphs (e.g., tree maps) or lists for further analysis and actions.

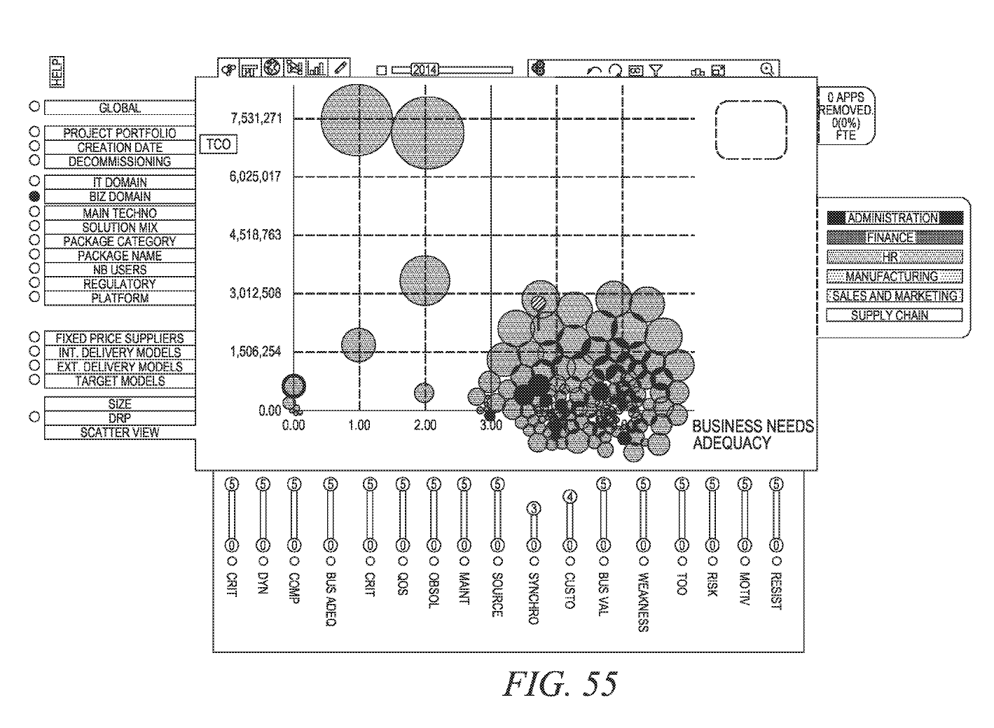

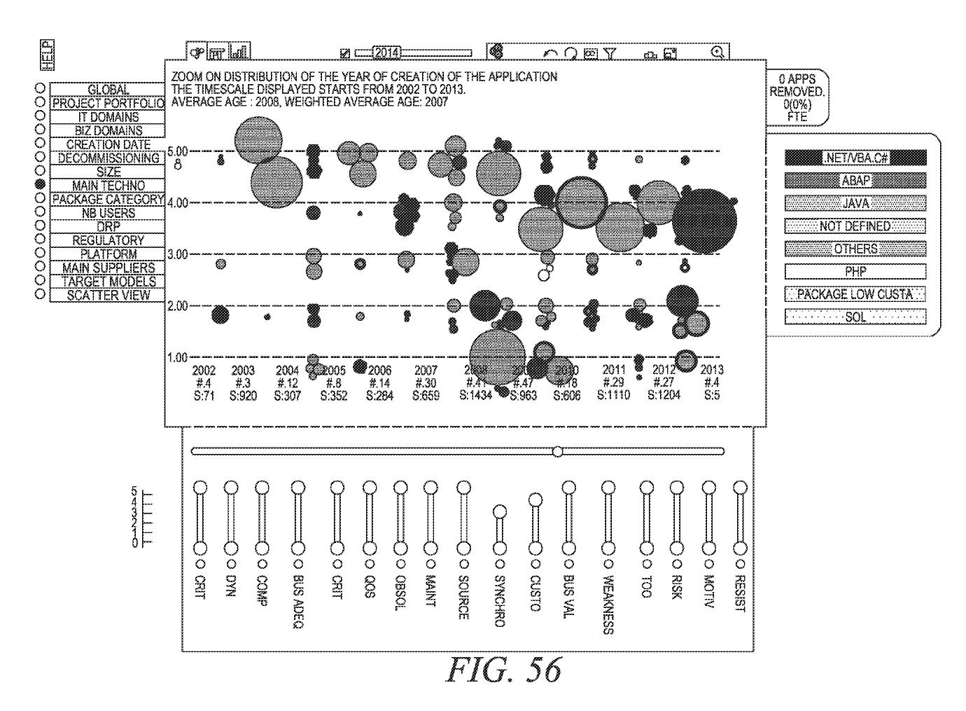

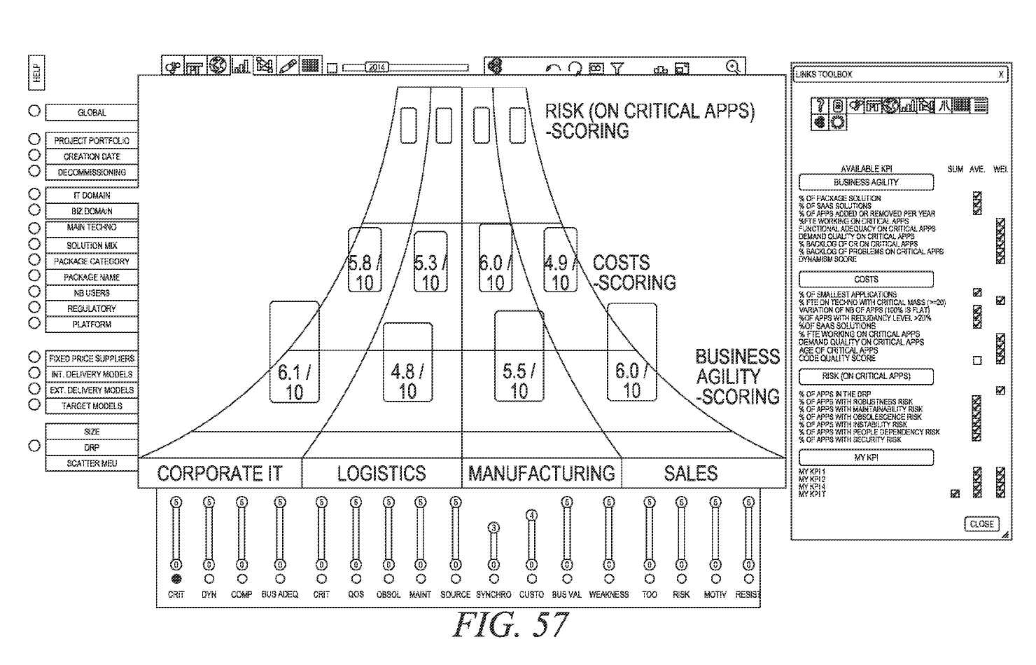

FIGS. 54-57 show further examples of the output screen 4910 that may be created through operation of the interactive dashboard tool 2860. In FIG. 54, there is provided a view showing a split of software assets by IT domains, with different characteristics (e.g., colors or shadings) being used to indicate the Criticality (raw parameter) of the application whereas the size of the graphical element indicates the Number of FTE (full time employees) working on that application. In FIG. 55, there is provided a view showing a scatter graph, wherein different characteristics (e.g., colors or shadings) can be used to indicate the Business Domain, while the axes measure the Business Needs Adequacy of the software asset in relation to its total cost of ownership (TCO). In FIG. 56, there is provided a view showing split of software assets by Age, wherein different characteristics (e.g., colors or shadings) can be used to indicate the Main Technology used whereas the size of the graphical element can be used to indicate the number of tickets opened in the last 12 months (e.g., Number of Incidents). In FIG. 57, there is provided a view showing KPI performance by IT Domain Name; different KPIs can be chosen from a menu and scrolled through.

There may also be pre-set scenarios to make often-used analyses easily accessible—for example, what software assets are candidates for decommissioning, what software assets are candidates for being moved to the cloud and/or what software assets are the most risky.

As such, dynamic visualization provided by the interactive dashboard tool 2860 enables the user to “slice-and-dice” the data as desired, to create different views for analyses and inferences to trigger actions. This can provide a bird's eye view of the entire IT estate, or a specific grouping, or a mix and match of the characteristics. For example, the interactive dashboard tool 2860 allows a user to isolate and view the software assets with, say, the lowest criticality, least number of users and lowest activity, which could therefore serve to identify candidates for decommissioning. Moreover, the dynamic visualization environment operates to provide real-time, multi-dimensional feedback to the user in a way that is unattainable without computer technology implementing aspects of the present invention.

(iii) Industrialization

With reference now to FIG. 7, operation of the IT transformation tool 240 when used for industrialization (in particular, further to selection of options B2, D5 and D6) will now be described. In a non-limiting embodiment, industrialization may include one or more of the following five phases, illustrated in FIG. 7 and discussed below in greater detail:

Phase 1: Compilation of a domain/sub-domain data container

Phase 2: Creation of an industrialization efficiency report

Phase 3: To-be model formation

Phase 4: Updating of the industrialization efficiency report

Phase 5: Conveyance

Phase 1: Compilation of a Domain/Sub-Domain Data Container

In response to detecting that GUI option B2 has been selected, the IT transformation tool 240 collects additional relevant information on the organizational aspects of the IT estate to supplement the information in the software asset data container 12. For example, this may include information on how teams are currently structured, number of staff across teams, the roles defined and the experience levels. Data may be collected at different levels of the organization, such as IT domain or IT sub-domain, business domain, business sub-domain and executive committee (for strategic questions).

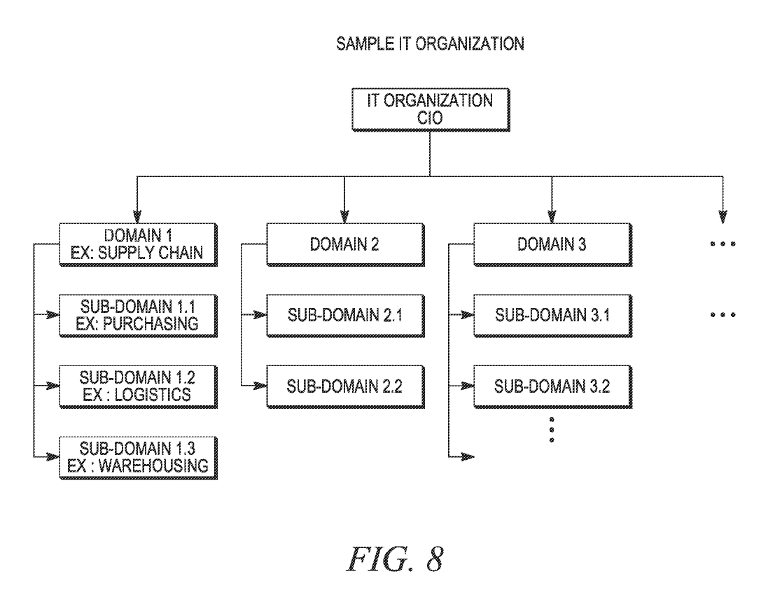

By way of non-limiting example, a simplified chart of a typical IT organization is shown in FIG. 8. Here, the IT organization is split into multiple domains (Domain 1, Domain 2, Domain 3) based on the business function or business process being served. Each domain is further split into multiple sub-domains based on a specific function or business sub-process being served. The collection and aggregation of data can be done at multiple levels to ensure relevance of the data point being collected and also validated at the next level to ensure accuracy.

The outcome of such interviews, or of a collected response to an automated questionnaire, may be used to populate a domain/sub-domain data container 13 which may be stored in the memory 10. By way of non-limiting example, and considering a particular sub-domain, the domain/sub-domain data container 13 may comprise entries for some or all of the following ancillary parameters (it should be noted that where the information is already entered into the software asset data container 12, it need not be collected via the domain/sub-domain data container 13):

General Information

(i) Starting date in Sub-domain Manager Role;

(ii) Main mission and current year objectives;

(iii) Main Challenges;

Level of Integration

(i) Integration level within the sub-domain;

(ii) Integration level with other sub-domains of the same domain;

(iii) Integration level with other domains;

(iv) Main linkages with other sub-domains;

Roadmap

(i) Current IT roadmap challenges;

(ii) Next IT roadmap challenges;

(iii) Rationalization opportunities;

Life Cycle

(i) Alignment with the Business;

(ii) Main hands off are respected: 1) Demand to Solutioning: investment sign off; 2)

Specifications to development: requirements;

(iii) Number of interfaces between teams from demand to go-live;

(iv) IT Service Catalog/SLA existence

Organization

(i) Average team size of operational people per Operational Manager;

(ii) Average number of Operational Managers reporting to the same N+1;

(iii) Ratio of people in front-office team (100% if no front/back delivery team);

(iv) Employee turnover;

(v) Internal resources: Managers;

(vi) Internal resources: Business Analysts

(vii) Internal resources: Technical Architects;

(viii) Internal resources: Technical Profiles (development/test);

(ix) Internal resources: Technicians (ex: level 1);

(x) External resources: Managers;

(xi) External resources: Business Analysts;

(xii) External resources: Technical Architects;

(xiii) External resources: Technical Profiles (development/test);

(xiv) External resources: Technicians (ex: level 1);

(xv) Apps IT shared services usage

Transversal Team

(i) Role and Responsibility;

(ii) Organizational Level of mutualization;

(iii) Average Daily rate for external resources;

(iv) Main sub-contractor Name

Budget

(i) What is the total annual budget;

(ii) What is the total annual budget in man*days;

(iii) Does business case for project decision have always quantitative ROI

Sourcing

(i) Number of distinct T&M suppliers;

(ii) Number of distinct fixed-price suppliers;

(iii) Number of fixed-price contracts with external suppliers;

(iv) Average size of fixed price supplier team

Industrialization

(i) Planning tool;

(ii) Configuration management tool;

(iii) Documentation tool;

(iv) Testing tool;

(v) Requirement Tool;

(vi) Code quality control;

(vii) Continuous integration;

(viii) Skill management tool;

(ix) Ticketing tool;

(x) Continuous improvement loops

Engagement Model

(i) User satisfaction;

(ii) Reactivity;

(iii) TTM;

(iv) Cost reduction;

(v) Predictability;

(vi) Productivity;

(vii) Flexibility;

(viii) User productivity;

(ix) Quality of asset (doc., code, test cases);

(x) Coherence of the engagement model and alignment of associated KPI all along the lifecycle

The per-sub-domain (and/or or per-domain) data contained in the domain/sub-domain data container 13, together with the per-application data contained in the software asset data container 12, can help the user to identify levers for consolidation, specialization of functions, and specific performance indicators, as now described with reference to Phase 2.

Phase 2: Creation of an Industrialization Efficiency Report

The selection of option D5 from the landing page 2800 may cause the creation of an industrialization efficiency report for the IT estate. Accordingly, the IT transformation tool 240 creates (or updates, if already created) an industrialization efficiency report, which can include a “decision dashboard” and a “scoring report”. The industrialization efficiency report can be stored in the memory 10.

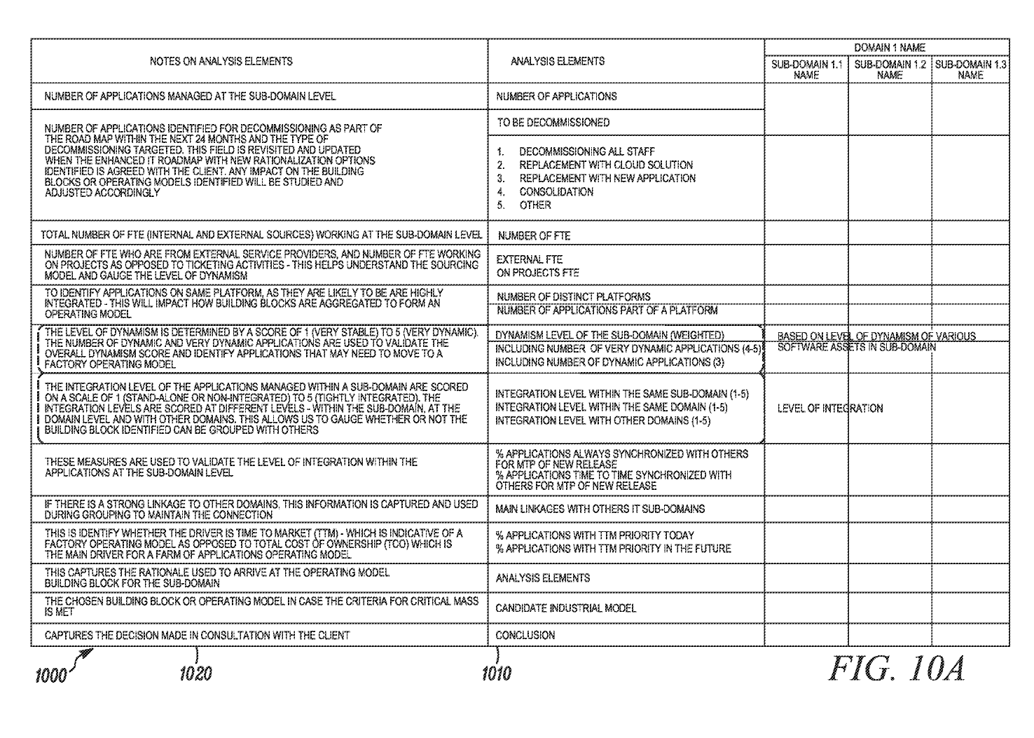

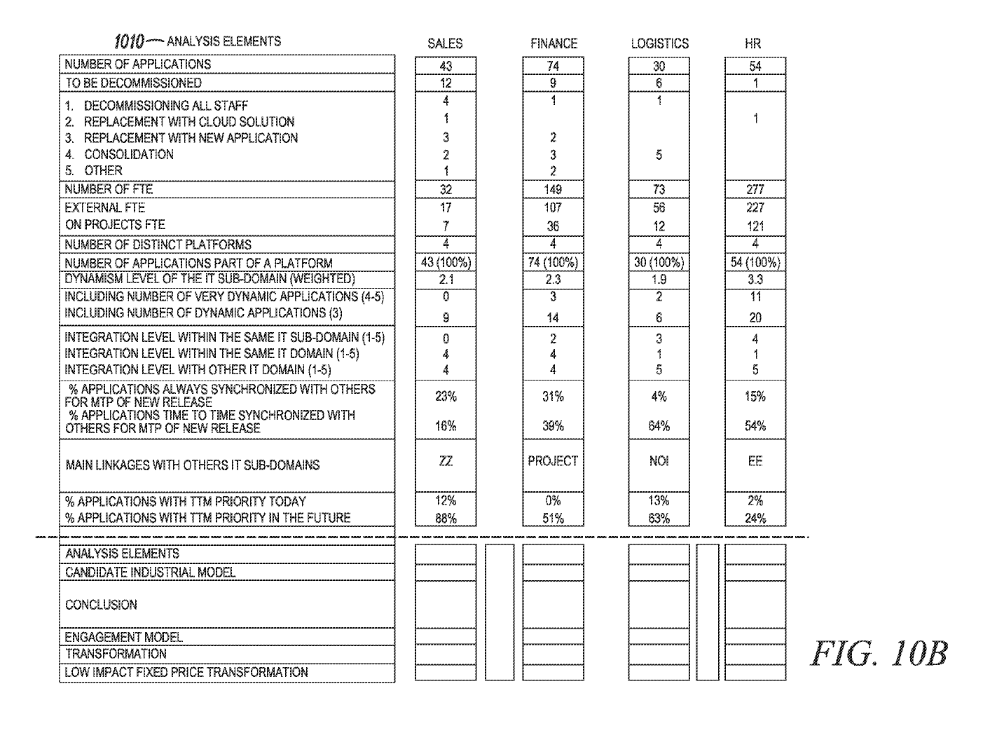

With reference to FIGS. 10A and 10B, there is shown an example of a decision dashboard 1000. The decision dashboard 1000 may include, for each of a plurality of “analysis elements”, a scoring of the applications within each sub-domain (FIG. 10A) and/or within each domain (FIG. 10B). The “analysis elements” occupy entries 1010 in the second column from the left in FIG. 10A, and the significance of each analysis element is shown in the leftmost column 1020 of FIG. 10A.

The decision dashboard 1000 provides a global vision of the IT estate, as it integrates per-application information (from the software asset data container 12) as well as per-subdomain (and/or per-domain) information (from the domain/sub-domain data container 13). The decision dashboard 1000, which may be produced at the IT sub-domain level and/or the IT domain level, can be used during Phase 3 to design a “target (or “to-be”) industrial model”, as will be described later.

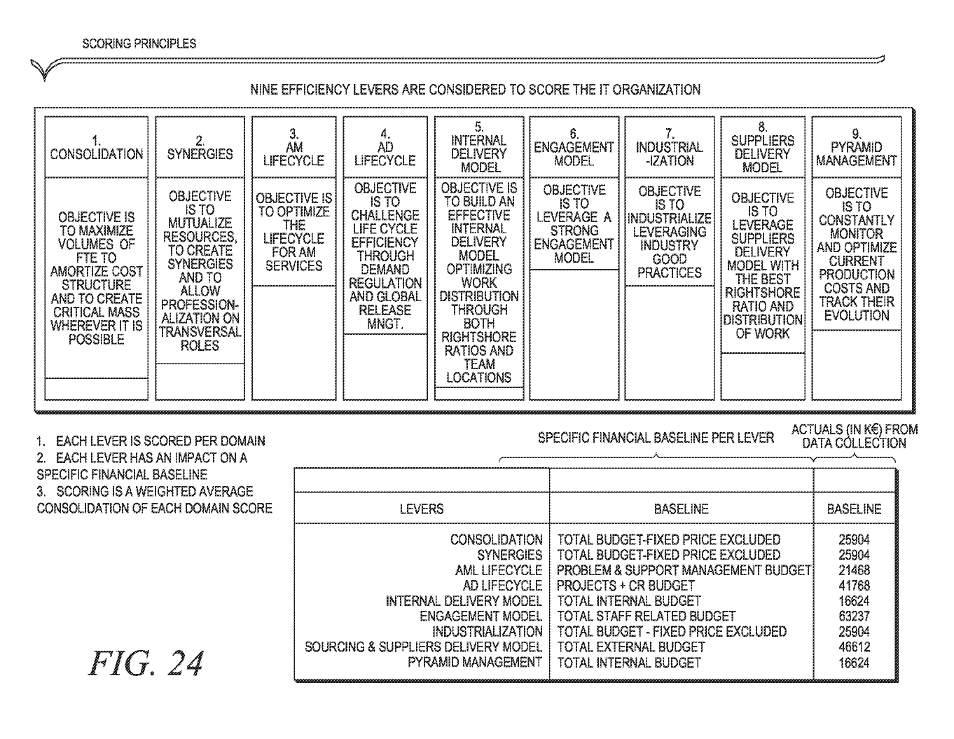

As for the scoring report, examples are shown in FIGS. 24, 25, 26A through 261 and 27.

The scoring report may cover “efficiency levers” based on a variety of scoring principles. Specifically, a plurality of “efficiency factors” are taken into consideration for each efficiency lever. The efficiency factors may pertain to applications, IT domain or IT sub-domain. In the case where an efficiency factor pertains to applications, it may be obtained from information in the software asset data container 12, such as the raw and/or derived parameters in FIGS. 58A-59. In the case where an efficiency factor pertains to an IT domain or IT sub-domain, it may be obtained from information in the domain/sub-domain data container 13.

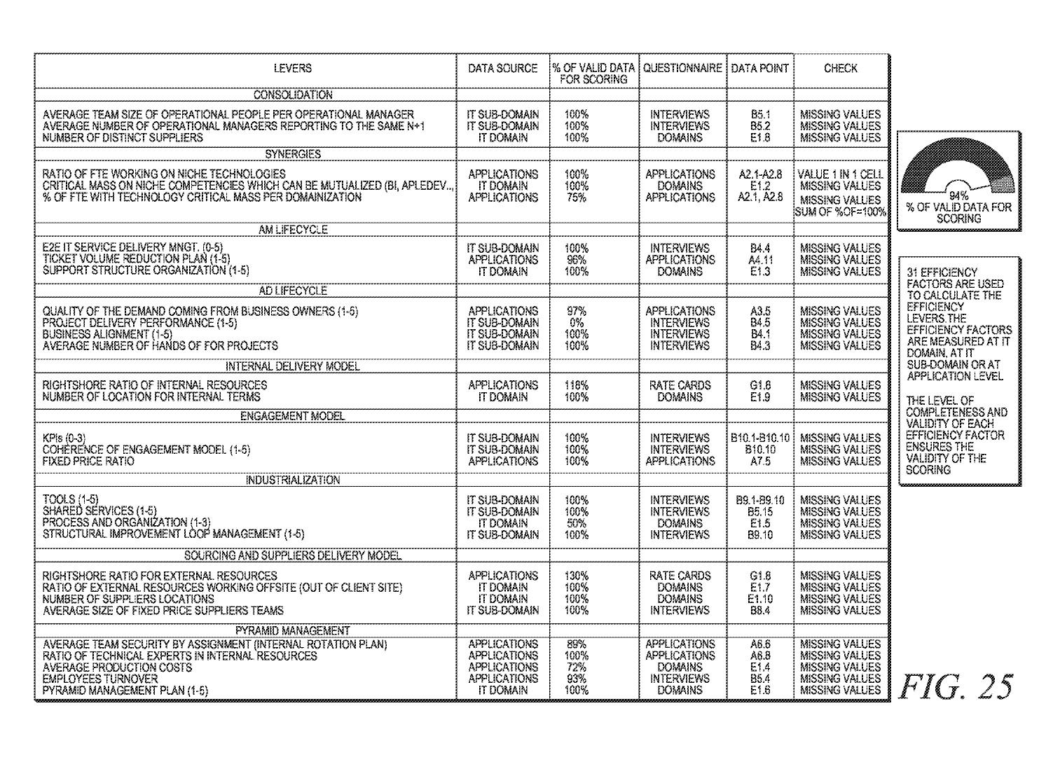

Specifically, in this non-limiting example, and with reference to FIGS. 24 and 25, thirty-one (31) efficiency factors are used to calculate nine (9) efficiency levers. In FIG. 25, the source of the efficiency levers is indicated as applications (referring to the applications data container 12), IT domain or IT sub-domain (referring to the domain/sub-domain data container 13). In this example, the efficiency levers and their corresponding efficiency factors include:
Consolidation of teams for critical mass and amortization of costs:
   Average team size of operational resources per Operational Manager
   Average number of Operational Managers reporting to the same N+1
   Number of distinct Suppliers
Synergies mutualization of high value resources (architects, project managers);
   Ratio of FTE working on niche technologies
   Critical mass on niche competencies which can be mutualized (BI, agile dev.)
   % of FTE with technology critical mass per domain/location
Application maintenance lifecycle;
   E2E IT Service delivery management. (0-5)
   Ticket volume reduction plan (1-5)
   Support structure organization (1-5)
Application development lifecycle;
   Quality of the demand coming from business owners (1-5)
   Project delivery performance (1-5)
   Business Alignment (1-5)
   Average number of hands off for projects
Internal delivery model team structures and work distribution;
   Rightshore ratio of internal resources
   Number of location for internal teams
   Engagement model alignment of KPIs across the delivery chain;
   KPIs (0-3)
   Coherence of engagement model (1-5)
   Fixed price ratio
Industrialization of tools and processes;
   Tools (1-5)
   Shared Services (1-5)
   Process and organisation (1-3)
Structured improvement loop management (1-5)
Suppliers delivery model: how external suppliers are used; and
Rightshore ratio for external resources
Ratio of external resources working offsite (out of client site)
Number of suppliers locations
Average size of fixed price Supplier teams
Pyramid management: HR aspects such as role distribution, team seniority, and costs.
Average team seniority by assignment (internal rotation plan)
Ratio of technical experts in internal resources
Average production costs
Employees Turnover
Pyramid Management Plan (1-5)

Each of the efficiency factors is computed, and then compared to values that are pre-computed and stored in memory, and which may be indicative of market “best practices”. This leads to a score for that efficiency factor.

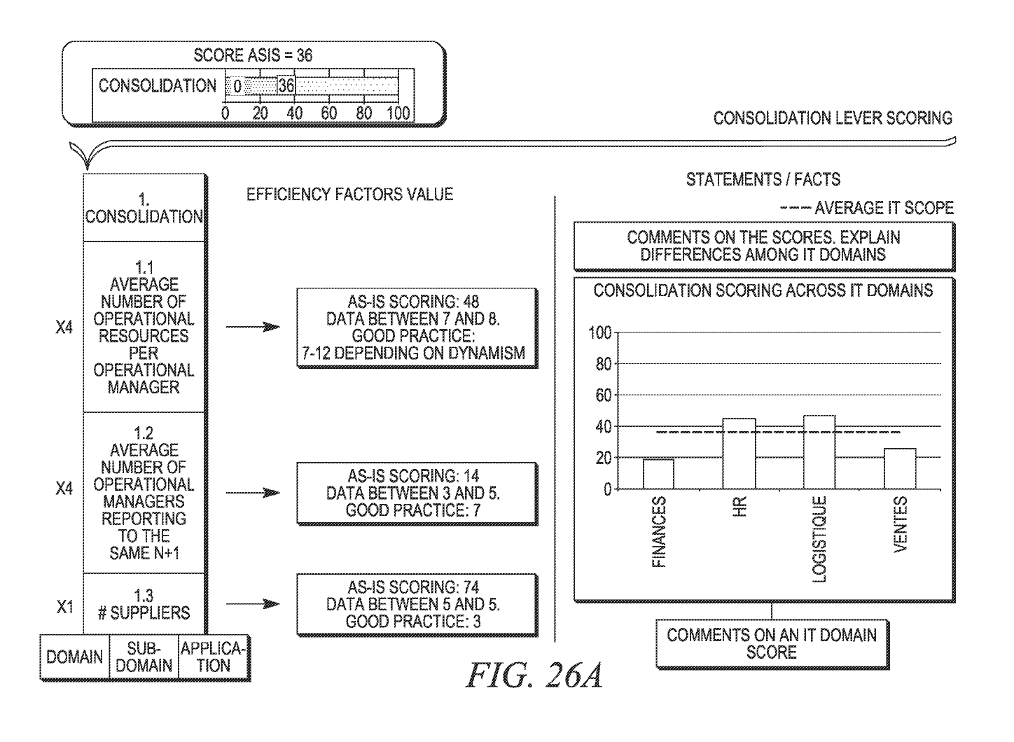

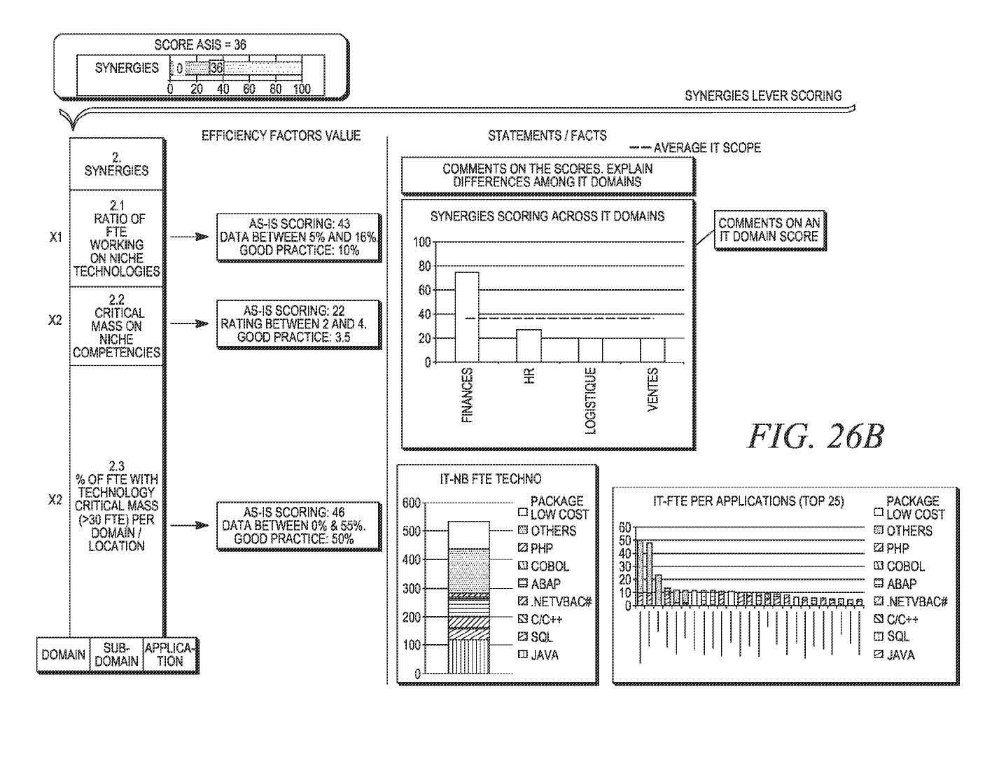

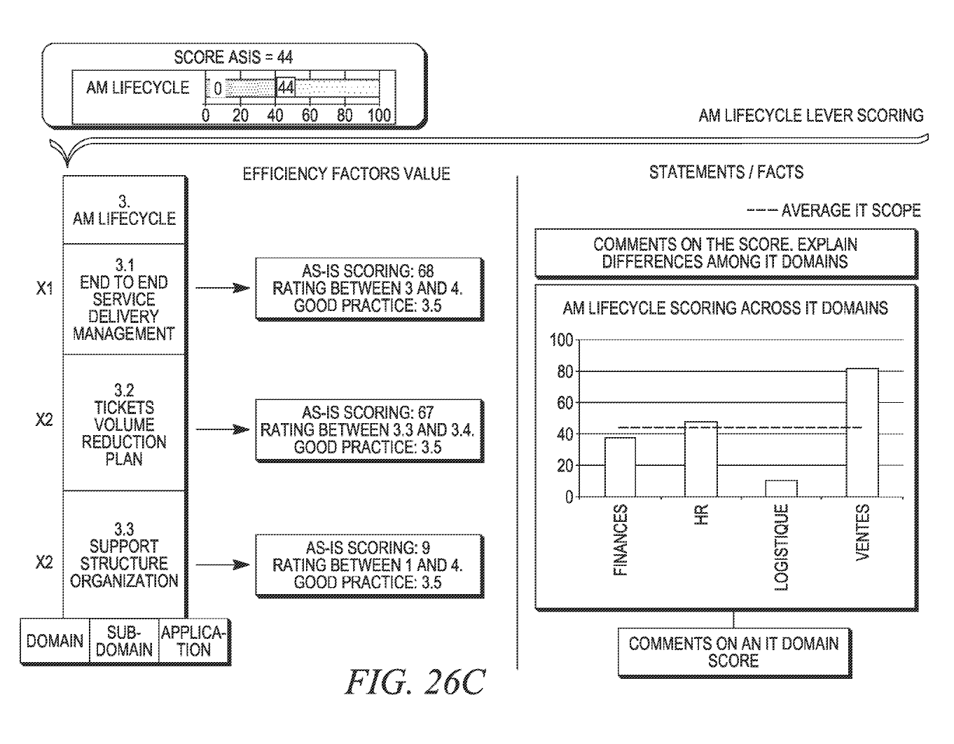

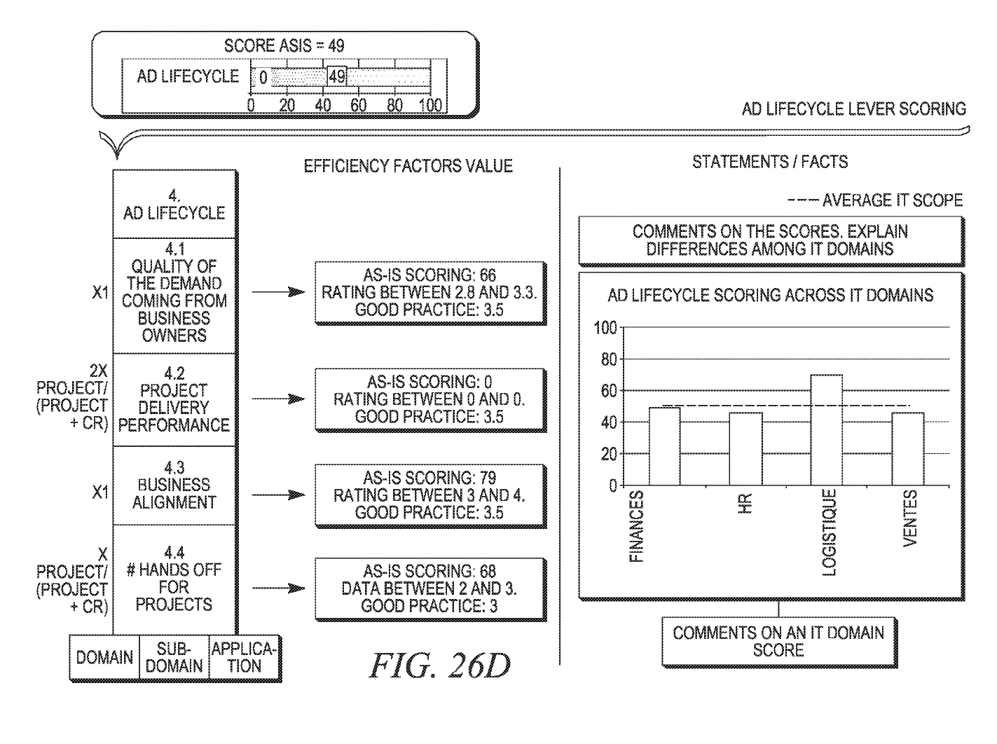

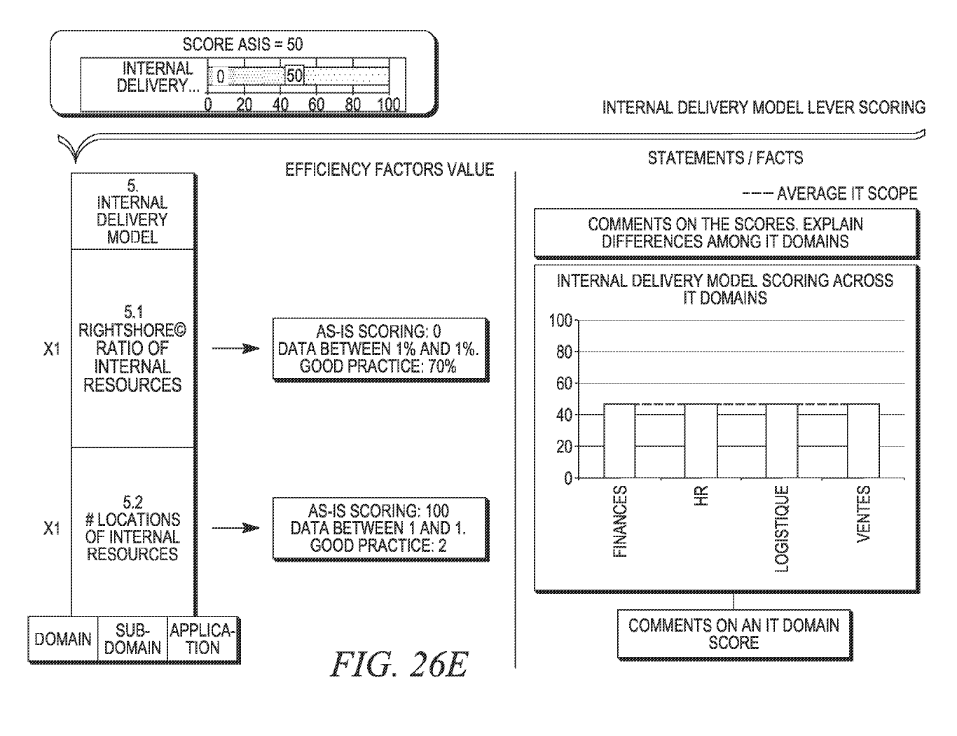

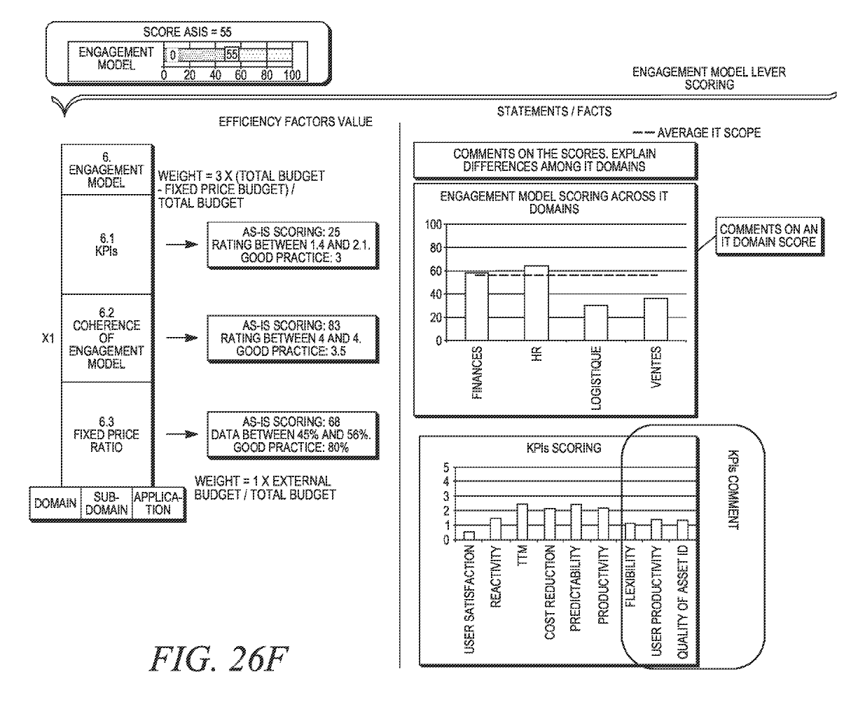

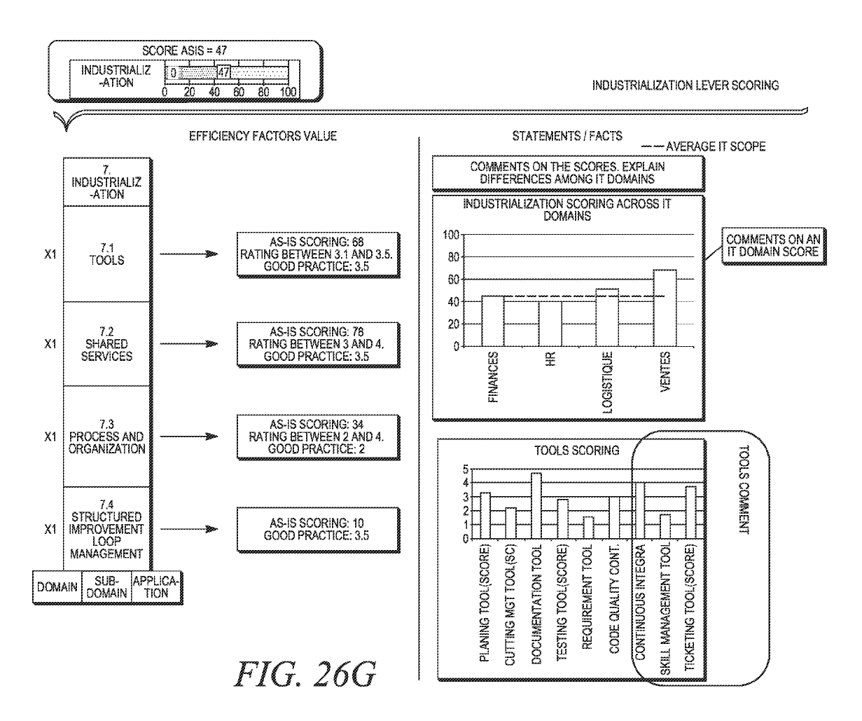

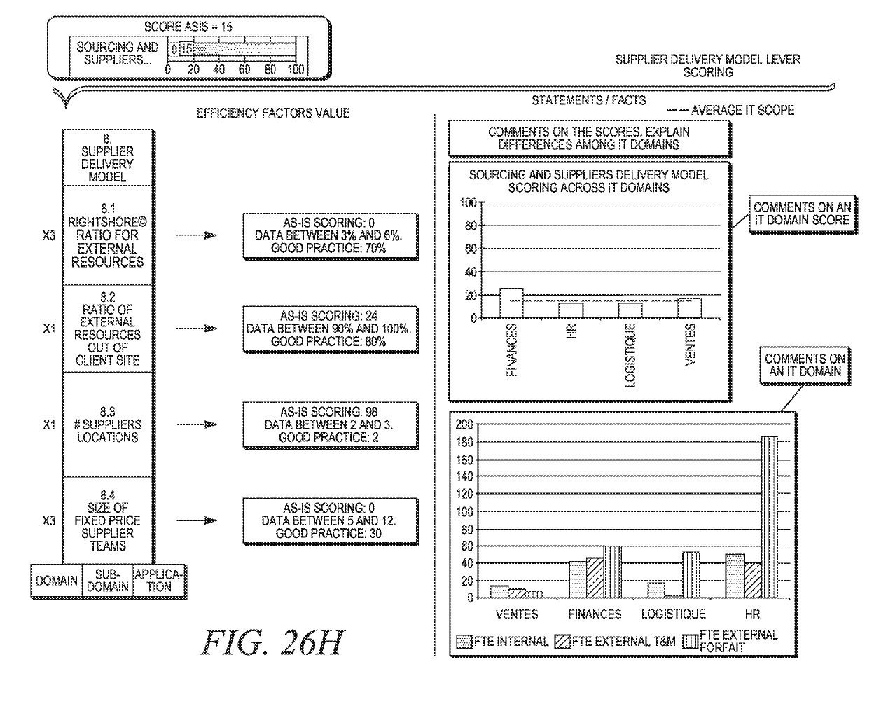

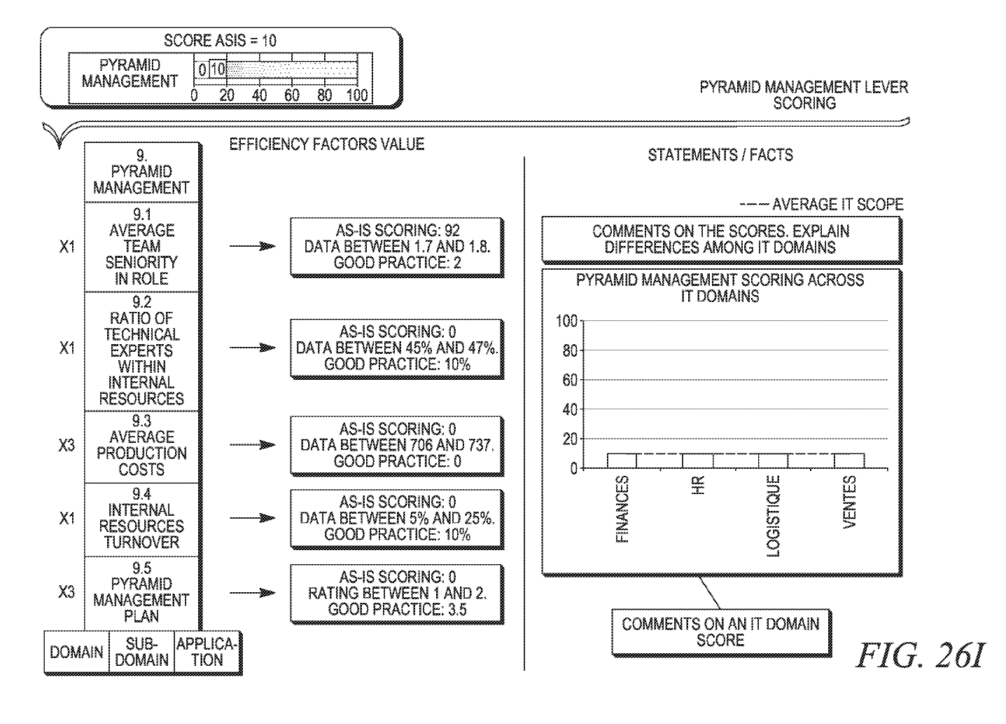

As shown in FIGS. 26A to 261, the scoring report can include a benchmark for each of the above-mentioned efficiency levers—each of which can contribute to operational excellence and may sustain IT performance. A pre-defined set of efficiency factors is measured for each of, e.g., nine (9) efficiency levers. Each efficiency factor is compared to a specific benchmark and scored on a scale of 1-100. The benchmarks may be predetermined and stored in the memory 10. Average efficiency scores are computed for each lever and the overall IT organization. Any score below, say, 50 could indicate that remedial actions to improve the score may be warranted.

For example, consider FIG. 26A, which relates to the “consolidation” efficiency lever. The efficiency factors pertaining to this efficiency lever are:

1 EF1: Average team size of operational resources per Operational Manager
EF2: Average number of Operational Managers reporting to the same N+1
EF3: Number of distinct Suppliers

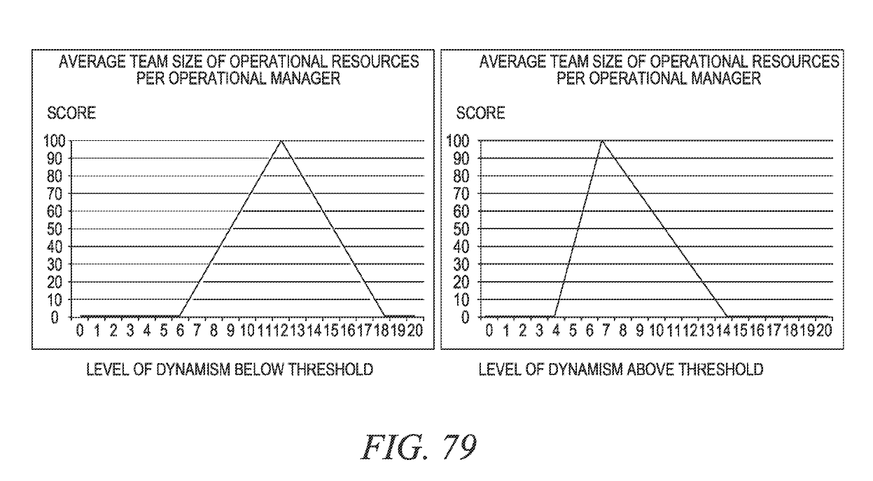

In the case of EF1, for example, the “Average team size of operational resources per Operational Manager” is computed based on sub-domain information in the domain/sub-domain data container 13, and is then given a score depending on the Level of Dynamism of the applications for that sub-domain, based on the mapping in FIG. 79. These two mappings codify not only the function that ties the team size to a score, but also the variability with Level of Dynamism. The score in this particular case was 48.

EF2 and EF3 are also calculated and were found to yield a score of 14 and 74, respectively.

Then, the scores are weighted according to a pre-weighting scheme, in this case 4X EF1, 4X EF2 and 1X EF3. When applied to the above values of EF1, EF2 and EF3, this gives a total weighted score of 36, out of a possibility of 100. As this can be done for each sub-domain, a breakdown per-domain is shown on the right-hand side of FIG. 26A, which illustrates four domains (Finance, HR, Logistics and Sales). It is seen that the current sub-domain's efficiency lever score is higher than the average score for the Finance and Sales domains, but lower than the average score for the HR and Logistics domains. This allows a unique perspective for each efficiency lever, relative to other domains and sub-domains, which can allow the more rapid and efficient detection of underperforming domains or sub-domains where changes are needed.

It will be noted that some efficiency factors may be based on the information stored in the software asset data container 12, other efficiency factors may be based on the information stored in the domain/sub-domain data container 13, while still other efficiency factors may be based on information stored in both the software asset data container 12 and the domain/sub-domain data container 13. This implies that if there are changes in the information stored in the software asset data container 12 and/or the domain/sub-domain data container 13, this may lead to changes in one or more efficiency factors and in the weighted score of one or more efficiency levers.

With reference to FIG. 25, the level of completeness and validity of each efficiency factor (which can be measured by a validation engine implemented by executing computer-readable instructions stored on a computer-readable medium) ensures the validity of the scoring. The level of completeness refers to whether the information needed to compute the efficiency factor and/or the efficiency lever is provided.

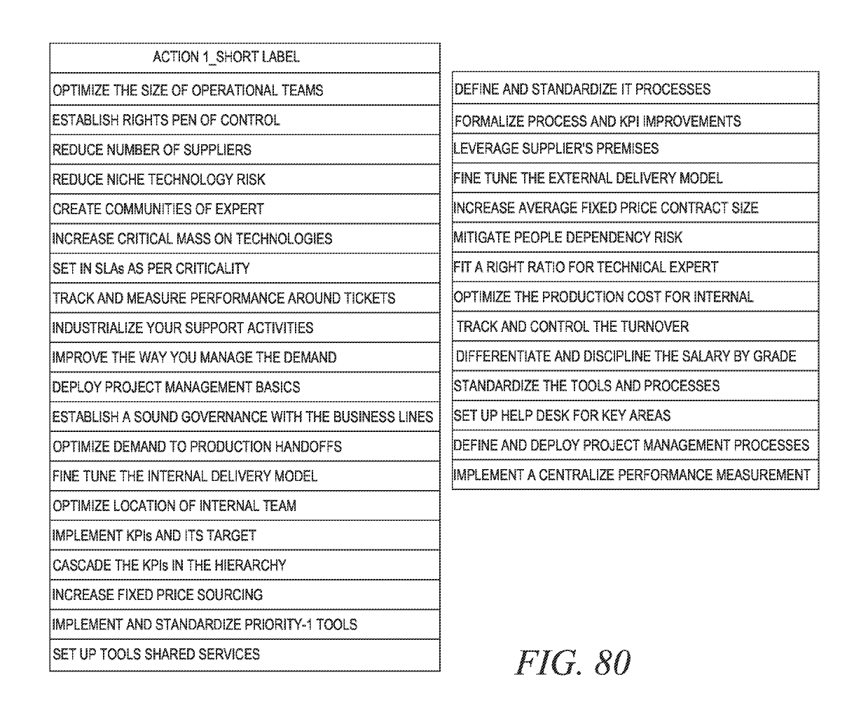

The scoring report (FIGS. 26A-26I) can incite the user to undertake improvement actions aimed at reducing organizational complexity, improving alignment between build and run teams, improving productivity, formalizing services and supplier consolidation for better management of results and lower costs. A more complete list of possible improvement actions that may be available is provided in FIG. 80.

Phase 3: To-Be Model Formation

“To-be model formation” can be viewed as a suggested, or hypothetical, restructuring of the IT organization, which can be achieved through use of an industrialization tool 2870 that may be part of the IT transformation tool 240. The industrialization tool 2870 assists the user in carrying out the improvement actions, i.e., actions to improve efficiency of the IT organization based. As such, the industrialization tool 2870 can be launched and utilized at any time after the interview form has been submitted (i.e., after Phase 1), although it may be preferable to also wait until after an industrialization efficiency report has been issued in Phase 2.

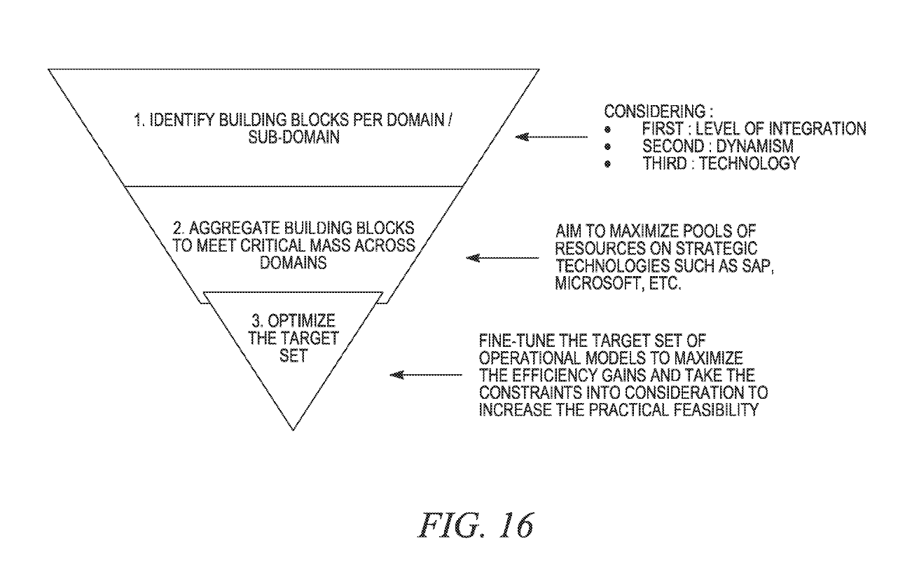

One of the various possible functions of the industrialization tool 2870 may be an aggregation wizard. The aggregation wizard may be implemented by one or more elements of the computer system 2, user device 4 or user device 6 executing computer-readable instructions stored on a computer-readable medium. The aggregation wizard provides an environment in which software assets are migrated from existing “building blocks” into specialized “operational units”. Accordingly, with continued reference to FIG. 7, the aggregation wizard may, in collaboration with the user, execute steps 710-720, also illustrated partly in FIG. 16.

Step 710

Execution of step 710 of the aggregation wizard may include identifying, within each given domain, “building blocks” of software assets. To this end, it is recalled that software assets can be classified/categorized using multiple classification criteria. These may include Level of Dynamism and Level of Integration. In fact, it has been discovered that these classification criteria serve as a useful basis on which to carry out aggregation of software assets. Other classification criteria may also provide benefits.

Software assets with a lower Level of Dynamism (e.g., steady-state applications) can be those for which the build is complete, and are not expected to undergo any major changes. They may be in a maintenance mode with activities mainly restricted to ticketing (service requests, change requests and incident or problem fixing). On the other hand, a higher Level of Dynamism (e.g., above a certain predefined threshold) is attributed to software assets that are continuously evolving.

Software assets within a particular sub-domain can be categorized as having a certain Level of Integration. Generally speaking, software assets with a higher Level of Integration are those that are closely linked to and dependent on each other. When one of these software assets undergoes a change, the whole set of software assets need to undergo non-regression testing before going into production as part of a release. Software assets that are attributed a lower Level of Integration (e.g., below a certain predetermined threshold) are stand-alone software assets and can be managed independently without impacting other software assets.

It will be recalled from the discussion of Phase 1 that there may be various integration data points that are captured during population of the domain/sub-domain data container 13, including:
1. Integration level within the same sub-domain: allows confirmation of the integration of the applications within the sub-domain which are usually taken as building blocks.
2. Integration level within the same domain: used to analyze the possible groupings of buildings blocks within a common domain.
3. Integration level with other domains: used to check across domains for dependencies and possible groupings

The Level of Integration may refer to one or more (or a combination) of the above integration data points. The Synchronization raw parameter (stored in the software asset data container 12, see FIG. 58D) can be used to cross check the consistency of the aforementioned integration data points for a particular application.

As such, a “building block” of software assets includes a collection of software assets that are within the same domain and share a common (i) Level of Dynamism; and/or (ii) Level of Integration. Based on these two classification criteria, it has been found beneficial to develop various “operational models”, examples of which include:
1. Farm—operational model characterized by software assets with a lower dynamism (such as, for example, steady-state applications with a Level of Dynamism below a predetermined threshold). The key drivers are processes, tools standardization and mutualization of resources.
2. Factory—operational model characterized by dynamic software assets (Level of Dynamism above a predetermined threshold) centered on a specific technology and having a lower Level of Integration (below a predetermined threshold). The key drivers are technology mutualization and reuse.
3. Service Centre—operational model characterized by dynamic software assets (Level of Dynamism above a predetermined threshold) that are more integrated than in a Factory (high Level of Integration). The key drivers are verticalization (scope of activities and responsibilities from demand management to move-to-production) and integration.

Thus, categorization/classification of building blocks according to one of the predetermined operational models (e.g., as a Farm, Factory or Service Center) can be done based on the Level of Dynamism and Level of Integration of the software assets corresponding to that building block. If the Level of Dynamism is above a certain threshold, then (i) if the Level of Integration is below a certain threshold then the software asset is categorized as a Factory or (ii) if the Level of Integration is above a certain threshold then the software asset is categorized as a Service Center.

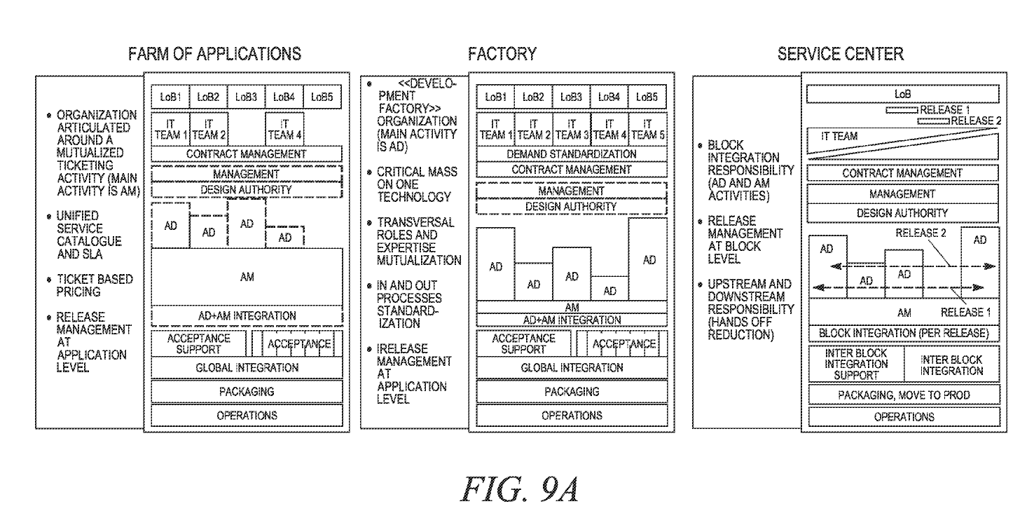

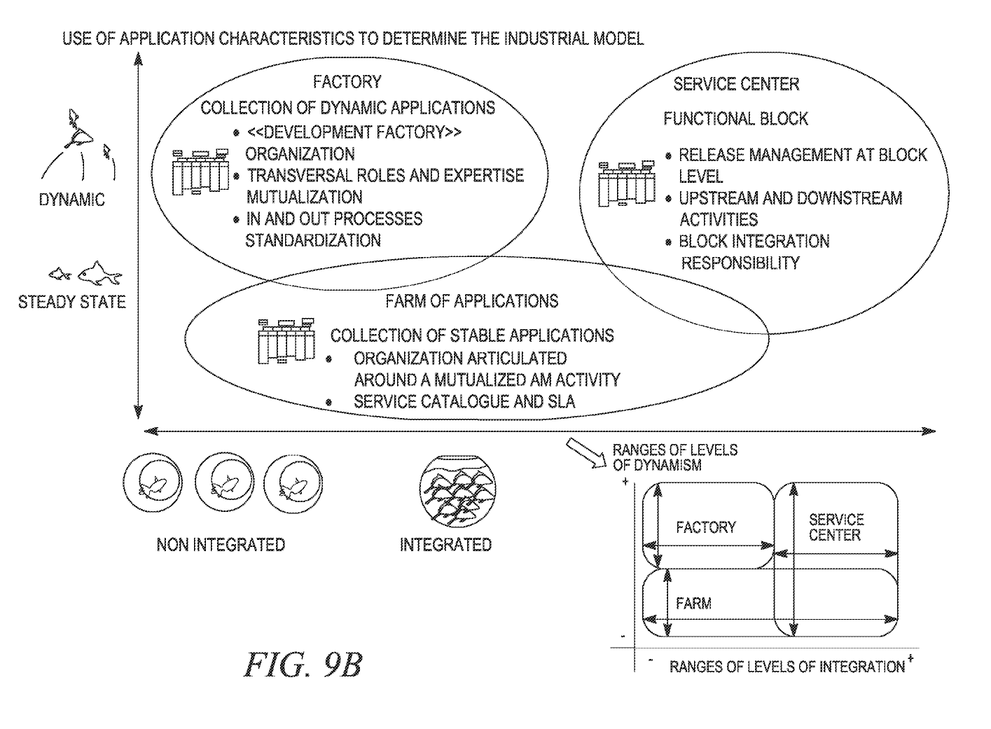

A conceptual view of these three non-limiting operational models is shown in FIGS. 9A and 9B Here, a two-dimensional diagram in which Level of Dynamism is plotted against Level of Integration is shown, and it is seen that the three operational models occupy respective areas of the diagram (i.e., ranges of values for Level of Dynamism and ranges of values for Level of Integration). It is to be understood that other embodiments may provide different criteria associated with each operational model and/or may define additional or different operational models not discussed above.

It may be further possible to granularize the building blocks according additional criteria such as, for example, Main Technology. Thus, it is possible for two building blocks in the same domain to be Farms (or Factories or Service Centers) and to be distinguished from one another based on, say, Main Technology and/or other additional criteria. These additional criteria may be entered by the user (e.g., selected form a menu) and recorded by the industrialization tool 2870.

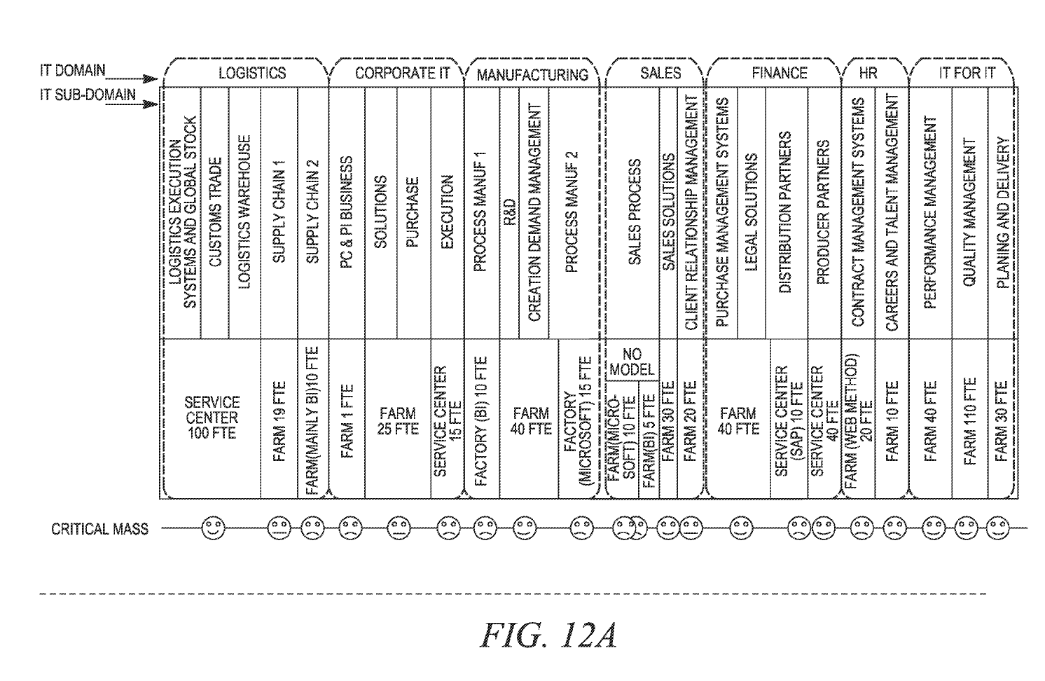

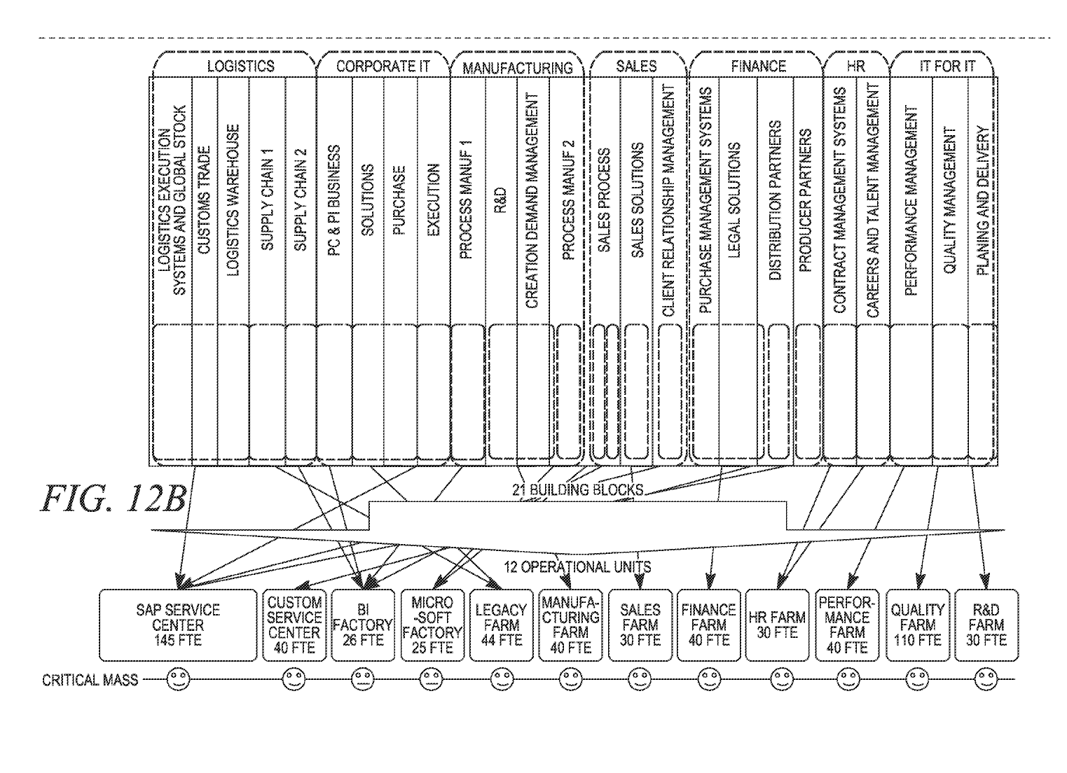

By way of non-limiting example, FIGS. 12A and 12B show a plurality of building blocks, namely Farms, Factories and Service Centers. In this example, 21 building blocks span 25 sub-domains. Thus, while the building blocks are generally at a sub-domain level, it is possible for some building blocks to span more than one sub-domain and it is also possible for a sub-domain to include more than one building block. It is noted that the Number of FTE associated with each building block is indicated. In an embodiment, this may about to the Number of FTE that are assigned to the software assets corresponding to that building block.

It is envisaged that the industrialization tool 2870, in addition to identifying the building blocks, may present to the user the set of building blocks that has been determined, possibly in graphical form as shown at the top of FIG. 12A.

Step 720

At step 720, the building blocks may be aggregated across domains according to one or more grouping criteria, thereby to form “operational units”.

As described above, each of the building blocks is associated with a particular operational model. Thus, one possible and non-limiting example of a grouping criterion may be the operational model of the building block. Thus, two building blocks in different domains but both being Farms (or both being Factories, or both being Service Centers) could be combinable into the same operational unit.

In the case where building blocks are further distinguished according to Main Technology, another possible and non-limiting example of a grouping criterion may be the Main Technology. Thus, two building blocks in different domains but sharing the same Main Technology could be combinable into the same operational unit.

Other grouping criteria are also possible. For example, aggregation could be effected based on the principle of location consolidation—e.g., to limit spread of resources to 2 or 3 locations subject to business needs, since this may improve efficiency.

In a non-limiting example, a critical mass of at least X FTE (full time equivalent staff, i.e., human resources) can be sought when forming an operational unit so as to enable its efficient functioning and unlock the benefits of industrialization. This means that there may be efficiency gains when individual building blocks having less than X FTE assigned to them, but collectively having at least X FTE assigned to them when aggregated into the same operational unit. Thus, one of the grouping criteria may be the resources assigned to a building block (or, stated differently, assigned to the software assets associated with the building block).

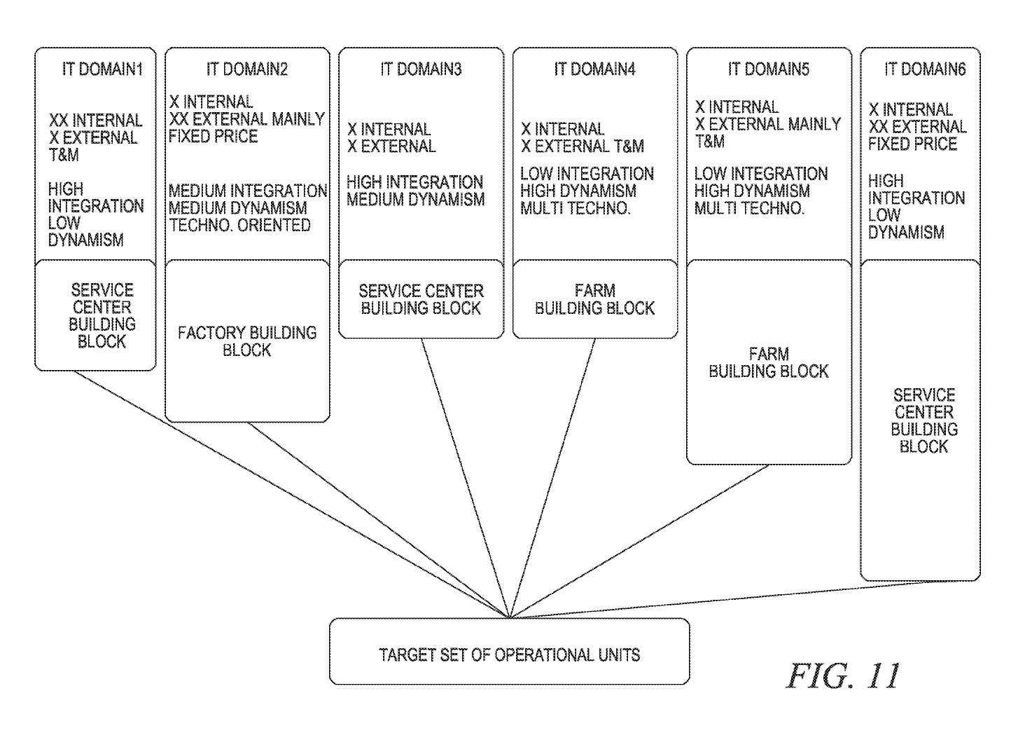

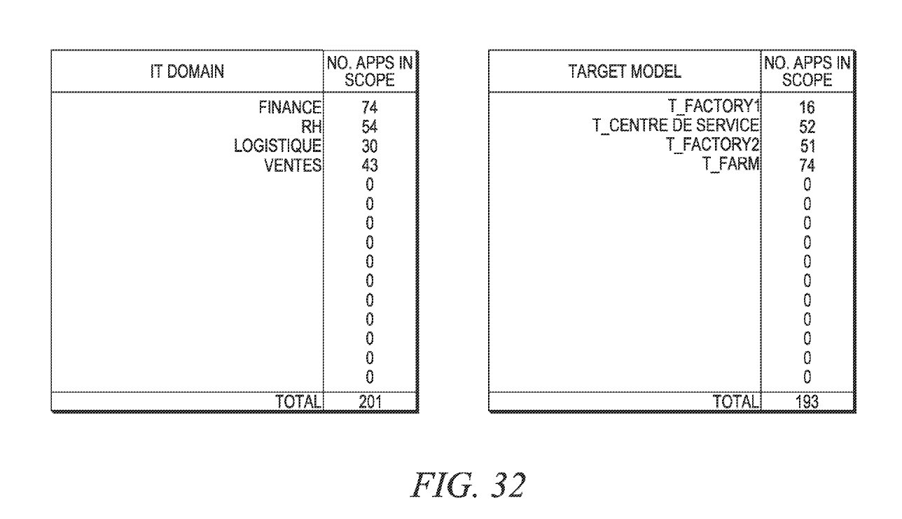

A non-limiting example of a hypothetical (“i.e., “to-be”, or “suggested”) aggregation of building blocks is shown in FIGS. 11, 12A and 12B and 32. FIG. 11 is conceptual in nature, showing that building blocks are combined across domains. FIG. 32 shows how there is a change in the number of software assets that are in scope when one considers all domains (left-hand side) versus when one considers the operational units (right-hand side). This is an example of a change that may have an impact of efficiency factors, efficiency levers, and costs. FIGS. 12A and 12B shows the specific case where the 21 previously identified building blocks are combined across domains into 12 operational units based on grouping criteria.

Also shown in FIGS. 12A and 12B is one of three possible icons illustrating, for each building block, the number of FTE associated with the software assets in that building block. The three possible icons include a first icon showing that a critical mass of FTE (in this case, 30) has been reached, a second icon showing that the critical mass of FTE has almost been reached, and a third icon showing that the critical mass of FTE is far from being reached. It is noted that, post aggregation, the chances of a software asset being associated with an operational unit for which the critical mass of FTE has been reached is greater.

It will also be noted that in FIGS. 12A and 12B, it is possible to aggregate a Farm with a Farm (with the resulting operational unit being a Farm), a Factory with a Factory (with the resulting operational unit being a Factory), and a Service Center with a Service Center (with the resulting operational unit being a Service Center). However, it is also possible for a Farm to be aggregated with a Service Center such that the resulting operational unit is a Service Center. This is because a Service Center has greater capabilities than a Farm (i.e., it can handle software assets with a greater Level of Dynamism). For instance, a Service Center can also handle “ticketing” activities that might ordinarily be assigned to a Farm.

As such, it is not necessary to aggregate building blocks having exactly the same operational model. Instead, one can aggregate building blocks that have a compatible operational model, where the range of Levels of Dynamism and the range of Levels of Integration of one operating model is subsumed by the range of Levels of Dynamism and the range of Levels of Integration of the other operational model (being the operational model associated with the operational unit).

It should also be noted that different grouping criteria may be used for different operational units. For example, Main Technology may be a grouping characteristic for Factories. However, Farms can be grouped based on technological or functional or organizational criteria, including parameters contained in the software asset data container 12 and the domain/sub-domain data container 13. These may include:
Business domain or sub-domain
Geographical location of FTE
Size of team (so as to attain critical mass, e.g., 30 FTE)
Integration data points: functional links (applications that are part of the same process) or technological links (technological interfaces, data exchanges) with other building blocks (or sub-domains)
Etc.

In some embodiments, aggregation may be automatically performed by the industrialization tool 2870 according to the grouping criteria, either predefined or entered/selected by the user.

Additional parameters can be entered into the software asset data container 12 for each software asset involved in aggregation. Completion of such additional entries in the software asset data container 12 may be automated, such that it is performed by the industrialization tool 2870. For example, for a given software asset, it is possible to assign one additional parameter that specifies the operational unit with which the given software asset would be associated if the hypothetical aggregation were to take place. That is to say, each software asset is associated with a particular operational unit in the target set of operational units. There may of course be more than one software asset associated with a particular operational unit, since the criteria for being part of an operational unit can be met by multiple software assets.

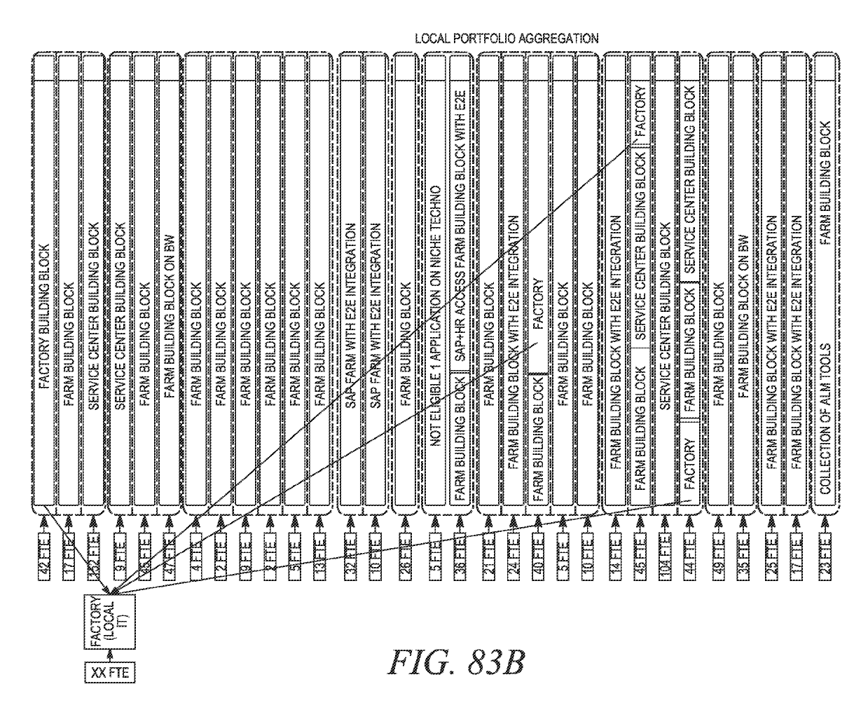

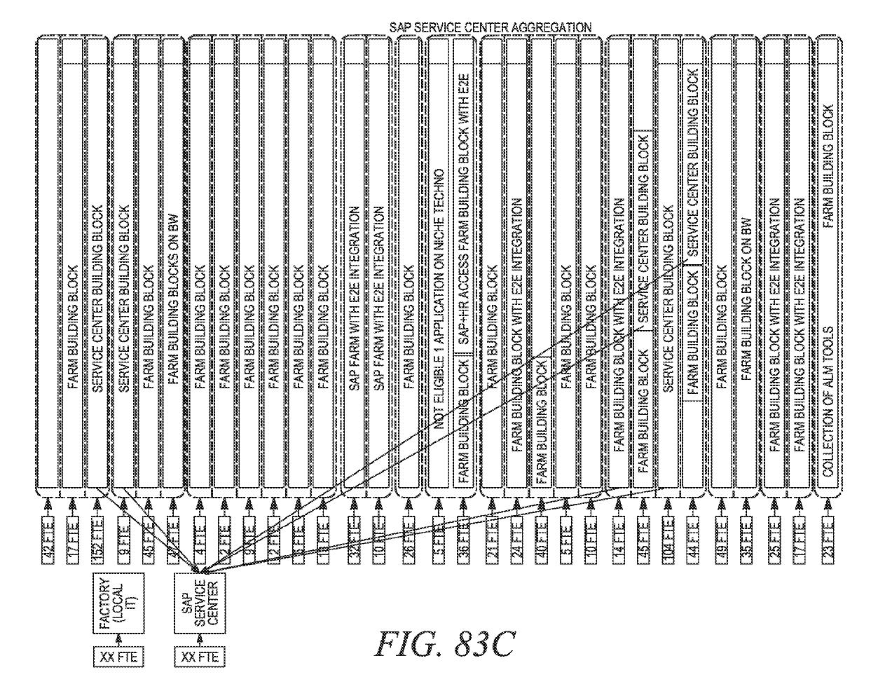

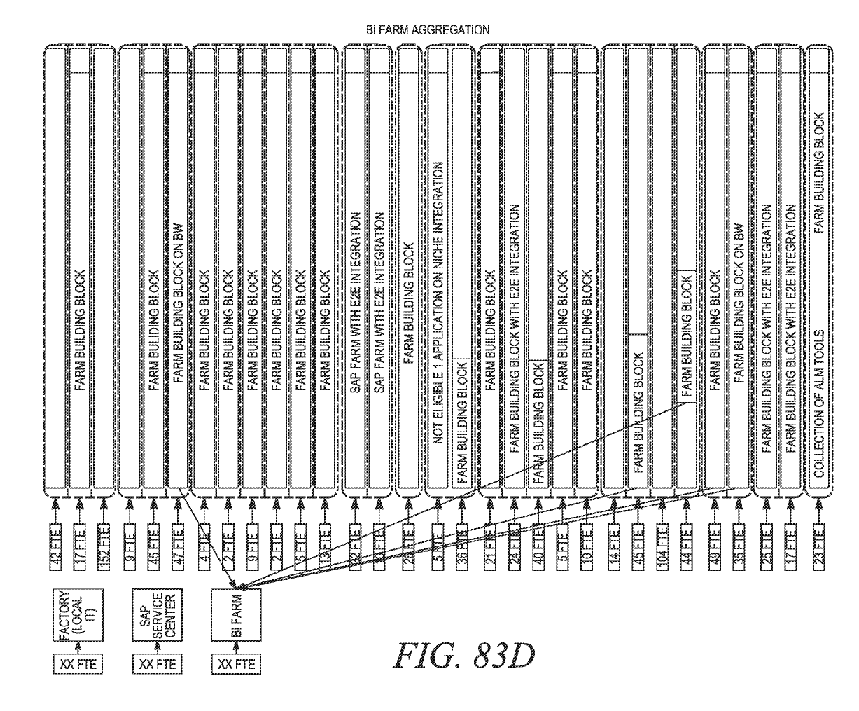

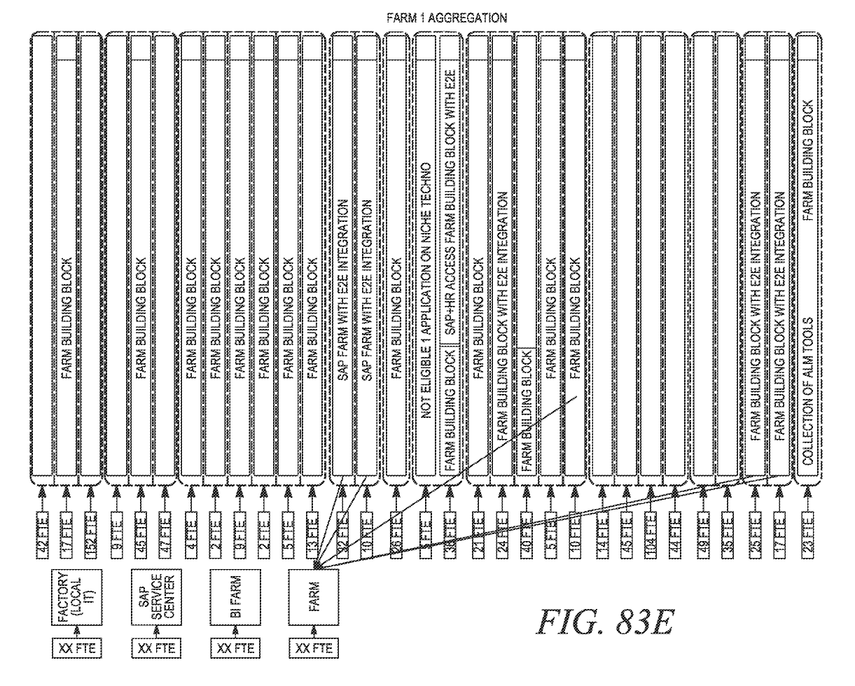

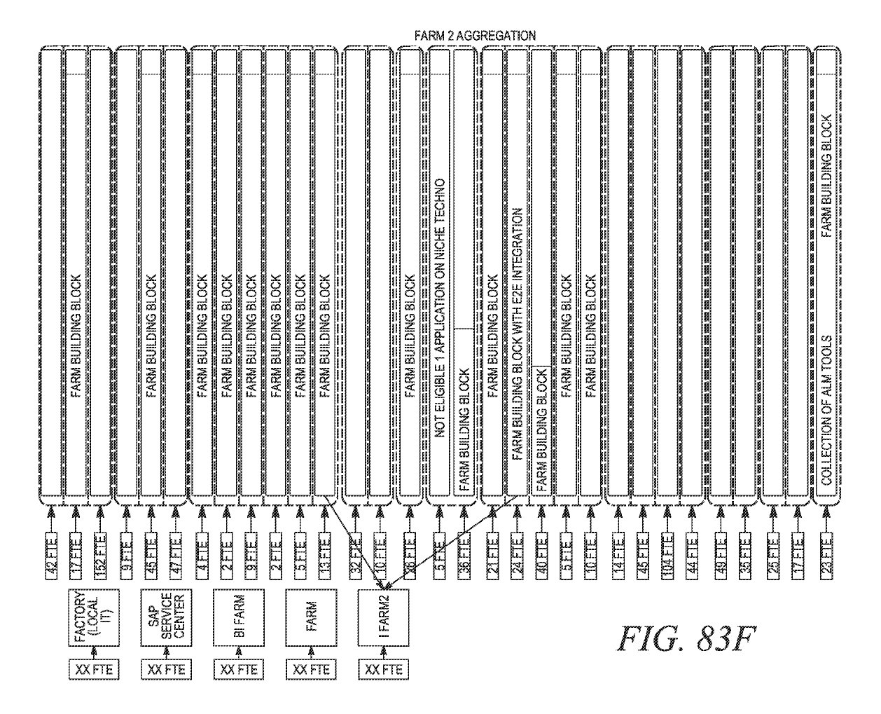

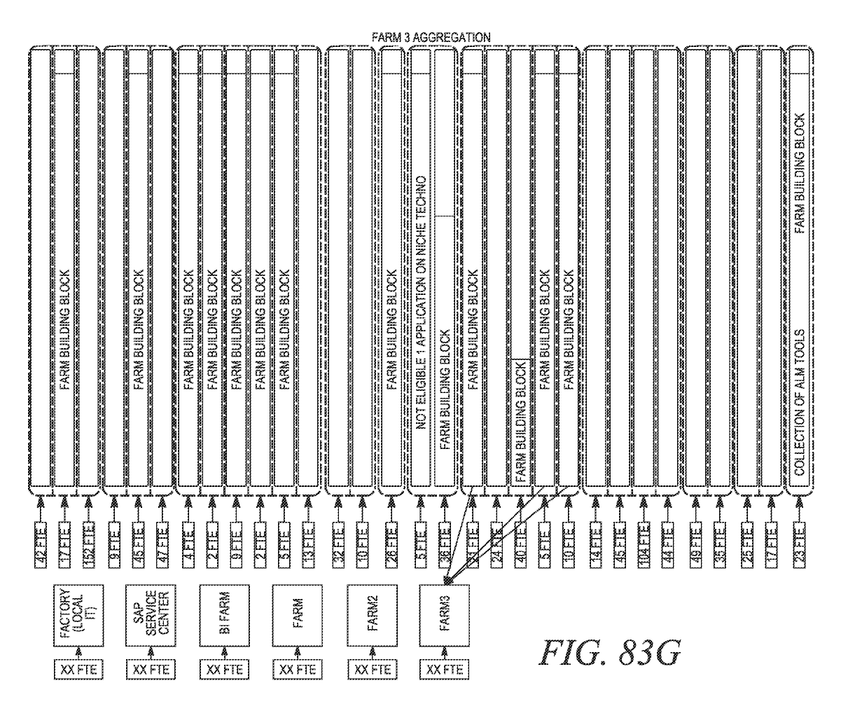

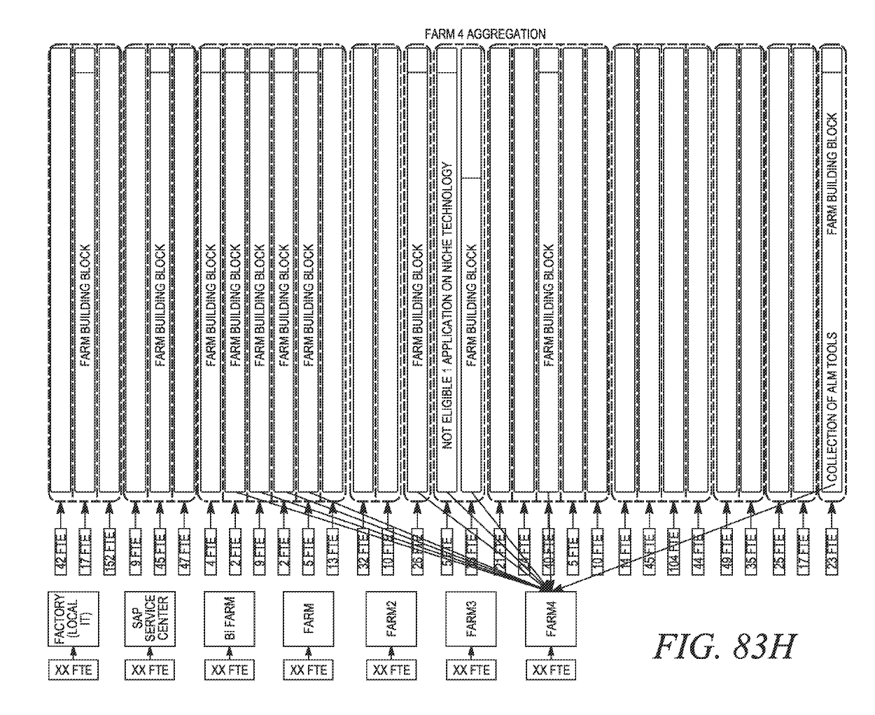

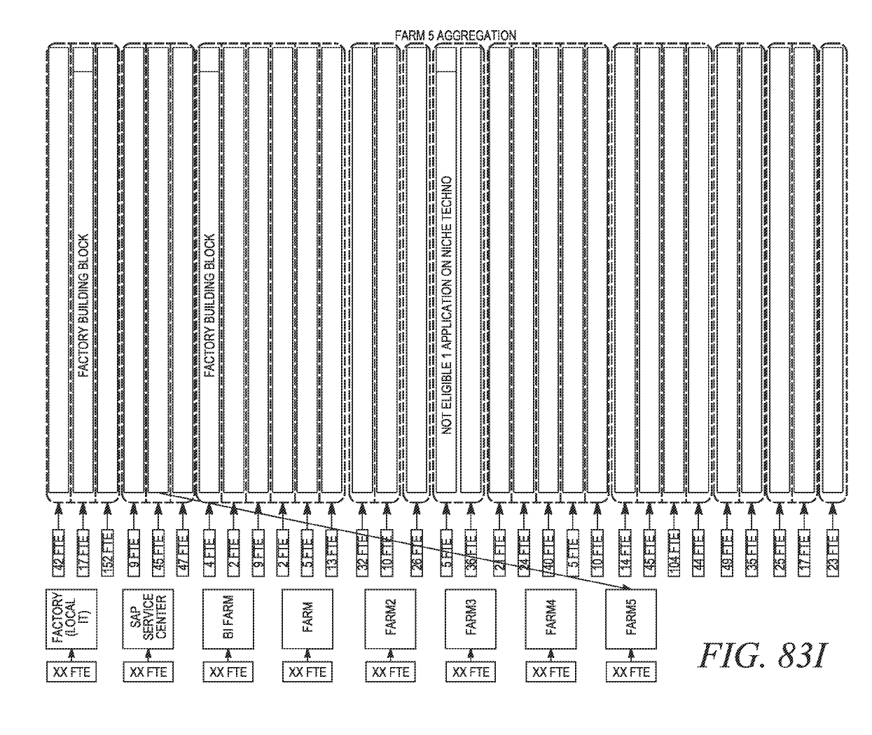

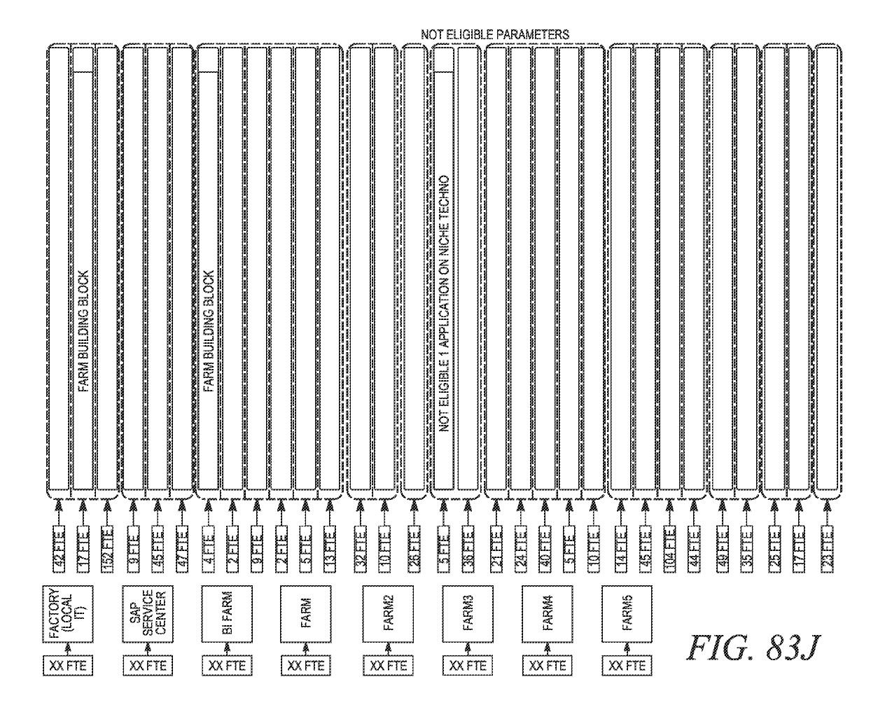

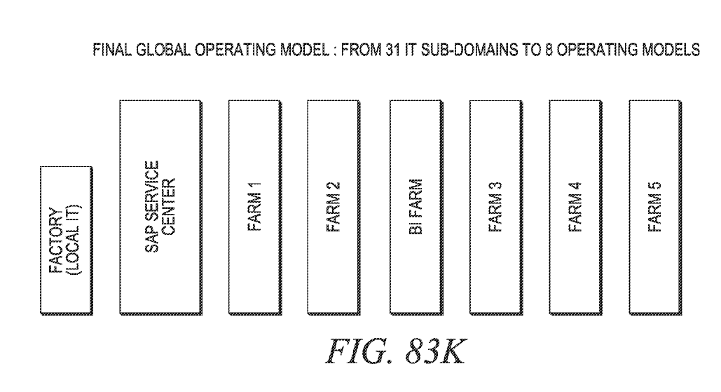

FIGS. 83A to 83K show a further example of aggregation from an as-is model to a to-be model. By going from 31 sub-domains to 8 target operational models, it may be possible to achieve one or more of: more coherent and larger groups that allow reductions in necessary management resources, to mutualize and professionalize teams, to better use experts, to render processes and tools more uniform and to offshore externalisable candidates, to consolidate suppliers (reduction in costs, maintenance, maintaining competencies over time, productivity gains, favoring fixed price versus T&M)

By performing aggregation, one may achieve one or more of the following quantifiable impacts:
Consolidation: reduction in middle management, supplier consolidation
Synergies: increase in critical mass (FTE) Per technology, capability to create mutualized centers of excellence
Application Maintenance: standardization of support processes and structure mutualization, professionalization of support and maintenance teams
Application Development: lifecycle optimization, demand management process formalization
Bringing together internal teams at a goegraphic level
Implementaiton of KPI
Convergence towards a single set of tools
Reduce of external costs by: fixed cost, offshore, consoludation with greate volume for preferred partners
Reduction of internal costs: pyramid management, better usage of experts, management of turnover.

Having created a set of operational units, the user may exit the aggregation wizard, and to-be model formation continues with step 740.

Step 740

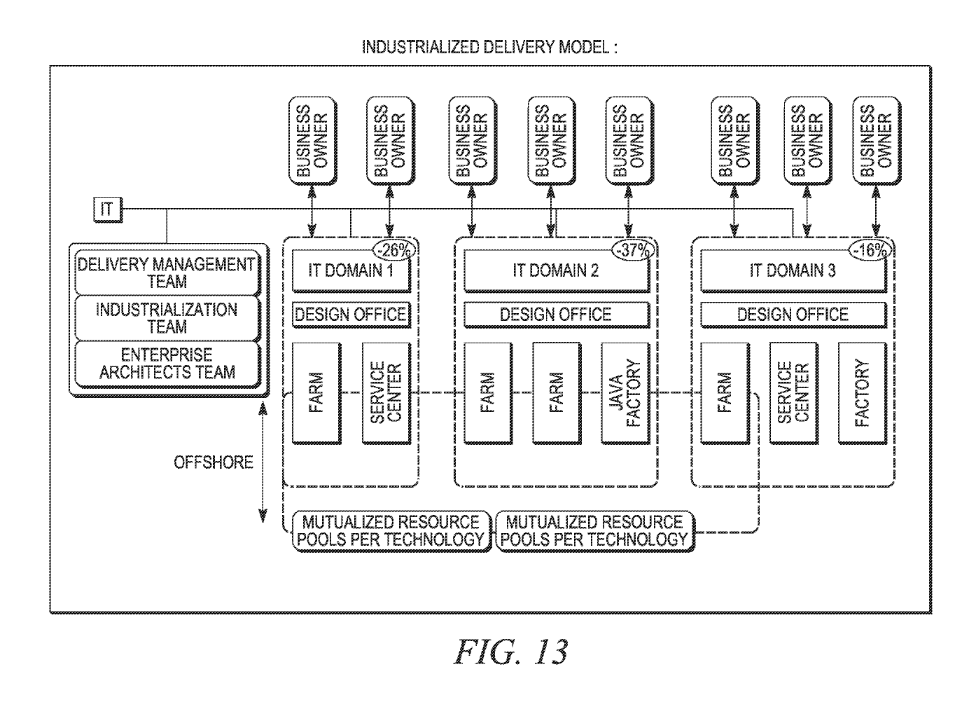

Step 740, an “industrialized delivery model” may now be designed by fitting the set of operational units (defined using the aggregation wizard) into the overall IT organization along with other functions. A conceptual diagram of an industrialized delivery model is given in FIG. 13.

The industrialized delivery model defines:
The recommended contract type (% of Time & Material versus fix price)
Offshore solution and target country+% of offshore versus front office team
% of people in customer premises
Year of commitment and volume
Etc . . .

Details as to how each operational unit will function can be determined on the basis of a handbook. Based on best practices taken from LEAN, Six-Sigma, CMMI Level 5 and institutional knowledge databases, the handbook may define for each operational model the processes, governance, sourcing considerations, tools and the organization, including specific roles and team composition by level of experience.

It should be appreciated that the design of the industrialized delivery model, together with aggregation, may result in changes to the software asset data container 12 and/or the domain/sub-domain data container 13 may be made. This may include changes to various parameters used to compute efficiency factors. One or more of the following efficiency factors may thus be affected by the aforementioned changes:
Average team size of operational resources per Operational Manager
Average number of Operational Managers reporting to the same N+1
Number of distinct Suppliers
Ratio of FTE working on niche technologies
Critical mass on niche competencies which can be mutualized (BI, agile dev.)
% of FTE with technology critical mass per domain/location
E2E IT Service delivery management. (0-5)
Ticket volume reduction plan (1-5)
Support structure organization (1-5)
Quality of the demand coming from business owners (1-5)
Project delivery performance (1-5)
Business Alignment (1-5)
Average number of hands off for projects
Rightshore ratio of internal resources
Number of location for internal teams
KPIs (0-3)
Coherence of engagement model (1-5)
Fixed price ratio
Tools (1-5)
Shared Services (1-5)
Process and organisation (1-3)
Structured improvement loop management (1-5)
Rightshore ratio for external resources
Ratio of external resources working offsite (out of client site)
Number of suppliers locations
Average size of fixed price Supplier teams
Average team seniority by assignment (internal rotation plan)
Ratio of technical experts in internal resources
Average production costs
Employees Turnover
Pyramid Management Plan (1-5)

Because there are changes in efficiency factors, there may also be changes in efficiency levers, as now discussed.

Phase 4: Update the Industrialization Efficiency Report (Selection of Option D5 from the GUI)

Once Phase 3 is complete, the user can exit the industrialization tool 2870 and return to the IT transformation tool 240 and select GUI option D5. Upon detecting that that GUI option D5 has indeed been selected (see FIG. 4B), the IT transformation tool 240 creates an updated version of the industrialization analysis report. Updating the industrialization analysis report can also be triggered even if the aggregation wizard has not been used, because to-be model formation may involve restructuring without necessarily involving aggregation. Nevertheless, if aggregation has been carried out, updating of the industrialization efficiency report will take into consideration the decisions made during the industrialization process and, in particular, the various changes made to the domain/sub-domain data container 13 (and possibly also to the software asset data container 12). Because there are changes in the domain/sub-domain data container 13, there will also be changes in the efficiency factors, which leads to changes in the efficiency levers. These changes may be due to aggregation performed at steps 710, 720, but may also be due to having implemented other improvement actions.

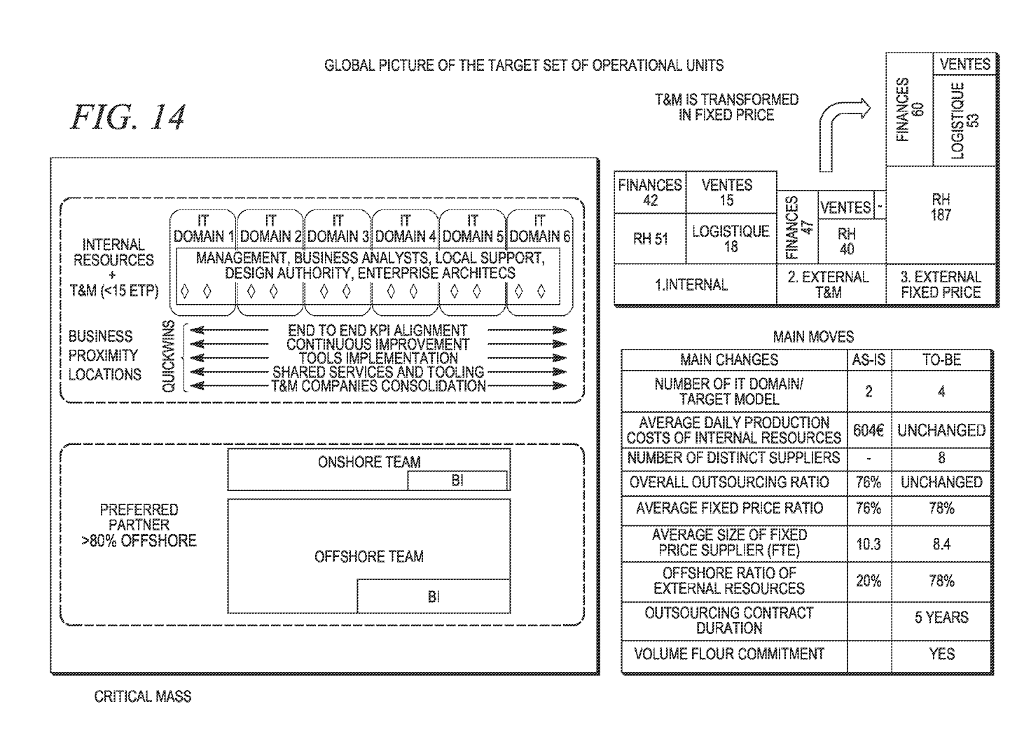

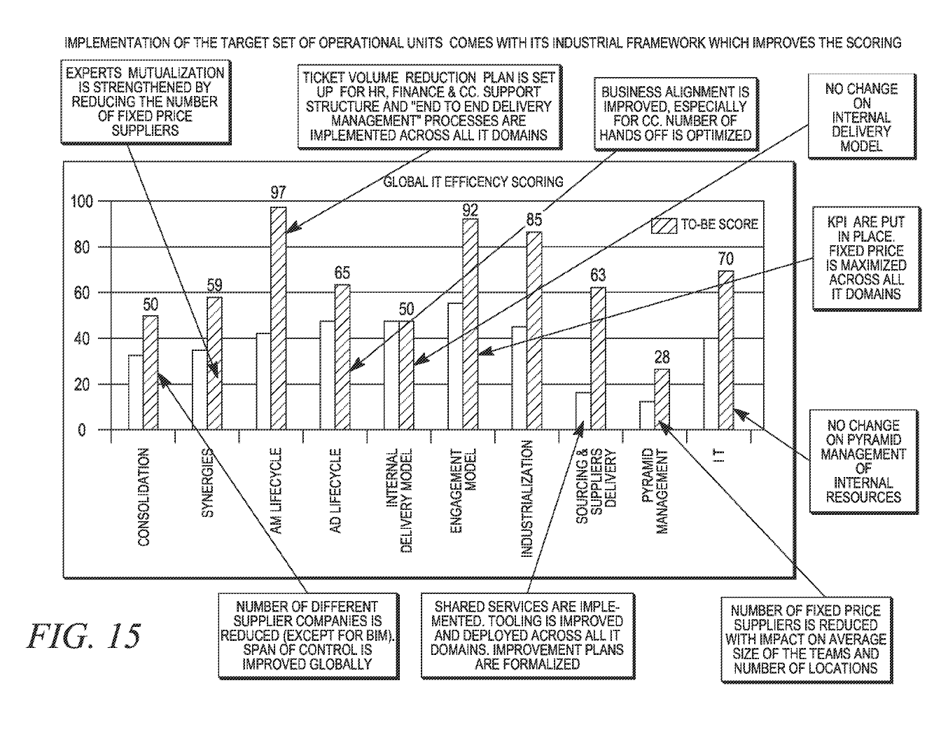

For example, the updated industrialization efficiency report may include comparative scoring information that is based on the industrialized delivery model (the “to-be model”), as shown in FIGS. 14-15 by way of non-limiting example. Specifically, it is seen how the efficiency levers (in this case, nine of them) are re-scored and compared to the pre-industrialization scenario. In this way, through the GUI, the user perceives and has the ability to compare the pre- and post-industrialization scenarios, allowing the user to make an informed decision about implementing the aggregation of building blocks.

For an example of re-scoring, consider the synergies efficiency lever. In the present non-limiting example, this efficiency lever can be based on 3 efficiency factors:

1. Efficiency Factor 1: Ratio of FTE working on niche technologies

2. Efficiency Factor 2: Critical mass (FTE) on niche competencies which can be mutualized

3. Efficiency Factor 3: % of FTE with technology critical mass (e.g., >20 FTE) per location

Consider now the types of changes that could be made to these efficiency factors as a result of to-be model formation.

Efficiency Factor 1: one of the improvement actions may be to rationalize less critical applications which have the most important technical debt on niche technologies. This will change the score of Efficiency Factor 1.

Efficiency Factor 2: one of the improvement actions may be to launch competency centers to gather experts in the same transverse organization under a common management. This will change the score of Efficiency Factor 2.

Efficiency Factor 3: one of the improvement actions may be to consolidate skills in the same location and/or transform existing portfolio to reach critical mass (20 FTE per techno). This action, which may involve aggregation as described above, will change the score of Efficiency Factor 3.

Therefore, one can re-compute the total score for the Synergies efficiency lever and obtain the difference between the as-is and to-be scores. The IT transformation tool can do the same for other efficiency levers. This can then be translated into a potential cost savings.

For example, an optional step could be carried out whereby the savings expected from the new organization (post transformation) can be computed per domain using a suitable financial model.

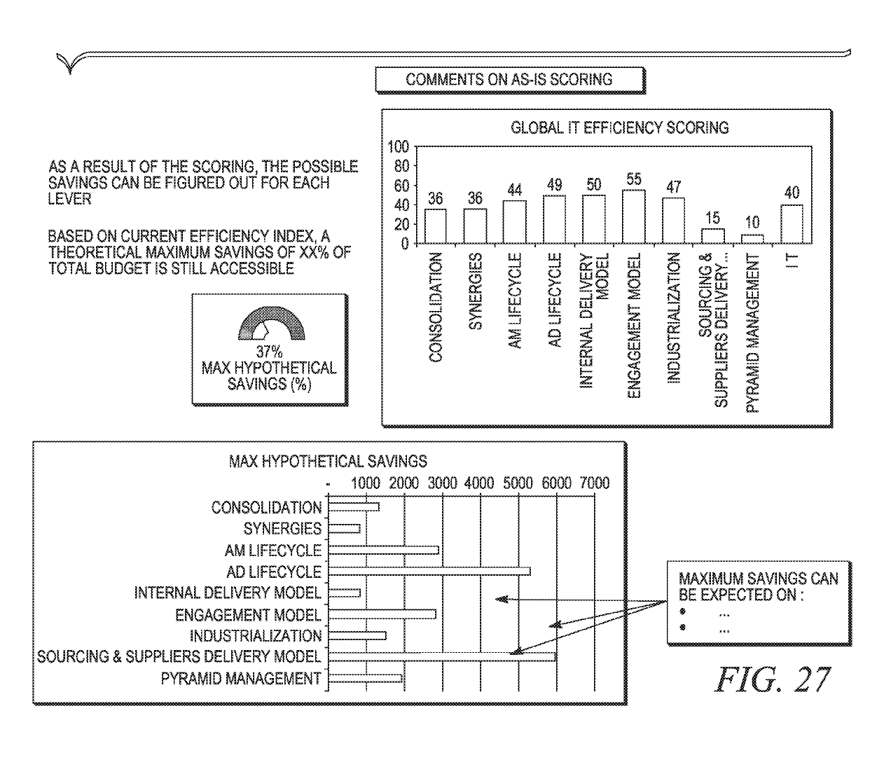

FIG. 27 shows possible savings that can be achieved for each efficiency lever, if the to-be model is implemented. The potential savings can be calculated by the IT transformation tool. Saving estimates principles include:
1. Each Lever has an impact on a specific financial baseline
2. Each Lever is associated with a “Maximum hypothetical saving %”. This Maximum saving % is the % of saving of the financial baseline of the lever when the score changes from 0 to 100.
3. The expected saving (S) for each lever is a ratio of this Maximum saving % (M) applied to the financial baseline of the lever (B), depending on the evolution of the score between the to-be score (Score_tobe) and the current score (Score_asis): S=(Score_tobe−Score asis)×M×B/100

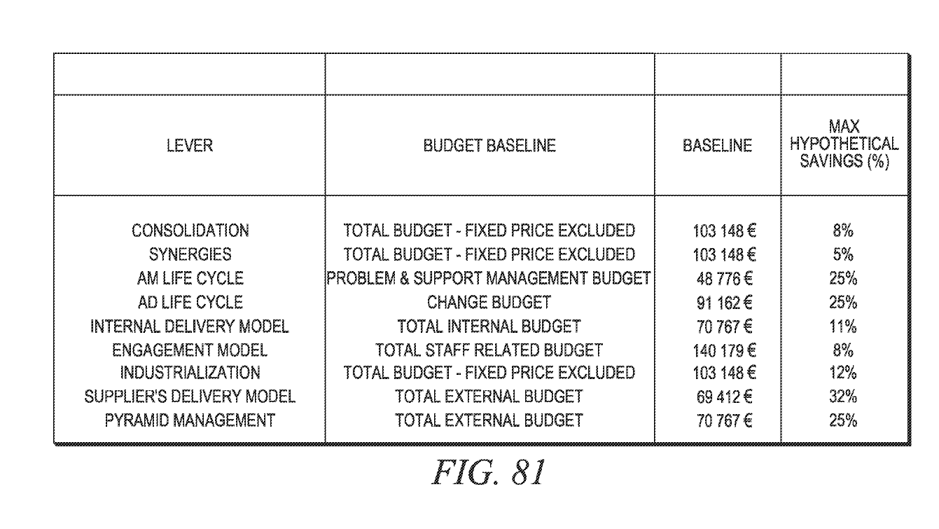

Baselines and Maximum savings % of each Lever are shown in FIG. 81.

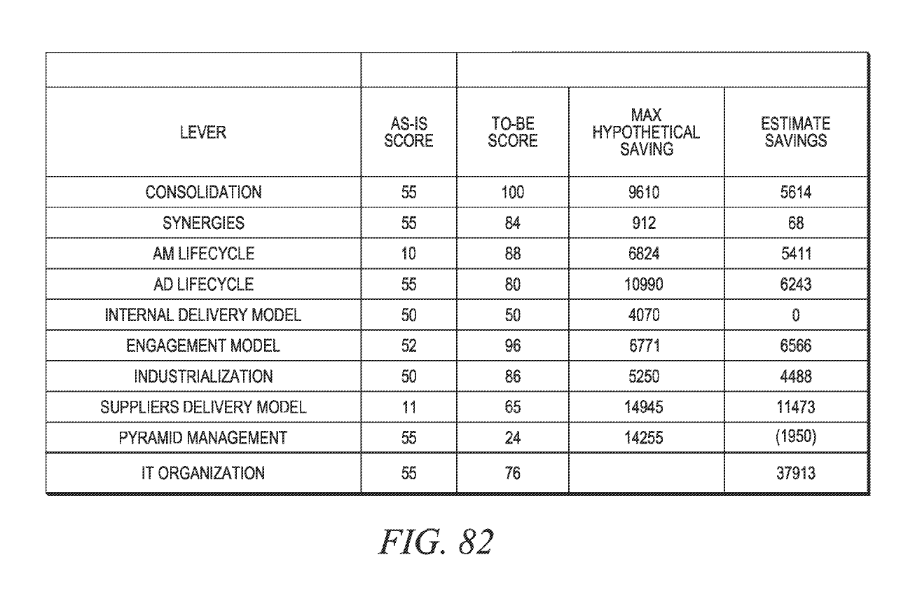

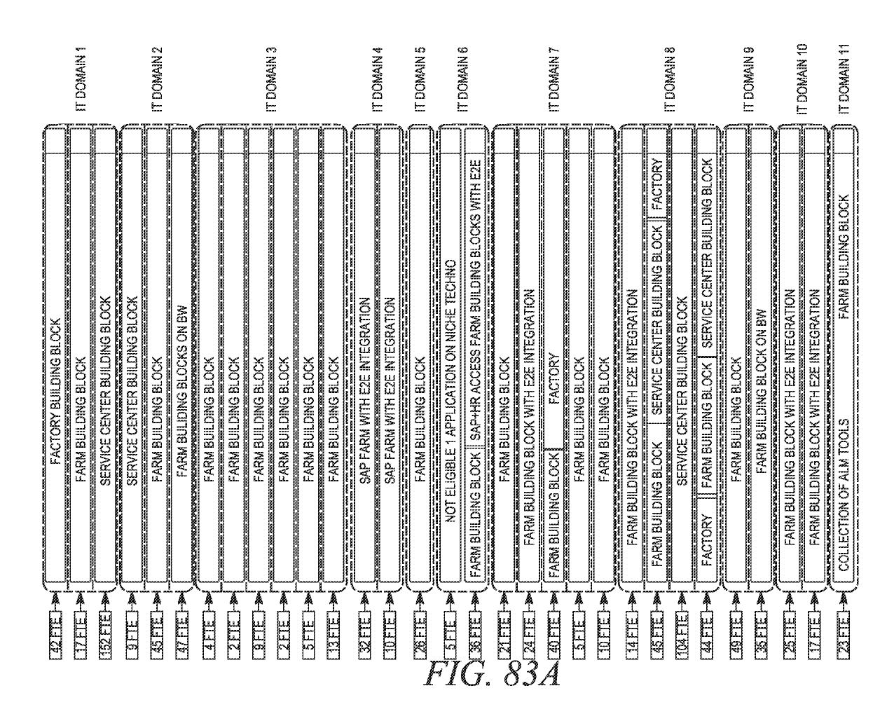

Savings estimates based on the difference of scoring between to-be (future) and as-is (current) are shown in FIG. 82.

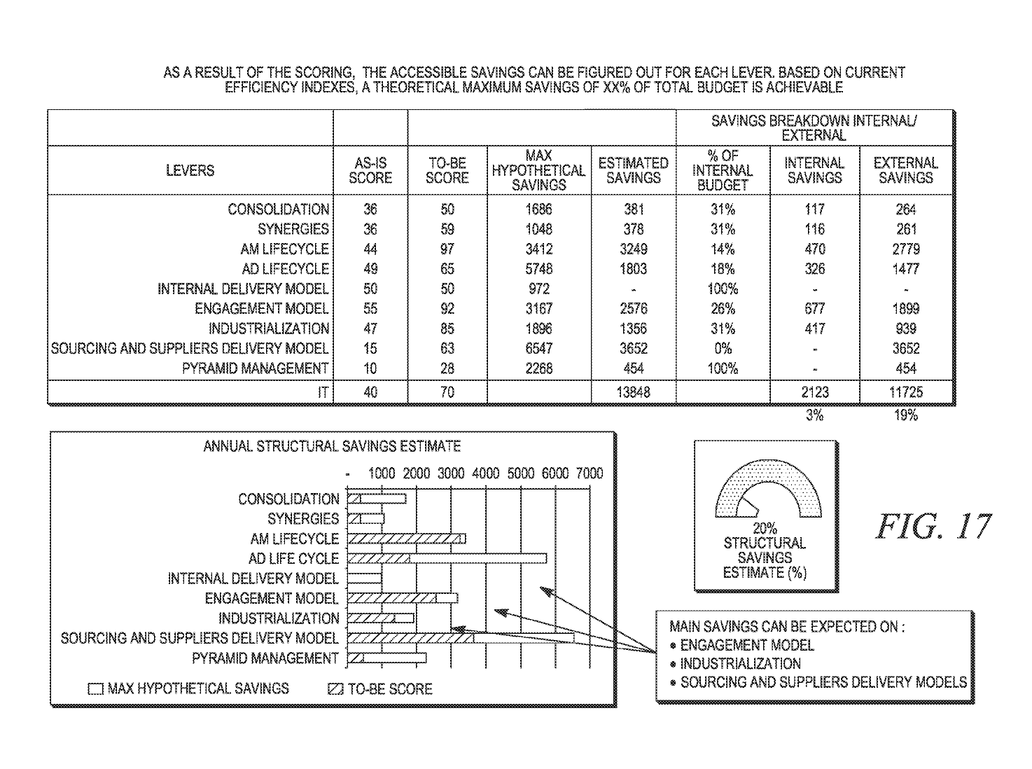

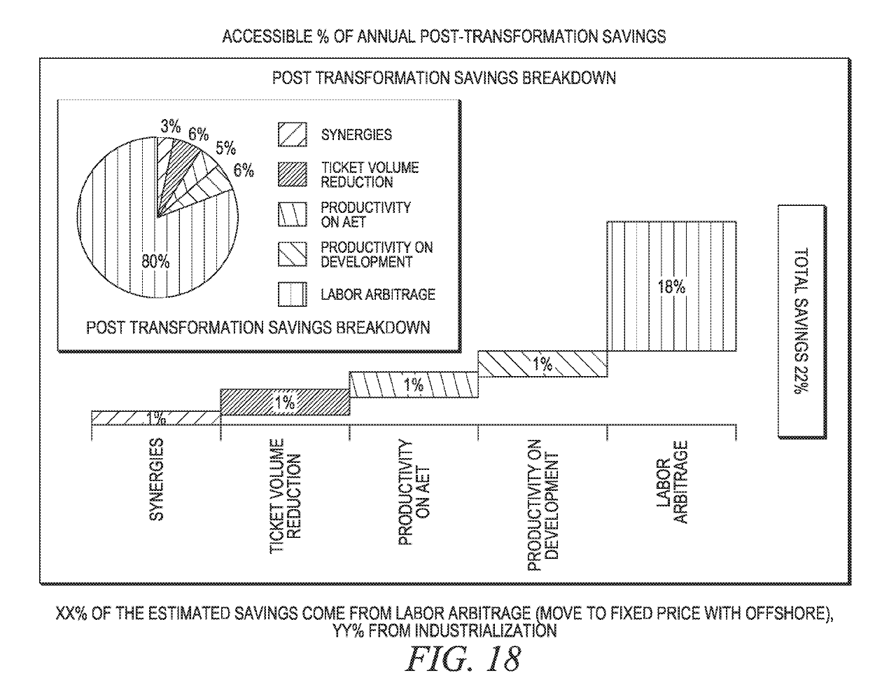

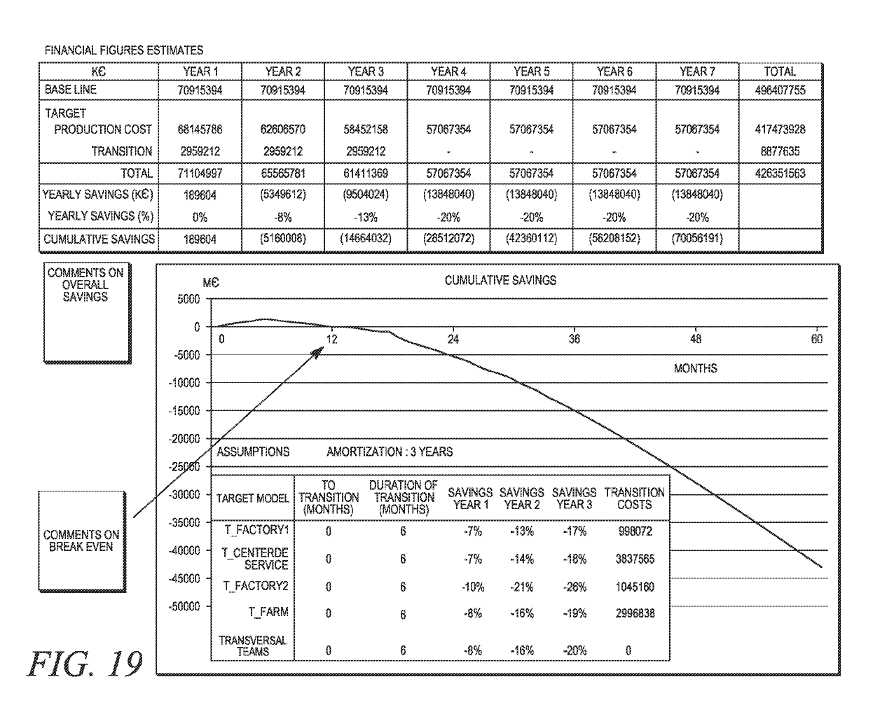

FIGS. 17-19 and 27 illustrate the savings that can be gained from industrialization, on a per-lever basis, by way of non-limiting examples.

Moreover, these savings could be computed for multiple transformation scenarios as to allow the most financially advantageous scenario to be identified.

Phase 5: Conveyance (Selection of Option D6 from the GUI)

The selection of option D6 from the landing page 2800 may instantiate the dynamic portfolio analysis engine 2850 of the IT transformation tool 240. Specifically, the selection of option D6 signals that the user wishes to use the dynamic portfolio analysis engine 2850 in order to update the portfolio analysis report 3000 that was previously described above in section (ii) Portfolio Analysis. This results in the generation of scorecards as previously described, but this time not based on as-is organization, but rather on the to-be model. Because classification and portfolio characteristics are different, the characteristics of the future solution may be rendered more readily, conveniently and intuitively perceptible to the user.

Therefore, it will be appreciated that the industrialization tool 2870 (including the aggregation wizard) induces changes to parameters that allow a user to perceive, using the IT transformation tool 240, various features of a hypothetical restructuring of the IT estate without actually having to carry out the restructuring actions themselves Financial savings can be estimated and benchmarks can be compared, allowing potentially more sound economic decisions to be made than in the absence of the present invention.

Certain adaptations and modifications of the described embodiments can be made. Therefore, the above discussed embodiments are to be considered illustrative and not restrictive. Also it should be appreciated that additional elements that may be needed for operation of certain embodiments of the present invention have not been described or illustrated as they are assumed to be within the purview of the person of ordinary skill in the art. Moreover, certain embodiments of the present invention may be free of, may lack and/or may function without any element that is not specifically disclosed herein.

1. A method performed by at least one computer processor executing computer program instructions tangibly stored on at least one non-transitory computer-readable medium, the method comprising using the at least one computer processor to perform operations of:
retrieving from a computer-readable memory data relating to assets of an organization's IT estate, the data relating to each asset including values ascribed to parameters common among the assets, the parameters relating to respective features of the assets;
interacting with a user to convey to the user a set of selectable classification parameters among said parameters;
interacting with the user to receive from the user an identification of a plurality of classification parameters selected from the conveyed set of selectable classification parameters; and
using a display screen to render perceptible to the user a plurality of graphical elements each corresponding to at least one of the assets, each graphical element characterized by multiple independent and simultaneously perceptible features, each of the features conveying the value ascribed to a corresponding one of the selected classification parameters for the corresponding at least one asset.

2. The method defined in claim 1, wherein to render perceptible to the user the graphical elements corresponding to the subset of the assets, the at least one computer processor performs operations of:
classifying the graphical elements into clusters, the clusters occupying distinct on-screen regions reflecting the values ascribed to a first one of the selected classification parameters; and
within each cluster, applying a distinguishing characteristic to the graphical elements reflecting a second one of the selected classification parameters.

3. (canceled)

4. The method defined in claim 1, further comprising:
interacting with a user to provide to the user a set of selectable filtering parameters among said parameters;
interacting with the user to receive from the user an identification of at least one filtering parameter selected from the provided set of selectable filtering parameters and, for each selected filtering parameter, a corresponding filtering value; and
using the display screen to render perceptible to the user those graphical elements that correspond to assets for which the value ascribed to the selected filtering parameter has a predetermined relationship to the corresponding filtering value.

5. (canceled)

6. (canceled)

7. The method defined in claim 1, wherein said parameters include raw parameters and derived parameters, the raw parameters having been entered directly by a user through a GUI, the method further comprising determining the derived parameters from the raw parameters according to pre-determined formulae stored in the memory.

8. The method defined in claim 1, further comprising:
interacting with a user to receive from the user a selection made using an input device of a subset of graphical elements from the originally displayed set of graphical elements;
interacting with the user to receive from the user a command to apply the selection; and
using the display screen to render perceptible to the user a subset of the originally displayed set of graphical elements, on the basis of the selected subset of graphical elements.

9. (canceled)

10. (canceled)

11. (canceled)

12. (canceled)

13. (canceled)

14. (canceled)

15. (canceled)

16. (canceled)

17. A dynamic portfolio analysis engine implemented by at least one computer processor executing computer program instructions tangibly stored on at least one non-transitory computer-readable medium and configured for:
retrieving from the computer-readable medium data relating to assets of an organization's IT estate, the data relating to each asset including values ascribed to parameters common among the assets;
generating a portfolio analysis output based on the retrieved data, the portfolio analysis output encoding a graphical representation of a mutual comparison of the assets of the IT estate with respect to at least one of the parameters;
monitoring the memory to detect changes in the data relating to the at least one of the parameters, for at least one of the assets; and
updating the portfolio analysis output in substantially real-time as said changes in the data relating to the at least one of the parameters are detected.

18. A dynamic portfolio analysis engine as defined in claim 17, the parameters including raw parameters and derived parameters, the values ascribed to the raw parameters being user-entered through interaction with a computer graphical user interface, the values ascribed to the derived parameters being computed by the dynamic portfolio analysis engine based at least in part on the values ascribed to at least some of the raw parameters.

19. (canceled)

20. (canceled)

21. (canceled)

22. (canceled)

23. (canceled)

24. (canceled)

25. A dynamic portfolio analysis engine as defined in claim 17, further configured for displaying the graphical representation conveyed by the portfolio analysis output on a physical display.

26. A dynamic portfolio analysis engine as defined in claim 25, wherein displaying the graphical representation comprises using a display screen to render perceptible to the user a plurality of graphical elements each corresponding to at least one of the assets, each graphical element characterized by multiple independent and simultaneously perceptible features, each of the features conveying the value ascribed to a corresponding one of the parameters for the corresponding at least one asset.

27. (canceled)

28. A dynamic portfolio analysis engine as defined in claim 17, further configured for determining an average value, across the assets, for at least one of the parameters; and
retrieving from the memory a benchmark value for the at least one parameter; wherein the portfolio analysis output further encodes a graphical representation of a comparison between the average value and the benchmark value, for the at least one parameter.

29. (canceled)

30. (canceled)

31. (canceled)

32. A dynamic portfolio analysis engine as defined in claim 17, further configured for determining, based on a first subset of the parameters, a resistance to decommissioning of each of the assets; for determining, based on a second subset of the parameters, a motivation for decommissioning of each of the assets; and for producing an output signal conveying an identity of those assets that are candidates for decommissioning, based on the assets' motivation for decommissioning and the resistance to decommissioning.

33. (canceled)

34. (canceled)

35. (canceled)

36. (canceled)

37. (canceled)

38. (canceled)

39. A method performed by at least one computer processor executing computer program instructions tangibly stored on at least one non-transitory computer-readable medium, the method comprising using the at least one computer processor to implement an IT transformation tool configured for:
interacting with a user to provide to the user a plurality of IT transformation options including at least a first option and a second option;
responsive to selection of the first option, causing further interaction with the user to allow the user to submit data relating to assets of an organization's IT estate, the data relating to each asset including values ascribed to parameters common among the assets, the parameters relating to respective features of the assets; and
responsive to selection of the second option, processing the data relating to the assets to dynamically generate a portfolio analysis output and using a display screen to render perceptible to the user the portfolio analysis output.

40. The method defined in claim 39, the data submitted by the user being collected in a data container stored in the non-transitory computer-readable medium.

41. The method defined in claim 40, the plurality of IT transformation options further including a third option, the IT transformation tool further configured for:
responsive to selection of the third option, causing conveyance of a graphical dashboard displaying a degree of completeness of the data container.

42. The method defined in claim 41, wherein the IT transformation tool is further configured for dynamically recomputing and redisplaying the degree of completeness via the dashboard as the data container is being completed.

43. The method defined in claim 42, wherein the displaying the degree of completeness as the data container comprises displaying the degree of completeness on a per-IT-domain basis, thereby to alert the user to any IT domains for which completion of the data container is lagging.

44. (canceled)

45. (canceled)

46. (canceled)

47. (canceled)

48. (canceled)

49. (canceled)

50. A method performed by at least one computer processor executing computer program instructions tangibly stored on at least one non-transitory computer-readable medium, the method comprising using the at least one computer processor to perform operations of:
retrieving from the computer-readable memory data relating to assets in different domains of an IT estate, the data relating to each asset including a corresponding level of dynamism and a corresponding level of integration for said asset;
categorizing each of the assets into a building block having a certain model, such that the assets categorized into a building block of a given model include those assets for which the corresponding levels of dynamism for those assets are within a predetermined range of dynamism levels for the given model and the corresponding levels of integration for those assets are within a predetermined range of integration levels for the given model;
creating suggested operational units by aggregating building blocks from different domains, based on the respective model of the aggregated building blocks; and
rendering perceptible to a user an indication of the suggested operational units resulting from the aggregating.

51. The method defined in claim 50, wherein categorizing each of the assets into a building block having a certain model comprises categorizing each of the assets as a farm, factory or service center according to the corresponding level of dynamism and level of integration of each asset.

52. The method defined in claim 51, wherein a farm is associated with a first range of dynamism levels and a first range of integration levels, wherein a factory is associated with a second range of dynamism levels and a second range of integration levels, and wherein a service center is associated with a third range of dynamism levels and a third range of integration levels.

53. (canceled)

54. (canceled)

55. (canceled)

56. (canceled)

57. (canceled)

58. (canceled)

59. The method defined in claim 50, further comprising:
obtaining an assessment of the IT estate based at least in part on the data relating to each of the assets;
modifying the data relating to assets that have been categorized into a building block;
obtaining a new assessment of the IT estate based at least in part on the data relating to each of the assets including the modified data;
comparing the old and new assessment; and
rendering perceptible to a user an outcome of the comparing.

60. (canceled)

61. (canceled)

62. (canceled)

63. (canceled)
